(19) United States
(12) Patent Application Publication
(10) Pub. No.: US 2026/0253499 A1
(43) Pub. Date: Aug. 27, 2026

(54) FLEET OF AUTONOMOUS UNDERWATER VEHICLES INCLUDING A NOVEL COMMUNICATION SYSTEM

(71) Applicant: Strydent Autonomous Technologies, Inc., Dayton, MD (US)

(72) Inventor: Dean Louis FANELLI, Dayton, MD (US)

(21) Appl. No.: 19/545,060

(22) Filed: Feb. 20, 2026

Related U.S. Application Data
(60) Provisional application No. 63/761,729, filed on Feb. 21, 2025.

(51) Int. Cl. G08G 3/00; F41G 7/00; H04B 10/50

(52) U.S. Cl. CPC G08G 3/00; H04B 10/503; F41G 7/001

(57) ABSTRACT

The present invention relates to a system of multiple autonomous underwater vehicles (AUVs) acting remotely in unison for reconnaissance, exploration, or military purposes. In various embodiments, the AUVs include various sensors, solar panels to charge a battery system for constant use, and autonomous intelligence to allow unmanned navigation and mission completion. In further embodiment, the AUVs of the invention includes a laser communication system.

### CROSS REFERENCE TO RELATED APPLICATIONS

This application claims the benefit of U.S. provisional patent application no. 63/761,729, which was filed on Feb. 21, 2025, and is incorporated herein by reference in its entirety.

### FIELD OF THE INVENTION

The present invention relates to a system of multiple autonomous underwater vehicles (AUVs) or swarms acting remotely independently and providing collective information regarding intelligence, reconnaissance, exploration, or military purposes. In various embodiments, the AUVs include various sensors, optionally one or more solar panels to charge a battery system for constant use, and autonomous intelligence to allow communication, unmanned navigation and mission completion. In further embodiment, the AUVs of the invention include a novel communication system including for example a system of acoustic, radio frequency, and laser communication.

### BACKGROUND OF THE INVENTION

Remotely operated underwater vehicles (ROV's) are widely used by industry and science for unmanned undersea exploration. The ROV typically requires an electromechanical cable connection (tether) to the surface for communications and power which are typically located on a boat. More recently, AUVs have been developed that are tether-free and can operate underwater, but there are limitations in operation, communication, and time the AUV can operate under a single batter charge. The invention encompasses a swarm or fleet of autonomous underwater vehicles or AUVs that overcome the limitations of instant AUV technology.

### SUMMARY OF THE INVENTION

The invention generally encompasses a group of two or more autonomous underwater vehicles each vehicle comprising:
a plurality of sensors enclosed within a housing of the underwater vehicle comprising optionally one or more inertial sensors, one or more gyrometers, a laser-based LiDAR (Light Distancing and Ranging) system, a video camera, a GPS (Global Positioning System) antenna, a GPU (Graphic Processing Unit), a CPU (Computer Processing Unit), an acoustic communication system, one or more chemical sensors, and a depth sensor;
one or more photovoltaic cells to charge a rechargeable battery of the AUV (e.g., Li-ion or NiMH battery); and
a generative learning system comprising at least one processor and at least one memory configured to implement a deployed learning network model, the deployed learning network model generated from a training network, wherein the training network is tuned using features extracted from a set of data received from the one or more sensors in the group of submersible underwater vehicles, and wherein data associated with each of the one or more sensors indicates a navigation model, the at least one processor configured to at least:
automatically process a first set of data using the deployed learning network model to generate a navigation trajectory;
compute the navigation trajectory metric associated with the set of data using the deployed learning network model by leveraging the features and associated target value for the navigation trajectory network to determine the associated navigation trajectory for the group of submersible underwater vehicles; and wherein the AUVs further comprise a linked communication system wherein depending on maritime conditions the swarm of AUVs communicates with one another and with a command-and-control system (C2) using a combination of acoustic, RF, and optical communications,
wherein the optical based communication system comprises: one or more of a photon-counting detector, a boundary detector operably coupled to the photon-counting detector, at least one alignment block operably coupled to the boundary detector, and a rate decision block operably coupled to the alignment block(s), wherein the photon-counting detector transduces an optical signal with a variable data rate into a digital signal including a symbol having a data period and a guard period, wherein he boundary detector senses a boundary (e.g., a rising or falling edge) of the digital signal and indicates a photon arrival at the photon-counting detector, wherein the alignment block estimates a number of photons detected by the photon-counting detector during the guard period at each of a plurality of predetermined data rates based on the boundary of the digital symbol, and the rate decision block estimates the variable data rate of the optical signal based on the number of photons detected by the photon-counting detector during the guard period at each of the plurality of predetermined data rates.

In certain specific embodiments, the optical communication system includes a plurality of lasers acquired and characterized by an acquisition module; a laser tracking module; a beacon feedback and beam dispersion mechanism; an adaptive learning detection algorithm implemented using an adaptive learning unit to identify and track unique optical signatures from at least one of the acquired lasers; and an aiming module aimed by at least one laser at a target based on the acquired laser.

In one embodiment, the autonomous underwater vehicles (AUVs) of the invention run their own tasks with a high degree of autonomy and are equipped with appropriate electronic devices. In another embodiment, the autonomous underwater vehicles or AUVs of the invention are developed as classical autonomous unmanned system using propellers and underwater gliders driven by gravity and/or buoyancy, respectively.

In certain embodiments, an underwater glider generates a propulsive force using a buoyancy regulator, generating a force in a vertical direction through a buoyancy regulator. In certain embodiments, the AUV of the invention including a glider has the advantage of maximizing the operating time and the exploration distance compared to general unmanned submersible.

In certain embodiments, the AUV of the invention includes a control processor that performs position tracking by a DVL (Doppler Velocity Log), which is a sensor for measuring the relative velocity of the hull using the Doppler phenomenon of the sound wave in the underwater glide mode.

In certain embodiments, when the AUV main body is located below sea level in the underwater glide mode, the control processor controls the GPS, the DVL (Doppler Velocity Log), the depth sensor depth sensor and an inertial measurement unit (IMU) to calculate the posture and the position of the AUV. The AUV main body is configured to calculate the posture and the position of the main body and transmits current data between AUVs using an acoustic or optical communication system and communicates to a C2 system using the RF (Radio Frequency) communication unit directly or connects to a satellite with the satellite using the GPS.

In certain embodiments, the invention encompasses a swarm of AUVs that perform reconnaissance, surveillance, or military operations and transmit in real-time and/or return with detailed data including mineral presence, depth, water temperature, obstacles, hazards, and potential targets. In certain embodiments, the AUVs also detect specific chemicals and trace them to their source. In certain embodiments, the data would be invaluable for protection, anti-smuggling efforts, environmental protection, and military applications.

In certain embodiments, the AUV comprises a controller; a body having a front end and a rear end and defining a cavity and a center of gravity; a first dive plane extending from the body proximate the center of gravity; a second dive plane extending from the body substantially opposite of the first dive plane proximate the center of gravity; a counterweight disposed within the cavity configured to be moved between the front end and the rear end of the body, wherein a fore-aft pitch of the body of the AUV is controlled by the controller through movement of the counterweight toward the front end or the rear end of the body. The counterweight may be located proximate the center of gravity of the body between the front end and the rear end in response to no pitch being commanded by the controller.

In certain embodiments, the first dive plane may be attached at a first end to the body, where the second dive plane may be attached at a second end to the body, where the autonomous underwater vehicle may further include: a first propeller disposed proximate a second end of the first dive plane, opposite the first end; and a second propeller disposed proximate a second end of the second dive plane, opposite the first end. The controller may be configured to cause the autonomous underwater vehicle to turn in response to differential control of the first propeller and the second propeller. The controller may be configured to cause the front end of the body to pitch up in response to causing the counterweight to move toward the rear end of the body.

In certain embodiments, the autonomous underwater vehicle may include: a first laser and a second laser, where the first laser projects a first laser beam to a spot in front of the autonomous underwater vehicle, and wherein the second laser beam projects an array of laser beams to a field of view in front of the autonomous underwater vehicle. An image capture device having a field of view may include the field of view of the first array of laser beams and the first spot, where the image capture device may be configured to map a surface covered by the field of view of the first array of laser beams. The controller may be configured to receive data from the image sensor device, process the data, and generate, for example, bathymetric data of a surface covered by the field of view of the first array of laser beams.

In certain embodiments, the autonomous underwater vehicle may include a gyrometer, an accelerometer, a compass, and a pressure transducer, where the controller may be configured to process data from the gyrometer, accelerometer, compass, and pressure transducer to facilitate autonomous navigation of the AUV within a predetermined area under water.

In certain embodiments, an AUV includes a controller; a body having a front end and a rear end defining a cavity; a first dive plane extending from the body; a second dive plane extending from the body substantially opposite of the first dive plane; a first LiDAR (i.e., light detection and ranging) system; and a second LiDAR system, where the first LiDAR system projects a single laser beam in front of the body and is configured to determine a height above the sea floor, wherein the second LiDAR system projects an array of laser beams in front of the body and is configured to detect objects in front of the AUV under water. In certain embodiments, the second LiDAR system may be configured to generate bathymetric data of the sea floor. In certain embodiments, the AUV may include a counterweight disposed within the cavity configured to be moved between the front end and the rear end of the body, where a fore-aft pitch of the body of the AUV may be controlled by the controller in response to movement of the counterweight toward the front end or the rear end of the body.

In other embodiments, the AUV according to the invention is formed by integrally connecting a first center-weighted drive motor, a center-weighted battery (preferably a solar rechargeable battery), and a second center-weighted drive motor, wherein the center-weighted battery is formed at a front end of the first center-weighted driving motor and the second center-weighted driving motor. In certain embodiments, an infrared distance sensor is formed on the rear end of the driving motor and on the front end of the center-weight type battery. In certain embodiments, a control processor performs a function of controlling the center of gravity to the upper end and the rear end through the horizontal movement on the central axis.

In certain embodiments, the AUV according to the invention is advantageous in that the energy required for propulsion is small because the propulsion force is obtained through the buoyancy control of the underwater glider and the movement of the center of gravity and the vertical movement of the autonomous unmanned submersible is necessary providing the possibility of providing a small turning radius at a high speed, thereby enhancing the energy efficiency by adding an underwater glider propulsion method to the AUV, and by using a propeller when necessary.

In certain embodiments, a lower surface of the main body is provided with acoustic positioning system and communication system to allow communication among a swarm of AUVs or to a C2 system. The communication system includes a transmitter which sends an acoustic wave and a wave receiver, which receives the acoustic wave. In certain embodiments, one more AUVs act as an on-water control system to measure a position of one or more of the underwater vehicles using the acoustic positioning system, and bidirectionally communicates with the underwater vehicle by acoustic signals using the communication system and controls the underwater vehicle. The acoustic signals sent from the on-water AUV control system toward underwater easily reach within a substantially conical range having the on-water control system as an apex.

In certain embodiments, the AUV includes various types of glide modes for the unmanned submersible according to the invention and variations of underwater wing according to various modes according to autonomous unmanned submersible mode.

In certain embodiments, when the cruising paths of one or more AUVs are set such that cruising loci of the underwater vehicles which cruise in the respective exploration regions are not vertically superposed on each other simultaneously, it is possible to prevent the underwater vehicles having close exploration depths from colliding against each other due to errors and the like in measurement and control, and it is possible to enhance the safety. Further, since underwater vehicles are not vertically superposed on each other, it is possible to reduce generation of troubles in the underwater vehicles related to exploration such as erroneous observation and observation inability.

In certain embodiments, if the exploration depths which are differently set in the one or more underwater vehicles include a deep exploration depth which is close to the water bottom and a shallow exploration depth which is far from the water bottom, it is possible to efficiently explore a region close to the water bottom and a region far from the water bottom.

In certain embodiments, if the cruising speed of the underwater vehicle having the deep exploration depth is slower than cruising speed of the underwater vehicle having the shallow exploration depth, the underwater vehicle which carries out the exploration at deep exploration depths can carry out exploration more precisely.

If a height from the water bottom on which the underwater vehicle at the deep exploration depth can cruise is 1 m or more and less than 50 m and a height from the water bottom on which the underwater vehicle at the shallow exploration depth can cruise is 10 m or more and less than 200 m, at is possible to efficiently explore a region at a height of 1 m or more and less than 50 m from the water bottom and a region at a height of 10 m or more and less than 200 m.

In certain embodiments, an image taking operation of the water bottom is included in the exploration mission of the underwater vehicle having the deep exploration depth, an image of the water bottom can be included in the exploration result.

In certain embodiments, the if research of a land form of the water bottom and/or research of a geological layer underwater is included in the exploration mission of the underwater vehicle having the shallow exploration depth, at least one of the land form and the geological layer of the water bottom can be included in the exploration result.

In certain embodiments, the positions of multiple AUVs are measured by acoustic positioning system provided in the on-water control system having moving system and capable of cruising near a water surface and/or if communication is performed utilizing communication system which are respectively provided in the underwater vehicles and the on-water control system, and if the exploration mission is executed, the on-water control system can grasp at least one of positions and communication states of the multiple underwater vehicles. Therefore, the multiple underwater vehicles can more safely and efficiently carry out the exploration operation under control of the on-water control system.

Further, according to the operating system of the multiple underwater vehicles of the invention, since the multiple underwater vehicles execute the exploration missions allocated to different exploration depths, exploration can efficiently be carried out.

In certain embodiments, if the exploration condition setting system sets exploration regions of the multiple underwater vehicles at the respective exploration depths, it is possible to explore the respective exploration regions more efficiently.

In certain embodiments, the if the exploration regions are set such that cruising paths of the cruising underwater vehicles are not vertically superposed on each other simultaneously, it is possible to prevent the underwater vehicles having close exploration depths from colliding against each other due to errors and the like in measurement and control, and it is possible to enhance the safety. Further, since underwater vehicles are not vertically superposed on each other, it is possible to reduce generation of troubles in the underwater vehicles related to exploration such as erroneous observation and observation inability.

In certain embodiments, the lower surface of the main body is provided with acoustic positioning system and communication system. The communication system includes a transmitter which sends acoustic wave and a wave receiver which receives acoustic wave. In certain embodiments, an on-water control system measures a position of the underwater vehicle using the acoustic positioning system, and bidirectionally communicates with the underwater vehicle by acoustic signals using the communication system, and controls the underwater vehicle. The acoustic signals sent from the on-water control system toward underwater easily reach within a substantially conical range having the on-water control system as an apex. Therefore, this substantially conical range controlled by the on-water control system is determined as a control region.

In certain embodiments, the AUV is a cable-free autonomous unmanned type vehicle, which autonomously cruises in water without using a cable for connecting with the on-water control system and is used as the underwater vehicle. The on-water AUV control system controls multiple underwater vehicles using acoustic signals. Therefore, it is unnecessary to provide the on-water AUV control system with a facility for cable, a cable is not entangled, or movement of the on-water control system is not limited by the cable.

In certain embodiments, the AUVs of the invention include a cruising system (submerging system) such as a rudder, a propulsion unit, and a ballast (weight), and by the cruising system, the underwater vehicle can cruise underwater and underwater navigate. In certain embodiments, the one or more AUVs are provided with their own vehicle positioning system used for measuring the position of an AUV, communication system used for bidirectional communication with the on-water control system by acoustic signals, and an acoustic transponder for responding a signal transmitted from the acoustic positioning system of the on-water control system.

In certain embodiments, the communication system includes a transmitter for sending acoustic waves, and a wave receiver for receiving acoustic waves. The underwater vehicle can emergency surface and can be collected by the support ship when measurement of the on-water AUV control system fails predetermined times or when communication with the on-water control system fails predetermined times.

In certain embodiments, a cruising speed of a first AUV can be made slower than those of the second or more underwater vehicles. In certain embodiments, the first underwater vehicle includes a vertical thruster and a horizontal thruster, a free degree of movement of the first underwater vehicle is higher than the second underwater vehicles, and a position of the first underwater vehicle can be held even in a place having water flow or the like. In certain embodiments, a first underwater vehicle carries out a precise exploration near a water bottom, wherein the first underwater vehicle is provided with an imaging system for taking an image of a water bottom or surroundings. In certain embodiments, the imaging system is a camera including lighting for example.

In certain embodiments, each of the one or more AUVs includes a cruising system, a vehicle positioning system, communication system, exploration condition setting system, depth meter, exploration mission executing system, transmission system, recording system, cruising speed setting section, cruising-control section, imaging system, and geological layer researching system.

In certain embodiments, the exploration mission executing system includes a depth control section, a submerging-control section, a position-estimating section, a time-managing section, and a mission-control section.

In certain embodiments, the cruising-control section includes a control region-determining section.

In certain embodiments, an operator can set exploration, reconnaissance, or military/tactical conditions by remotely inputting, to the one or more AUVs, information which is necessary for the mission, an exploration depth, an exploration region and a cruising path of the underwater vehicle using the exploration condition setting system before the underwater vehicle is introduced into the exploration water area, and the operator sets cruising speed for the underwater vehicle using the cruising speed setting section. The exploration missions, the exploration depths, the exploration regions, and the cruising paths are optionally differently set for the respective underwater vehicles to more efficiently explore the exploration regions.

In certain embodiments, the cruising paths are set such that cruising loci of the one or more AUVs, which cruise in the respective exploration regions are not superposed simultaneously to prevent the underwater vehicles having close exploration depths from colliding against each other due to errors and the like in measurement and control, and it is possible to enhance the safety.

In certain embodiments, to prevent the multiple underwater vehicles from being vertically superposed on each other to prevent the erroneous observation and observation inability, it is preferable to keep the distance between cruising loci which are not superposed on each other simultaneously when at least the above-described collision is prevented although this situation may differ depending upon the observing direction and a kind of the observing device of the multiple the underwater vehicles.

In certain embodiments, the exploration depths which are differently set for the respective underwater vehicles include deep exploration depths which are close to the water bottom and shallow exploration depths which are far from the water bottom. It is more preferable that the deep exploration depth has a height (distance) of 1 m or more and less than 50 m from the water bottom, and the shallow exploration depth has a height (distance) of 10 m or more and less than 200 m from the water bottom. It is preferable that the deep exploration depth has the height (distance) of 2 m or more and less than 20 m from the water bottom, and the shallow exploration depth has the height (distance) of 20 m or more and less than 50 m.

In certain embodiments, the deep exploration depth is mainly utilized for exploration using the imaging system, and the shallow exploration depth is mainly utilized for exploration using the landform researching system and the geological layer researching system.

In certain embodiments, the AUVs can submerge using the propulsion unit and the ballast, but if the propulsion unit is stopped and the underwater vehicles submerge only by the weight of the ballast, for example, battery life can be saved.

In certain embodiments, the AUVs can submerge independently, and each of the underwater vehicles measures a depth and a position of the own vehicle using the depth meter and the own vehicle positioning system, and the exploration mission executing system having the depth control section, the submerging-control section and the position-estimating section controls the cruising-control section in accordance with the exploration depth. In certain embodiments, the cruising-control section controls the cruising system in accordance with the control performed by the exploration mission executing system and the cruising speed which is set by the cruising speed setting section.

In certain embodiments, the own vehicle positioning system measures the position of the own vehicle by placing a speed. sensor and a gyroscope sensor and detecting and calculating speed and acceleration of the own vehicle for example.

In certain embodiments, each of the underwater vehicles which starts cruising at the set exploration depth measures the position of the own vehicle using the own vehicle positioning system and sends a result thereof to the exploration mission executing system. The exploration mission executing system having the position-estimating section controls the cruising-control section such that the underwater vehicles cruises in the exploration region. In certain embodiments, the cruising-control section controls the cruising system in accordance with the control performed by the exploration mission executing system and the cruising speed which is set by the cruising speed setting section. According to this, the underwater vehicle cruises in the exploration region.

In certain embodiments, the exploration mission executing system having the time cruising-managing section which manages time controls the cruising-control section in accordance with a cruising path such that cruising loci of this underwater vehicle and the other underwater vehicle are not superposed on each other simultaneously.

In certain embodiments, the cruising-control section cruises in the control region of the on-water control system based on an estimated position of the own vehicle received from the exploration mission executing system, a depth of the own vehicle and a communication state with the on-water control system. The communication state with the on-water control system is measured using the communication system, its measurement result is sent to the exploration mission executing system, and the exploration mission executing system grasps the communication state by a signal/noise ratio (S/N ratio) for example.

In certain embodiments, the cruising-control section includes the control region-determining section. The cruising-control section periodically determines whether the own vehicle is in the control region based on the estimated position of the own vehicle and the communication state with the on-water control system.

In certain embodiments, the mission-control section of the exploration mission executing system controls the imaging system provided in the first underwater vehicle. According to this, it is possible to take an image of the water bottom. If the mission-control section controls the landform researching system and the geological layer researching system provided in the second underwater vehicle, information of a landform of the water bottom and a geological layer under the water bottom can be obtained.

In certain embodiments, the exploration mission executing results such as information of the obtained shot image, the landform of the water bottom and the geological layer under the water bottom are recorded in the recording system such as a hard disk and a magnetic tape. After the results are subjected to processing such as encoding by the transmission system, the results are sent to the on-water control system using the communication system.

If it is determined that the own vehicle is not located in the control region, the position-estimating section estimates the position of the own vehicle based on the measurement result obtained by the own vehicle positioning system and the measurement result obtained by the depth meter and selects a path to return to the control region.

In certain embodiments, if the AUV reversely cruises the recorded cruising path and the path to return to the control region is selected, the cruising-control section controls the cruising system to reversely return the path through which the underwater vehicle cruised heretofore. If the depth is increased and the path to return to the control region is selected, the cruising-control section controls the cruising system such that the depth of the own vehicle is increased. According to this, the AUV can return to the control region by itself, and the operation can be continued while again receiving control of the on-water control system.

In certain embodiments, the underwater vehicle can return to the control region by increasing depth.

In certain embodiments, the AUV system includes an on-water control system including the own position grasping system, the maritime communication system, the moving system, the acoustic positioning system, the communication system, a control setting section, and movement-control system. In certain embodiments, the movement-control system includes a number-managing section, a standby-control section, a position-estimating section, a cruising-recording section and a control-determining section.

In certain embodiments, before an on-water control system launches into the research water area, an operator inputs, to the on-water control system, information which is necessary for the control such as a moving range of the on-water AUV control system, the number and performance of the underwater vehicles which will be controlled using the control setting section, thereby setting the control.

In certain embodiments, the on-water control system launches into the research water area and starts controlling the underwater vehicle in accordance with the control setting. First, positions of the multiple underwater vehicles are measured using the acoustic positioning system, and measurement results are sent to the movement-control system.

In certain embodiments, the communication states of the multiple underwater vehicles are measured using the communication system, and measurement results are sent to the movement-control system. The communication states are grasped by the signal/noise ratio (S/N ratio) for example.

In certain embodiments, based on the measurement results the movement-control system records cruising paths of the respective underwater vehicles together with time in the cruising-recording section.

In certain embodiments, the number-managing section compares, with each other, the number of underwater vehicles which are input in the control setting and the number of underwater vehicles in which the cruising paths are recorded, and the number-managing section determines whether all of the underwater vehicles which should be controlled are located in the control region.

In certain embodiments, when it is determined that the number of the underwater vehicles in which the cruising paths are recorded is equal to or larger than the number of the underwater vehicles which should be controlled, i.e., when it is determined that all of the underwater vehicles which should be controlled are located in the control region, this result is sent to the control-determining section. In certain embodiments, the movement-control system then predicts behaviors of the multiple underwater vehicles based on the cruising paths recorded in the cruising-recording section, and based on this prediction result, control may be performed to move the on-water control system such that the underwater vehicles do not deviate from the control region. According to this, it is possible to prevent the underwater vehicles from deviating from the control region.

In certain embodiments, when moving the on-water control system, it is preferable that the on-water control system is moved in a range where the number of the multiple underwater vehicles located in the control region when the movement is started is not reduced. According to this, it is possible to prevent the number of underwater vehicles located in the control region from being reduced.

In certain embodiments, the when it is determined that the number of the underwater vehicles in which the cruising paths are recorded is smaller than the number of the underwater vehicles which should be controlled, i.e., when it is determined that one or some or all of the underwater vehicles which should be controlled deviate from the control region, the position-estimating section estimates a direction in which an underwater vehicle which deviates from the control region exists based on the cruising paths of the underwater vehicles recorded in the cruising-recording section.

In certain embodiments, when it is determined that the predetermined time is not elapsed, the procedure returns, and it is again determined whether all the underwater vehicles which should be controlled are located in the control region.

In certain embodiments, even when it is determined that one or some or all of the underwater vehicles, deviate from the control region, an underwater vehicle which deviates from the control region returns into the control region by itself and a possibility that although an underwater vehicle is actually located in the control region, it is erroneously detected that the underwater vehicle deviates from the control region by temporal positioning or communication failure. Therefore, it is possible to lower a possibility that the on-water control system unnecessarily moves by keeping, before moving the on-water control system, the on-water control system on standby for predetermined time after it is detected that the underwater vehicle deviates from the control region, and by repeating the determination predetermined times during that time as in this embodiment. According to this, it is possible to prevent consumption of energy of the on-water control system and prevent the underwater vehicle located in the control region from deviating from the control region.

In certain embodiments, the position-estimating section estimates a direction in which an underwater vehicle exists based on the cruising paths of the underwater vehicles recorded in the cruising-recording section, and the movement-control system controls the moving system based on this estimation result. According to this, it is possible to enhance the control precision and moving efficiency of the on-water control system, and an underwater vehicle.

In certain embodiments, all the underwater vehicles can be placed under control of the on-water control system, the underwater exploration can be carried out more safely and efficiently.

In certain embodiments, the exploration conditions which are set by the exploration condition setting system of the multiple underwater vehicles are setting of the exploration conditions in the support ship and except this, instructions from the support ship can also be renewed automatically through the on-water control system or based on a schedule which is programed in the on-water control system.

### BRIEF DESCRIPTION OF THE DRAWINGS

FIG. 1 is an exemplary embodiment of an autonomous underwater vehicle of the invention.

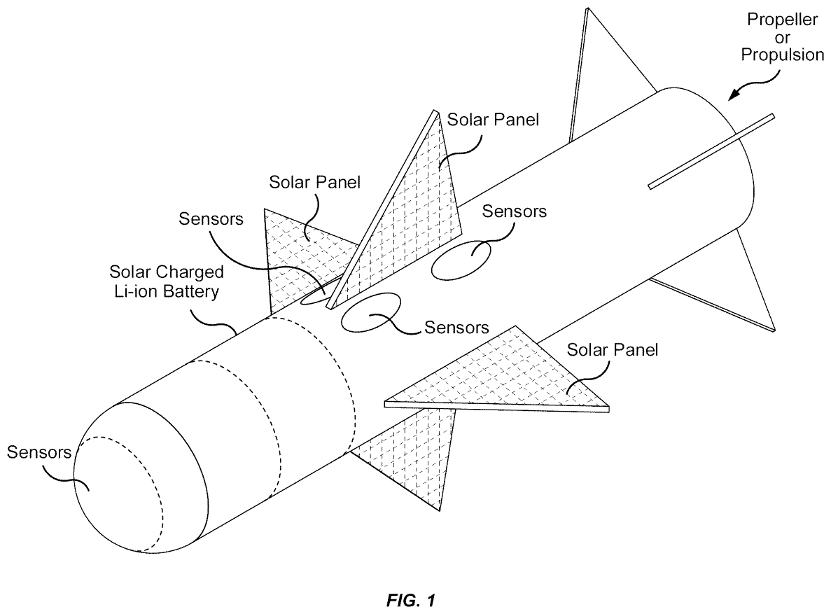

FIG. 2 is an exemplary embodiment of an autonomous underwater vehicle of the invention.

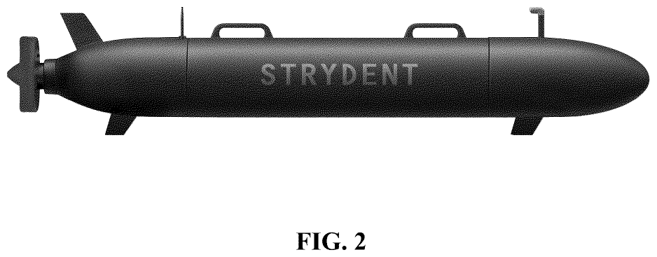

FIG. 3 is an exemplary embodiment of a swarm or fleet of AUVs providing surveillance around a naval or commercial port.

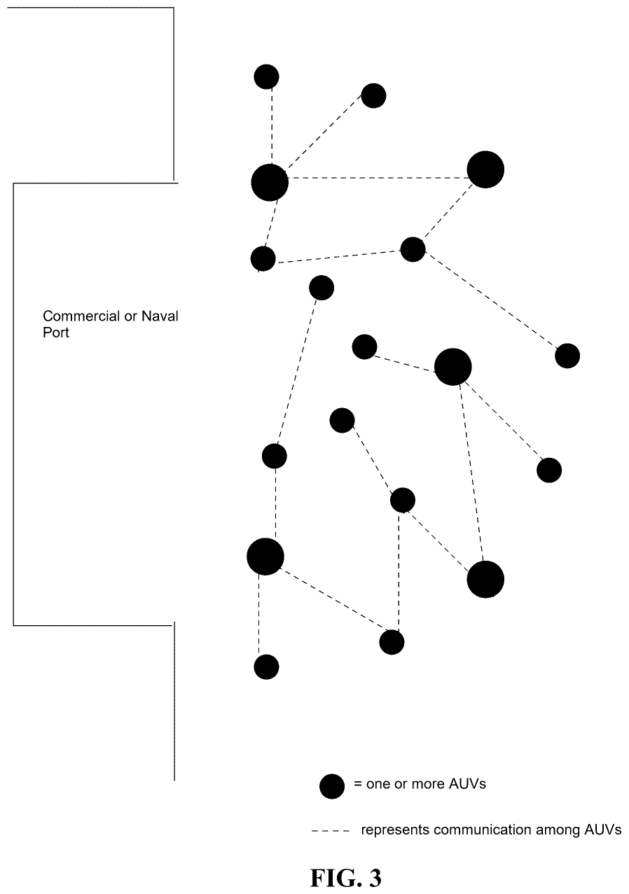

FIG. 4 is an exemplary embodiment of a swarm or fleet of AUVs providing collective communication, for example, for surveillance.

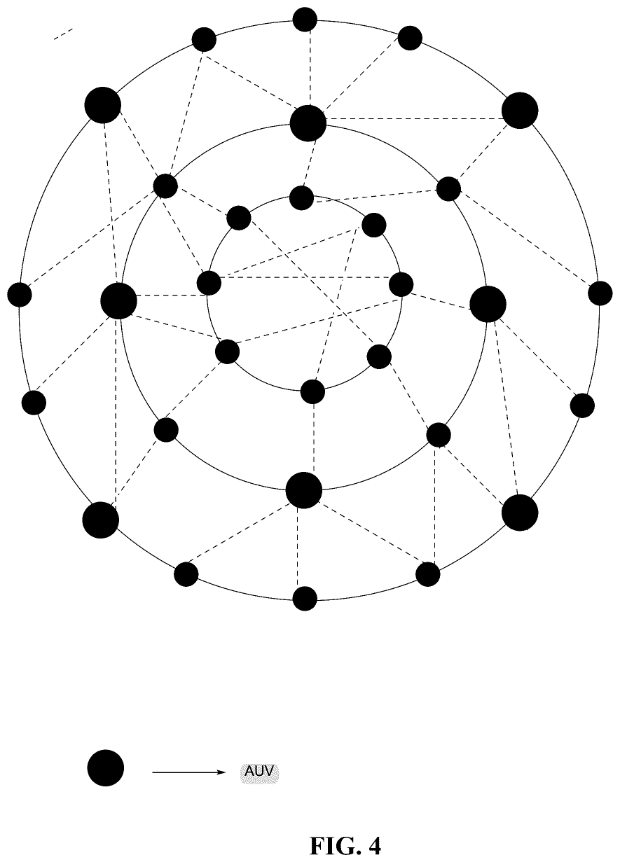

FIG. 5 is an exemplary embodiment of a swarm or fleet of AUVs providing surveillance around a U.S. asset.

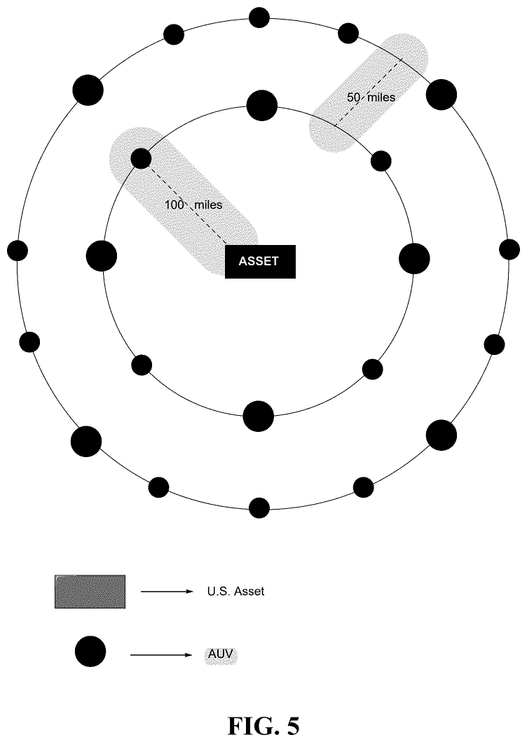

FIG. 6 is an exemplary embodiment of an autonomous underwater vehicle of the invention.

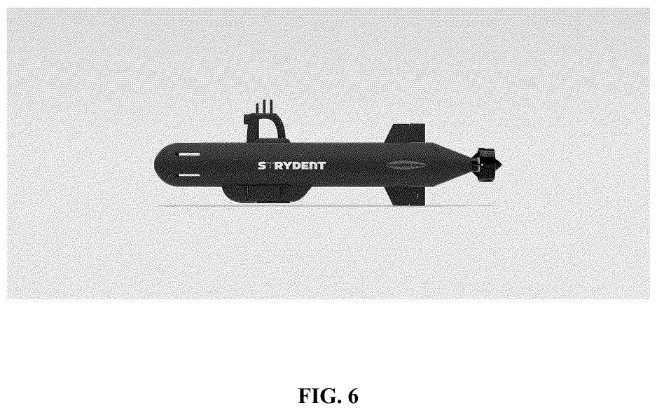

FIG. 7 is an exemplary embodiment of an autonomous underwater vehicle of the invention.

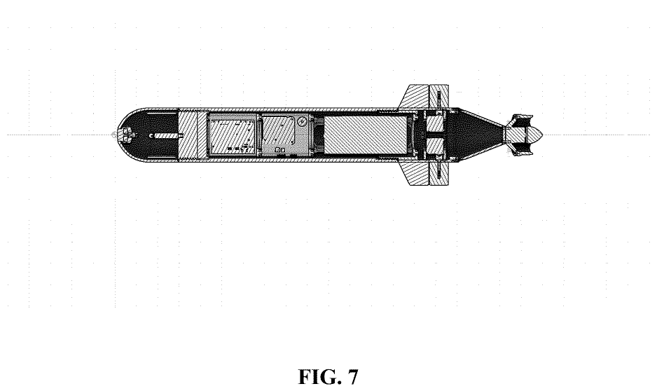

FIG. 8 is an exemplary embodiment of an autonomous underwater vehicle of the invention.

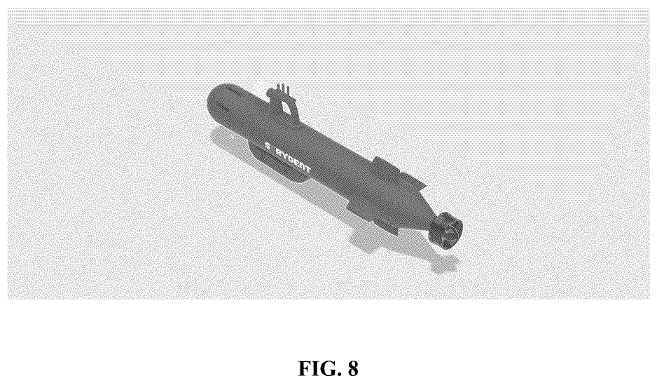

### DETAILED DESCRIPTION OF THE INVENTION

The invention generally encompasses an autonomous underwater vehicle (AUV) that can provide reconnaissance, geographical surveying, and military operations, wherein multiple AUVs operate in a uniform manner to map large areas (e.g., 100 square kilometers or more) at depths of about 20 to about 2,000 meters or greater. The AUV embodiments may generate a bathymetric map of the sea floor and generate high-definition images of specified features such as archeological, biological, or geological features or create an electronic (e.g., radiofrequency) net among multiple AUVs to identify objects at a certain position and time. For example, AUVs may use low-power sensors to collect temperatures, depths, capture still and video images, capture sonar/bathymetric data, and LiDAR data. In certain embodiments, a plurality of AUVs may be deployed from a fully autonomous deployment vehicle; which may include a floating vessel sufficient size to carry the plurality of AUVs.

In certain embodiments, an exemplary AUV may be sized according to the specific use case and sensor package of the AUV; however, a preferred embodiment may be about 1 foot long, 2, 3, 4, 5, 6, 7, 8, 9, 10, 12, 15, or about 20 feet long, include 3 or more wings or fins for stabilization, and weigh around 20 pounds In certain embodiments, an AUV includes a pressure vessel that houses batteries, electronics, and a counterweight system. In certain embodiments, one or more dive planes may be attached to the pressure vessel, which provide dynamic pressure to enable the AUVs to dive. In certain embodiments, the dive planes also serve as mounts for two brushless, DC motors that provide thrust via respective propellers. In certain embodiments, the pressure vessel including the end caps may be configured to withstand pressures to depths of at least 2,000 meters.

In certain embodiments, the dive planes and fins may be made of syntactic foam which provides buoyancy, impact durability, and non-compressive structure even at substantial depths. In certain embodiments, the motor mounting and housing may be made of syntactic foam for the same reasons as the dive planes. In certain embodiments, the end caps may be rated to pressures above the expected operational depth of the AUV, and may be attached to the pressure vessel through, for example, a dual O-ring cylinder-in-cylinder configuration. In certain embodiments, the propulsion system of the illustrated embodiment includes brushless motors, electronic speed controls, and housings. In certain embodiments, the brushless motors may be of a solid-state design, void of gas pockets to accommodate operational pressures at depth, while the windings and rotor may be coated in a corrosion preventative material. In certain embodiments, the dive planes may be angled down relative to the body such that when the AUV is at the surface of the water, the propellers remain submerged.

In certain embodiments, one or more sensors are configured and situated behind the end cap, particularly those sensors requiring a line of sight from the sensor to the environment. In certain embodiments, the sensors may be vacuum potted in a sensor housing to eliminate gas pockets to provide an environment that does not enable or hinder normal operational function, whether or not the vessel is in or out of water.

In certain embodiments, the AUV may further include a sensor package enclosed within a housing attached to the front of the AUV, which may contain sensors, such as: a low-power laser-based LiDAR (Light Distancing and Ranging) system, a video camera, a GPS (Global Positioning System) antenna, a GPU (Graphic Processing Unit), a CPU (Computer Processing Unit), and a depth sensor. In certain embodiments, the sensor package may optionally contain other mission specific sensors, such as a fluorometer, a thermometer, pH meter, single or multibeam sonar, etc., for information gathering. In certain embodiments, the electronics in the sensor head may be potted and may be configured to withstand pressures at least depths of 2,000 meters or more.

In certain embodiments, the pressure vessel may be based on a hollow or substantially hollow cylindrical tube that has been adapted to house electronic components and batteries. The tube may be constructed of a variety of materials, including but not limited to plastic, composite, and aircraft quality aluminum, or steel, dependent upon mission requirements.

In certain embodiments, mounted on the outside of the pressure vessel there are two stationary dive planes. These provide dynamic force to cause the AUV to ascend or descend as required by the navigation and obstacle avoidance programs. When the AUV is traveling in a level attitude the dive planes are in a preset position to counteract the buoyancy of the AUV. The dive planes drive the AUV up or down using dynamic force when the nose is in an up or down position, which is accomplished by shifting the AUV's center of gravity.

In certain embodiments, the AUV shifts its center of gravity using an internal counterweight that is shifted forward or backward on an internal carriage assembly. Moving the counterweight forward or aft on the carriage and rail assembly causes the center of gravity of the AUV to change, and consequently the nose of the AUV will pitch up or down and the dynamic force of water flowing over the dive planes causes the AUV to rise or dive. The dive planes may be cast from syntactic foam, contain the lights for the video camera, and also serve as the mounting structure for the brushless motors.

In certain embodiments, the AUVs may be powered by one or more (e.g., four) 10,000 mah (milliamp hour) Lithium-Ion batteries. In certain embodiments, the internal batteries power the internal electronics package and the additional sensor packages that could consist of: CPU/GPU unit, sensor package, LiDAR system, GPS, and video camera. In certain embodiments, the internal electronics may draw approximately 1 amp of current. In certain embodiments, the motors may draw approximately 1 to 2 amps of current at minimum cruising speed and about 3 to about 5 amps of current at maximum cruising speed. The video camera lights may draw an additional 0.5 amp.

In certain embodiments, the AUV as described herein may incorporate an internal counterweight system and dive plane mechanism that provides unique stability and suitability of the disclosed AUVs for operating autonomously underwater. In certain embodiments, the AUV incorporates a unique pitch and yaw control. While conventional torpedo shaped designs having a single aft-located motor rely on control vanes at the aft end of the body, such conventional designs require actuators to move control surfaces which produce dynamic force to turn and dive the AUV. In certain embodiments, dive planes located on the center of gravity of the vehicle's body tube and an internal counterweight system to turn and drive the AUV.

In certain embodiments, the internal counterweight may be moved internally to shift the center of gravity to provide pitch control. In certain embodiments, the AUV can be pitched up or down by as much as thirty degrees due to dynamic forces acting on the dive planes. In certain embodiments, the dive planes may be static and may thus reduce the moving external components that provide potential modes of failure in conventional underwater vehicles.

In certain embodiments, the dive planes serve as motor mounts for motor driven propellers using waterproof brushless motors. In certain embodiments, the two motors and propellers, one mounted on each dive plane, may be counter rotating to reduce the inertial effects of the rotation of the propellers.

In certain embodiments, the benefit of the design using the movement of the internal counterweight along a carriage/rail system within the body results in no external actuators required to move control surfaces, such that the design is simpler and more robust, which reduces the likelihood of control surface failure.

In certain embodiments, the components of the AUV include a body, a cavity defined within the body may include a sensor array that may include various components as described in greater detail below, and which may be distributed throughout the cavity rather than in the position shown. In certain embodiments, the within the cavity may be one or more batteries generally positioned along a bottom of the body to provide ballast and orient the AUV in water.

In certain embodiments, the dive plane may be located proximate a center of gravity of the AUV. A counterweight may also be disposed proximate the center of gravity of the AUV in a neutral position when no pitch is desired. The counterweight may be located on a rail system along which the counterweight may move. The counterweight may be moved fore and aft along the rail based on a control signal from a propulsion controller to guide the AUV. In certain embodiments, the counterweight may be moved aft along arrow to cause the nose of the AUV to pitch up for ascent, while the counterweight may move in the opposite direction, away from arrow, to cause the nose to pitch down for descent. In certain embodiments, the counterweight system may eliminate the need for control surfaces that pitch to control an AUV. Further, the two motors and propellers mounted opposite one another on the dive planes may provide steering through independent operation. Through these techniques, full control of the AUV may be provided with few moving parts and with greater reliability than dive planes that move relative to the body of the AUV.

In certain embodiments, during data collection, the AUVs could act as a group or swarm that follow a preprogrammed course, altitude, and speed. In certain embodiments, the sensor and image data could then be recorded to an internal storage media and processed at the surface to extract information. In certain embodiments, utilizing the collected data, a topographical map could be made from: high-resolution LiDAR data, high-resolution video images, sonar data, along with position and depth information.

In certain embodiments, in seawater, the AUV of example embodiments is approximately 0.5 to 5 pounds buoyant. In certain embodiments, thrust from the motors and dynamic forces over the dive planes are used to propel the AUV forward and downward. If power to the AUV is lost, it will eventually surface on its own. All abort scenarios cause the AUV to surface and activate a locator beacon so that it can be retrieved.

In certain embodiments, the AUVs may act a swarm configured to map a body of water (i.e., sea) which may include lakes, seas, oceans, etc. In certain embodiments, various techniques may be used to map the sea, of which SONAR is most common. However, SONAR suffers from limitations that inhibit the speed of sea mapping. SONAR using sound pulses may be more susceptible to error when used at relatively high speeds due to factors such as the Doppler effect when the speed of travel of a submersible is not negligible relative to the speed of sound in the water.

In certain embodiments, light, rather than sound, may be used to map the sea with a unique implementation of LiDAR technology. In certain embodiments, SONAR may be used in conjunction with LiDAR where LiDAR is limited or error prone (e.g., in cloudy/murky water), LiDAR may be the primary mapping method in various embodiments due to the advantages.

In certain embodiments, a novel LiDAR system that operates on two different wavelengths of lasers and a digital camera connected to a GPU/CPU. The two different laser wavelengths function as two LiDAR systems sharing a receiver with each wavelength of light used to obtain different data.

In certain embodiments, a group of AUVs traveling in the sea may include a LiDAR system using a laser producing a laser beam of a first wavelength, which may be oriented along the centerline of the AUV and set at an angle impinging upon the substantially horizontal sea floor. In certain embodiments, the laser may emit a single beam of light to a single point in front of the AUV that will intersect a second AUV at some distance ahead of the first AUV and, preferably, within the field of view (for most water conditions) of a digital camera.

In certain embodiments, if the first AUV travels at a depth of, for example twenty feet from the second AUV, and the laser is directed at an angle from the centerline of the first AUV of 45 degrees, the point of laser light will be seen twenty feet in front of the first AUV. In certain embodiments, by measuring the position of this point in the field of view, the GPU/CPU unit can calculate the distance, the depth of the field of view, and the basic contour of the sea between one or more AUVs. In certain embodiments, the algorithm may use a lookup table that corresponds to the laser dot position at a specific distance. In certain embodiments, the distance may initially be determined by trigonometry before it is entered into the lookup table.

In certain embodiments, the AUVs compute a navigation trajectory metric associated with the set of data using a deployed learning network model by leveraging the features and associated target value for the navigation trajectory network to determine the associated navigation trajectory for the group of submersible underwater vehicles; and wherein the AUVs further comprise a linked communication system wherein depending on maritime conditions the swarm of AUVs communicates with one another and/or with a command-and-control system (C2) using a combination of acoustic, RF, and optical communications,
wherein the optical based communication system comprises: one or more of a photon-counting detector, a boundary detector operably coupled to the photon-counting detector, at least one alignment block operably coupled to the boundary detector, and a rate decision block operably coupled to the alignment block(s), wherein the photon-counting detector transduces an optical signal with a variable data rate into a digital signal including a symbol having a data period and a guard period, wherein he boundary detector senses a boundary (e.g., a rising or falling edge) of the digital signal and indicates a photon arrival at the photon-counting detector, wherein the alignment block estimates a number of photons detected by the photon-counting detector during the guard period at each of a plurality of predetermined data rates based on the boundary of the digital symbol, and the rate decision block estimates the variable data rate of the optical signal based on the number of photons detected by the photon-counting detector during the guard period at each of the plurality of predetermined data rates.

In certain specific embodiments, the optical communication system includes a plurality of lasers acquired and characterized by an acquisition module; a laser tracking module; a beacon feedback and beam dispersion mechanism; an adaptive learning detection algorithm implemented using an adaptive learning unit to identify and track unique optical signatures from at least one of the acquired lasers; and an aiming module aimed by at least one laser at a target based on the acquired laser.

In certain embodiments, a laser of the AUV may project a matrix or array of points of light within field in front of the AUV in a direction of the centerline of a second or groups of additional AUVs, within the field of view of the digital camera. In certain embodiments, the GPU/CPU unit may be programmed to recognize the individual points of light based on their color and shape. In certain embodiments, the GPU/CPU unit may then calculate the relative positions of the points of light, assign an index number to them for tracking from frame to frame, and calculate the size of each point and distance from the center of the field of view. In certain embodiments, this system creates a three-dimensional LiDAR system and the matrix of points is used to detect obstacles in the path of the AUV.

In certain embodiments, the system provides the AUV with a basic machine vision capability using one or more lasers and one or more cameras. In certain embodiments, the system described herein uses geometry of the laser points to determine distance between points, and the distance of each point from one or more AUVs.

According to the embodiments described herein, two or more LiDAR systems cooperate to provide a comprehensive LiDAR system that provides unique advantages over existing technologies. In certain embodiments, the first system provides information to the CPU to maintain a desired distance above the bottom to conduct mapping operations and also provides a reference point in determining the depth of field. In certain embodiments, the second system then uses the depth of field to establish the horizon for the field of view that aids in weighting the various points of light to determine if they represent obstacles that must be avoided, or if they are simply minor features that require no action on the part of the AUV.

In certain embodiments, the GPU/CPU may be programmed to divide the field of view into four quadrants. In certain embodiments, the segments of the quadrants may not necessarily be of equal size. In certain embodiments, the right side of the field of view may be divided from the left along the center line. In certain embodiments, the horizontal line may divide the top from the bottom, and the horizontal line may move up and down in the field of view dependent upon the location of the point of light emitted by the first laser. In certain embodiments, the “horizon line” separates the near field from the background. The CPU of the vehicle may receive instructions to maneuver in order to avoid objects in the near field.

In certain embodiments, the field of view is divided into quadrants by the horizontal line and the vertical line. In certain embodiments, a matrix of light points is interpreted by the GPU/CPU to establish the location of objects within the field of view such that they may be avoided or detected. In certain embodiments, the data generated by the dual LiDAR system may be recorded for use in creating detailed bathymetric maps of the sea using a structure from motion algorithm.

In certain embodiments, the use of two different wavelengths of laser light enables a clear distinction between the single point and the matrix of points to maintain an accurate indication of speed and altitude, while also being able to readily interpret the matrix of laser light points through the image sensor field of view.

In certain embodiments, the swarm of AUVs may traverse a sea at a considerably higher speed than possible using SONAR mapping due to the limitations of SONAR. As such, embodiments described herein can map a larger area in a shorter amount of time rendering embodiments considerably more efficient and effective at covering large swaths of area in a compressed time allotment.

In certain embodiments, the swarm of AUVs can accurately determine and maintain its location to be able to properly correlate the mapped sea floor with a latitude and longitude or other global measurement metric. In certain embodiments, the swarm of AUVs may use an Inertial Navigation System (INS) using an onboard compass, gyrometer, accelerometer, and pressure transducer that produce information that can be processed by the CPU/GPU and interpreted by software specifically developed for the described system. In certain embodiments, the INS as described herein may be an advanced dead reckoning system that may have some degree of error. In certain embodiments, a method of reducing error is using the INS in conjunction with the LiDAR system to determine the speed of the AUV relative to correct/verify the speed of the INS system. In certain embodiments, the AUV swarm is configured to detect drift caused by side currents using the INS including the three-axis gyrometer and the three-axis accelerometer, along with a compass. In certain embodiments, the AUV may compensate for side current by tacking into the current in the same manner that an aircraft tacks into the wind. An algorithm for tacking into the current may be derived from algorithms used for aircraft tacking into the wind.

In certain embodiments, a “swarm” refers to a plurality of AUVs operating in cooperation with one another. In certain embodiments, each AUV can only cover a limited amount of surface in a given time, deploying a plurality or “swarm” of AUVs can maximize surface area coverage within a finite amount of time. In certain embodiments, the AUV swarm is composed of a number of AUVs, each independent of the other members of the swarm with a preprogrammed search area to explore. The size and number of swarms is determined by the size and shape of the target area to be mapped. In certain embodiments, a typical swarm may consist of approximately 10, 100, 1,000, or about 10,000 s of AUVs. In certain embodiments, once the swarm has completed its data collection operations, the members of the swarm may be configured to surface and travel to a predetermined rendezvous point where they can be retrieved or they may surface and their batteries recharge for example via a solar charging and then complete an additional mission.

In certain embodiments, the size of the swarm will be determined by the size of the area to be covered. It is expected that each AUV will map about 10, 20, 30, 40, 50, 60, 70, 80, 90, or 100 km² during a 10-hour data collection window dependent on water visibility and currents. In certain embodiments, the search area for the swarm may be established based on GPS coordinates prior to deployment of the swarm. In certain embodiments, each member of the swarm may be assigned a prescribed search area; however, if an AUV is unable to complete its search function, the AUV may communicate with the deployment vessel, such as by acoustic modem. In certain embodiments, the deployment vessel may then launch a replacement AUV to complete the mission of the failed unit.

In certain embodiments, the swarms can be deployed from a single or multiple locations, autonomously or manually. In certain embodiments, a deployment vessel may be used to deploy a swarm, where each AUV may be deployed from a single location, or deployed as the deployment vessel traverses the surface of the water above the target area to be mapped. In certain embodiments, aerial deployment may be possible where the AUVs are dropped into the water in which case the AUVs may be equipped with parachutes or other systems to avoid substantial impact upon reaching the water surface. Once deployed, the swarm may perform the prescribed mapping. Once the mapping is complete, each member of the swarm may return to the surface and identify its location to a recovery vehicle, which may be the deployment vessel. Optionally, the AUVs may be programmed with a rendezvous point such that the swarm of AUVs may each return to the rendezvous point once mapping is completed.

In certain embodiments, the AUVs may be powered by about 1, 2, 3, 4, 5, 6, 7, 8, 9 or about 10 10,000 mah (or larger) Lithium-Ion batteries.

In certain embodiments, the LiDAR system used is a proprietary design based on a low-power laser and a digital camera connected to a GPU/CPU unit. In certain embodiments, the laser is low power to conserve battery life and to minimize danger to the marine environment. In certain embodiments, the LiDAR operates by projecting a matrix of laser light at a known angle from the video camera. The matrix consists of an ordered set of projected points. In certain embodiments, the GPU of the camera detects the points of light and measures each pixel to determine straight line distance, position, and size of the projected points. In certain embodiments, the data is used by the internal GPU/CPU to perform obstacle detection and avoidance and determine water visibility, as well as altitude above the bottom. In certain embodiments, the data is stored internally on a storage media for later extraction and computation of map information.

In certain embodiments, the failure of an AUV may be mitigated by other AUVs in a swarm through other AUVs covering the region of the failed AUV. There are two primary methods that an AUV may use to determine potential failure. In certain embodiments, a first mode of failure may be due to battery life. In certain embodiments, a battery monitor may be connected to the batteries that check the amount of charge remaining in each battery against a mission clock that identifies how much of the mission remains. In certain embodiments, the monitor may also calculate the rate of drain on the batteries and compare that rate against the remaining time for the mission. In certain embodiments, if the monitor determines that there is insufficient battery life to complete the mission, the AUV will abort the mission before fully draining the batteries to allow the AUV sufficient power to return to a rendezvous point. Another failure mode may include a leak in the pressure vessel. In certain embodiments, a lead detector may monitor the internal humidity and pressure of the AUV. If there is a leak in the pressure vessel, then the internal humidity and the pressure will rise. In certain embodiments, upon detection of a leak, the mission may be immediately aborted with the AUV returning to the rendezvous point. In certain embodiments, abort scenarios generally return the AUV to the rendezvous point. Once at the surface, the AUV may activate a beacon to provide an indication of the failure and the location of the AUV for collection. The planned

In certain embodiments, the ocean reconnaissance route of the AUV is defined by a starting location (where the AUV is submerged in the ocean) a sequence of waypoints, and a destination (rally point). In certain embodiments, each of these are defined by their latitude and longitude coordinates. This set of coordinates (starting point, waypoints, rally point) comprise the AUV's navigation path through the ocean, or “mission.” In certain embodiments, the navigation may be performed based on the locating mechanism described above including an inertial navigation unit and a sensor array configured to provide dead reckoning navigation once submerged.

In certain embodiments, prior to execution of the mission, the AUV uses its onboard GPS to obtain a fix for its current position. In certain embodiments, the position is recorded as the mission starting point. In certain embodiments, the AUV is preloaded with mission instructions which are executed from the mission starting point. In certain embodiments, the mission instructions are loaded onto the AUV prior to transport to the area to be mapped. Each AUV is activated prior to deployment to obtain an initial GPS fix. Once the GPS fix has been obtained the AUV is deployed into the water to begin its mission.

In certain embodiments, the AUV executes its mission by navigating from the starting point to each mission waypoint in sequence, and finally to the rally point at the end of the mission or in certain embodiments, the AUVs may continue. In certain embodiments, upon arrival at each mission waypoint, the AUV will compute the estimated time to travel to the next waypoint and add the estimated time to travel from there to the rally point. It then compares that time duration to the estimated amount of battery life remaining. If battery level is sufficient it proceeds with the mission, if not then the AUV will abort the mission.

In certain embodiments, the AUV will surface close to the rally point. Upon surfacing, the AUV will obtain a GPS position fix, and proceed to navigate on the surface towards the rally point, obtaining additional GPS fixes as it travels. Recovery is performed at the rally point as the AUV arrives.

In certain embodiments, navigation from waypoint to waypoint requires management of AUV depth and heading. Depth is managed through monitoring a pressure transducer, which measures pressure changes. Heading is managed by use of the onboard Inertial Navigation System (INS). Ocean currents will require heading corrections for the AUV to remain on course. As the AUV travels, it constantly adjusts its heading by reading the INS data, comparing it to the desired course, and computing a drift compensation angle. The AUV then adds/subtracts this angle to find a new heading which compensates for drift.

In certain embodiments, data collection will be conducted while one or more AUVs travel along the designated search path. In certain embodiments, the CPU/GPU unit in each AUV includes an internal storage media where data will be stored. Data collected will include full motion video, LiDAR data, depth, position, speed, internal temperature, internal humidity, and external temperature.

In certain embodiments, full-motion, color video will be recorded at a high resolution. In certain embodiments, single monochrome frame from the video will be sampled once per second and this image will be used to create a photo montage of the AUV's designated search area. The photo montage will be produced by a graphics server on the surface after retrieval.

In certain embodiments, LiDAR data will be used by the CPU/GPU for navigation and obstacle avoidance while the AUV is performing data collection. This data will also be stored on the internal storage media for later processing of image data and to produce bathymetric maps.

In certain embodiments, depth, position, and speed will be used by the navigation program while the AUV is conducting data collection. This information will be logged and used to produce a 3D mesh of the mapping area. This mesh will be produced during the data processing window on shore or afloat.

In certain embodiments, data may be stored internally in the AUV until it is retrieved and returned to shore. In certain embodiments, the internal CPU/GPU unit will be used to process some LiDAR data while the AUV is operating. In certain embodiments, the extricated from the mission the CPU/GPU units of the AUVs will be connected together via a wireless network to produce a local cloud which may be used for further processing of the data.

In certain embodiments, data correction may be performed after the data is collected, such as when an AUV may return to the surface of the water at an expected position, and subsequently determine that the actual location at the surface is different. While an initial position of the AUV at the surface may be positively determined by the AUV using available satellite navigation methods or other such methods available at the surface, once submerged, the navigation relies upon the INU and dead reckoning. The navigational information collected while below the surface of the water, such as the position calculations, accelerations, turns, drift, etc., which are recorded during data collection, can later be adjusted based on an offset of the actual final location of the AUV versus an anticipated final location of the AUV. For example, if the AUV surfaces ten feet from its expected home position and it ran for two hours collecting data, then the error is averaged to five feet of error accumulated per hour of operation. In actual operation, however, the amount of expected error is on the order of inches per hour of operation based on the specifications of the electronics used and described above. Most errors stem from instantaneous accelerations that may be too short in duration for the data sample rate to detect.

In certain embodiments, the sensors may be checked onboard the AUV to ensure data integrity from the sensors. In certain embodiments, rotational motion can be checked using the electronic compass and the three-axis gyrometers. In certain embodiments, changes in depth can be checked using the three-axis accelerometer and the depth sensor. Likewise, changes in pitch can be checked using the three-axis gyrometer and the depth sensor.

In certain embodiments, the surface vessel may have an inertial navigation package, autopilot, dynamic positioning equipment, radar, LiDAR, GPS, and autonomous controls. In certain embodiments, the AUV swarms are loaded onto the vessel on shore and then driven to the mapping area. While on the shore each AUV is preloaded with a search pattern for a designated area, internal clocks are synchronized, and initial coordinates are loaded. In certain embodiments, the AUV's INS system is active while they are being transported to the mapping area.

In certain embodiments, once deployed, each AUV begins diving to its mission depth, and traveling to its designated search area. As the AUV approaches its mission depth, it will level off and begin following the contour of the bottom along the designated search path. LiDAR, video, and environmental sensors will be activated, and the data collection process will begin.

In certain embodiments, once the AUVs have completed their data collection operations, they will move to a preprogrammed recovery point. In certain embodiments, the surface vessel will be waiting at the recovery point and will maintain position using its dynamic positioning system. In certain embodiments, the surface vessel could be controlled by the same CPU/GPU unit that controls the AUVs or manually operated. In certain embodiments, the CPU/GPU would have the ability to perform object and color recognition and be able to identify and retrieve the AUV swarm, should the recovery vessel be operated autonomously.

In certain embodiments, the recovery mechanism could consist of a metal cage which is lowered through the deck of the recovery vessel near the center of gravity. Each AUV will navigate to a position near the bow of the recovery vessel and then drive itself between the pontoons and into the cage. When the recovery vessel detects that an AUV has entered the recovery cage it will raise and empty the AUV onto a storage rack. The cage will then be lowered into the water and the vessel will wait for the next AUV to enter.

In certain embodiments, once the AUVs have been recovered, the surface vessel will take inventory to determine if all AUVs are accounted for. If so, the vessel will take the fastest route to shore. In certain embodiments, the AUVs will be off loaded and replenished for redeployment. Replenishing the AUV simply involves replacing the internal storage media with the collected data and replacing it with a storage media without previously collected data, but with new instructions for a new search area, and replacement of the internal batteries.

In certain embodiments, each AUV evaluates its status based upon the intended search pattern, the waypoints designated, power consumption, navigation, and expected battery life. If the AUV determines that it is unable to complete the mission then it will abort the mission and travel to the recovery area.

Once on the surface the aborted AUV will attempt to navigate to the rendezvous point to be retrieved. The rest of the swarm will continue to gather data and proceed normally to the rendezvous point.

In certain embodiments, the CPU/GPU may be embodied by a number of different computing/processing systems which may be specifically configured to perform the operations described above. In certain embodiments, the CPUGPU may include a variety of computing devices that include or are otherwise associated with an AUV. For example, the computing device may be a CPU/GPU which may at least partially control autonomous or semi-autonomous features of the AUV. In certain embodiments, apparatus may be equipped with any number of sensors, such as a global positioning system (GPS), accelerometer, image sensor, LiDAR (Light Distancing and Ranging) sensor, radar, pressure transducer, and/or gyroscope. Any of the sensors may be used to sense information regarding the movement, positioning, or orientation of the AUV for use in navigation assistance and/or to facilitate sea floor mapping, as described herein according to example embodiments. In certain embodiments, the CPU/GPU may be configured to control the navigational functions of the AUV, such as independent control of the motors driving the propellers and control of the counterweight system.

### AUV Communication System

The invention generally encompasses a group of two or more autonomous underwater vehicles that communicate with each other using a combination of acoustic, RF, and optical communication system, wherein each vehicle comprises:
a generative learning system comprising at least one processor and at least one memory configured to implement a deployed learning network model, the deployed learning network model generated from a training network, wherein the training network is tuned using features extracted from a set of data received from the one or more sensors in the group of submersible underwater vehicles, and wherein data associated with each of the one or more sensors indicates a navigation model, the at least one processor configured to at least:
automatically process a first set of data using the deployed learning network model to generate a navigation trajectory;
compute the navigation trajectory metric associated with the set of data using the deployed learning network model by leveraging the features and associated target value for the navigation trajectory network to determine the associated navigation trajectory for the group of submersible underwater vehicles; and wherein the AUVs further comprise a linked communication system wherein depending on maritime conditions the swarm of AUVs communicates with one another and with a command-and-control system (C2) using a combination of acoustic, RF, and optical communications,
wherein the optical based communication system comprises: one or more of a photon-counting detector, a boundary detector operably coupled to the photon-counting detector, at least one alignment block operably coupled to the boundary detector, and a rate decision block operably coupled to the alignment block(s), wherein the photon-counting detector transduces an optical signal with a variable data rate into a digital signal including a symbol having a data period and a guard period, wherein he boundary detector senses a boundary (e.g., a rising or falling edge) of the digital signal and indicates a photon arrival at the photon-counting detector, wherein the alignment block estimates a number of photons detected by the photon-counting detector during the guard period at each of a plurality of predetermined data rates based on the boundary of the digital symbol, and the rate decision block estimates the variable data rate of the optical signal based on the number of photons detected by the photon-counting detector during the guard period at each of the plurality of predetermined data rates.

In certain specific embodiments, the optical communication system includes a plurality of lasers acquired and characterized by an acquisition module; a laser tracking module; a beacon feedback and beam dispersion mechanism; an adaptive learning detection algorithm implemented using an adaptive learning unit to identify and track unique optical signatures from at least one of the acquired lasers; and an aiming module aimed by at least one laser at a target based on the acquired laser.

In one embodiment, the autonomous underwater vehicles (AUVs) of the invention run their own tasks with a high degree of autonomy and are equipped with appropriate electronic devices. In another embodiment, the autonomous underwater vehicles or AUVs of the invention are developed as classical autonomous unmanned systems using propellers and underwater gliders driven by gravity and/or buoyancy, respectively.

In certain embodiments, the AUVs wireless optical communications network for communications among a variety of AUVs, allows these platforms to also communicate with surface vessels, such as a ship, via an underwater optical communications link. The ship, in turn, may communicate with aircraft, satellites, and ground stations via existing optical and radio-frequency links. Likewise, the deep-submerged infrastructure interfaces may connect the underwater wireless optical communications network with a seafloor acoustic array and other acoustic for both passive acoustic sensing and underwater acoustic communication.

In certain embodiments, each platform connected to or forming part of the underwater wireless optical communications network can include a transmitter and receiver for two-way communication. (Some platforms may have only a transmitter or a receiver, not both, and be configured for one-way communication). As described in greater detail below, each transmitter can transmit a laser beam modulated with a rate determined in part by the desired data transmission rate and the link loss between the transmitter and the receiver. This data rate is a member of a set of possible data rates that is discrete, finite, pre-determined, and known to both transmitter and receiver. In certain embodiments, the transmitter may switch among data rates in the set of possible data rates during the transmission, e.g., in response to variations in the link loss caused by fish, turbidity, sediment, distance variations between the transmitter and receiver, and other environmental perturbations. In certain embodiments, the transmitter may also vary the FEC code rate as well. In some cases, the transmitter may change the data and FEC code rates at every frame in the transmitted signal.

In certain embodiments, the receiver detects the transmitted signal, determines the data and FEC code rates on a frame-by-frame basis, and uses the detected rates to decode the signal. In some cases, the receiver estimates the channel (e.g., the signal and background levels) faster than the code rate. For example, at a (highest) data rate of 10.416 Mb/s, the receiver may re-estimate the channel every 16384 bits. At a (lowest) data rate of 1.302 Mb/s, the receiver re-estimates the channel every 2048 bits. In this example, the frame itself is longer at 65856 bits. This enables the transmitter and receiver to stay connected even when the link loss fluctuates wildly during the transmission. If the loss is too high (e.g., because a fish is in between the transmitter and receiver), however, the system may simply stop transmitting until the loss falls to acceptable levels.

In certain embodiments, the system can respond to link loss fluctuations with a speed that depends on the integration time W which represents the number of samples or slots as discussed below with respect to FIG. 9A. For example, in the implementation described below, the slot period is 4 ns. The integration period W=(24 slots per bit at a data rate of 10.416 Mb/s)×(16384 bits)×(4 ns)=1.57 ms. So, in this example, the receiver expects the channel to be roughly constant for about 1.57 ms. Shortening this integration time allows the receiver to handle faster fluctuations in the channel loss. On the other hand, a shorter integration time can yield noisier estimates.

In some cases, the link loss may range from almost nothing to roughly 100 dB. The ability to support on-the-fly changes in data and FEC code rates also allows the link to tolerate and adapt to a range of background light levels. The link can be designed to vary its data rate according to changes in link quality, allowing high data rates in the presence of low loss and low background, and robust communications in the presence of low light or high noise. As a result, the link can operate with robust data transmission and reception at the highest rate supported by the channel.

In certain embodiments, the CPU/GPU may include, be associated with, or may otherwise be in communication with a communication interface, processor, and/or a memory device. In some embodiments, the processor (and/or co-processors or any other processing circuitry assisting or otherwise associated with the processor) may be in communication with the memory device via a bus for passing information among components of the apparatus.

In certain embodiments, the memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). In certain embodiments, the memory device may be configured to store information, data, content, applications, instructions, or the like for enabling the apparatus to carry out various functions in accordance with an example embodiment of the present invention. For example, the memory device could be configured to buffer input data for processing by the processor. Additionally, or alternatively, the memory device could be configured to store instructions for execution by the processor.

In certain embodiments, the processor may be embodied in a number of different ways. For example, the processor may be embodied as one or more of various hardware processing system such as a microprocessor, a controller, a digital signal processor, or other processing circuitry including circuits such as an application specific integrated circuit, an field programmable gate array, a microcontroller unit, or the like.

In certain embodiments, the CPU/GPU may optionally include a communication interface that may be any system such as a device or circuitry embodied in either hardware or a combination of hardware and software configured to receive and/or transmit data to/from other electronic devices, such as communicating between an AUV associated with the apparatus and a deploying vessel or with other AUVs of the swarm. In certain embodiments, communication may be performed over any available communication protocol, such as near field communication, cellular communication, sonar, Global System for Mobile Communications (GSM), or the like.

In certain embodiments, the memory may be configured for storage of bathymetric data received from the LiDAR systems described above and may store navigational information such as a geographical area to map and rendezvous points for returning to after mapping is complete, for example. Optionally, the memory may store computer program code for execution by the processor to perform any of the aforementioned processes.

Technology is disclosed herein to enable data transfer from an AUV to cloud destinations. (Herein, the terms “AUV” and “vehicle” are used interchangeably with “AUV.”) In certain embodiments, the AUV is tasked by a user, such as a AUV dispatcher or operator, with performing a mission or task which entails collecting and storing data, such as sensor data or telemetry data. In certain embodiments, a data file of data acquired while performing the task is to be transferred to a destination from which an interested party can access the data.

In certain embodiments, a user may configure a task for a AUV in a client application for a cloud-based vehicle operations servicer. Information relating to the task may be sent to the cloud service by an application portal hosting the client application. Communication between the application portal and the cloud service may be transmitted via an API. The cloud service then sends information relating to the task to a vehicle assigned to the task.

During or upon completion of the task, the AUV transmits a unique filename or identifier of the data file associated with the task to a relay resource. The relay resource receives the request and relays it via a second or “relay” API to the cloud service to obtain transfer instructions. In certain embodiments, the transfer instructions may include a destination of the data file as well as information pertaining to the transfer, such as an authorization key by which the relay resource can interface with the destination and an encryption key to ensure the integrity of the data. Upon obtaining the transfer instructions, the relay resource obtains the data file from the vehicle and transfers it to the destination according to the instructions.

In certain embodiments, the cloud service determines the transfer instructions, including destination information, based on a unique identifier of the data file to be transferred. The unique identifier may be configured by concatenating parameters relating to the vehicle, the vehicle's organization, the task and/or the data type. The cloud service stores transfer instructions or information pertaining to file transfer in a transfer log or database according to one or more of the filename parameters. For example, the unique filename or identifier for a data file may be created by a naming convention or rule which concatenates parameters of the task, such as a task identifier, a vehicle model designation, vehicle identifier, an organization identifier, and/or a data type or kind. The cloud service may determine the file destination based on the organization and file type obtained by parsing the unique identifier according to the naming convention or rule.

In certain embodiments, the destination information of the transfer instructions may include a web address for the destination and an authentication key for uploading the data file to the destination. The cloud service then responds to the request by sending instructions for transferring the data file to the relay resource via the relay API.

In certain embodiments, the relay resource receives the instructions for transferring the data file, and the relay resource downloads the data file from the vehicle and uploads it to the destination according to the instructions. In certain embodiments, the relay resource receives confirmation from the destination that the file has been successfully uploaded. The relay resource then sends to the vehicle an indication of the successful transfer, upon receipt of which the vehicle deletes the data file from its onboard storage. In certain embodiments, the relay resource receives the unique identifier of the data file as well as the data file from the vehicle via the relay API.

In certain embodiments, the relay resource receives the transfer instructions, the relay resource sends the transfer instructions to the vehicle. The vehicle then transfers the data file directly to the destination by establishing an Internet connection via a wireless access point, such as a Wi-Fi router.

In certain embodiments, the relay resource is a service called by or executing within a mobile application operating on a mobile computing device or controller in wireless communication with the vehicle. In other implementations, the relay resource may be a service operated by the control system of the vehicle. For example, a Wifi-enabled AUV may connect via a wireless access point to communicate with the cloud service which enables the onboard relay resource to request and obtain the transfer instructions from the cloud service and to transfer the data files to the destination.

In certain embodiments, an end-user may change a file destination or a vehicle setting which affects the transfer of data files. For example, an AUV may produce data which is routinely transferred to a cloud data storage location. In certain embodiments, the end-user associated with the AUV or its data seeking to change the destination of the data may designate the new destination to the cloud service which updates its transfer log or database accordingly. After the update, when the relay resource requests transfer instructions for the data via the relay API, the cloud service determines and provides transfer instructions indicating the updated destination for the data.

In certain embodiments, the cloud-based vehicle operations service may receive from the client application an indication to upgrade the operational capabilities of a UAV. For example, an end-user may configure or purchase vehicle settings (e.g., “premium features”) which enable new or upgraded vehicle functionalities, such as telemetry data collection or automated file uploading from the vehicle via the vehicle's Wi-Fi connectivity.

In certain embodiments, when an end-user configures a change to the AUV settings, the vehicle operations service assembles a configuration package or bundle of vehicle settings and transmits the configuration package to one or more AUVs. In certain embodiments, the cloud service may also store or update the pertinent transfer information in its file transfer log or database. For example, if the end-user enables an upgrade for telemetry data collection, the cloud service will update its database to indicate the destination information for vehicles upgraded to collect telemetry data and will send to the upgraded vehicles a configuration package of vehicle settings to enable telemetry data collection and storage.

In certain embodiments, the end-user enables automated file uploading from the one or more AUVs, the cloud service will store or update the pertinent transfer information in its database and will send a configuration package implementing the upgraded functionality to the vehicle. Subsequent to the upgrade, when the vehicle seeks to transfer the telemetry data file, it will request transfer instructions from the relay resource according to the data file's unique identifier. The relay resource will obtain the transfer instructions from the cloud service and relay the instructions to the vehicle.

In certain embodiments, a swarm of cloud-based AUV operations service which communicates with application portal and one or more AUVs. In certain embodiments, the AUV and AUV operations service communicate with relay resource, which in turn communicates with a destination. In certain embodiments, an application portal hosts a web application executing on computing device.

In certain embodiments, an AUV operations service is representative of one or more services (including microservices) capable of interfacing with computing devices and network-connected AUVs for operations management and for providing the data transfer processes, services, and methods described herein. In certain embodiments, the vehicle operations service comprises services capable of interfacing with application portals or with one or more AUVs, or with other data services in communication with the AUVs, such as relay resource, over one or more wired or wireless communication networks. In an implementation, AUV operations service comprises various subprocesses or subservices such as a vehicle data service or an AUV tasking service. In certain embodiments, the AUV operations service may be implemented in the context of one or more data centers and one or more computing devices of which computing device.

In certain embodiments, the application portal is representative of one or more services (including microservices) capable of interfacing with computing devices for AUV operations management and for providing the data transfer processes, services, and methods described herein. In certain embodiments, the application portal comprises services capable of interfacing with computing device, with AUV operations service, or with other data services such as destination over one or more wired or wireless communication networks. In certain embodiments, the application portal comprises services for hosting client applications for managing AUV operations. In certain embodiments, the application portal may be implemented in the context of one or more data centers and one or more computing devices. In certain embodiments, the application portal may be co-located with AUV operations service.

In certain embodiments, a computing device is representative of a computing device operated by an AUV operator such as a vehicle dispatcher, an AUV pilot or teleoperator, or other organizational personnel or stakeholder associated with the AUV in an implementation. In certain embodiments, the computing device is representative of a computing device, such as a laptop or desktop computer, or mobile computing device, such as a tablet computer or cellular phone, capable of communicating with application portal over one or more wired or wireless communication networks. In certain embodiments, the computing device executes a user application for AUV operations such as data transfer operations. In certain embodiments, the user application communicates with application portal including sending user input from the user interface of a client application to application portal of AUV operations service.

In certain embodiments, the AUV is representative of an autonomous underwater vehicle capable of communicating with vehicle operations service over one or more wired or wireless communication networks. In certain embodiments, the AUV may connect with a wireless access point (e.g., a Wi-Fi router) for Internet access to cloud services such as AUV operations service. In certain embodiments, the AUV is representative of a vehicle capable of performing various tasks, including capturing sensor or telemetry data, which may be configured by an end-user in the user interface of a client application on computing device in communication with application portal of the AUV operations service.

In certain embodiments, a relay resource is representative of one or more services (including microservices) capable of interfacing with computing devices and AUVs over one or more wired or wireless communication networks for providing the data transfer processes, services, and methods described herein. In certain embodiments, the relay resource may be implemented in program instructions operating on one or more computing devices.

In certain embodiments, the AUV includes one or more services (including microservices) capable of interfacing with computing devices and AUVs over one or more wired or wireless communication networks for providing the data transfer processes, services, and methods described herein. In certain embodiments, the AUV can include cloud data storage, video relay services, or other services for receiving, storing, sending, and otherwise managing sensor data (which may include imaging data or video data), telemetry data, or other types of data collected and stored by the AUV. In certain embodiments, the AUV may be implemented in program instructions operating on one or more computing devices.

In certain embodiments, the computing device displays a user interface for configuring vehicle operations for vehicle, such as planning and scheduling vehicle tasks, obtaining vehicle or fleet status information, or accessing data collected by a vehicle. In certain embodiments, an end-user may also specify file destinations for data collected by vehicle in the user interface of the client application. In certain embodiments, the interaction between the user application executing on computing device and application portal may be handled by an API.

In certain embodiments, the vehicle operations service receives, via application portal, a task or configuration package configured by an end-user in a client application executing in computing device. In certain embodiments, the vehicle operations service assigns the task or sends the configuration package to vehicle. In certain embodiments, the vehicle operations service is a cloud-based service which communicates with vehicle \via a cloud API. In certain embodiments, the AUV may establish an Internet connection by connecting to a wireless access point, such as a Wi-Fi router.

In certain embodiments, the vehicle operations service provides the AUV with information tasking the AUV with transferring data collected by one or more elements (e.g., sensors) onboard the AUV. In certain embodiments, the AUV performs a task during which data is collected. For example, the AUV may collect sensor data (for example, images) including coordinates at various times during the mission as captured by an onboard camera. In certain embodiments, the filenames of the image data files are unique identifiers constructed according to a naming convention based on various parameters relating to the vehicle and the task. At the time the files are to be transferred, the AUV operations service can determine transfer instructions for the file by parsing the unique identifiers according to the naming convention.

In certain embodiments, sending a configuration package to the AUV, the AUV operations service provides the AUV with one or more settings which enable a vehicle functionality or enhance a functionality already in use. For example, an end-user may select an operational upgrade comprising telemetry data collection. Vehicle operations service may transmit a configuration package to the AUV, which changes an onboard setting to enable telemetry data collection and transfer of the data file containing the collected data. In certain embodiments, the filename of the telemetry data file is a unique identifier constructed according to a naming convention based on various parameters relating to the vehicle and the task. At the time the file is to be transferred, vehicle operations service can determine transfer instructions for the file by parsing the unique identifier according to the naming convention.

In certain embodiments, upon completing a mission for which vehicle is tasked with transferring data collected during the mission, the AUV transmits to relay resource the unique filename of the data file. Relay resource queries the AUV operations service, including the unique filename of the data file, to obtain transfer instructions.

In certain embodiments, when the AUV operations service receives the unique filename of the data file, the AUV operations service determines that the destination for the data file is destination. In certain embodiments, the vehicle operations service obtains transfer instructions for the data file from a database which correlates transfer information and instructions to one or more parameters contained within the unique identifier. In certain embodiments, the AUV operations service sends the transfer instructions to relay resource identifying destination as the destination and including other information for communicating with destination, such as the destination IP address and API key for destination.

In certain embodiments, upon receiving the transfer instructions from vehicle operations service, relay resource obtains the data file from vehicle and uploads the file to destination according to the transfer instructions. With the data file uploaded to destination, the end-user can access the data file from destination directly or via application portal for download, viewing, or other purposes.

In certain embodiments, after the file has been transmitted to the destination, the relay resource may receive confirmation of the successful upload from destination. In certain embodiments, upon receiving confirmation of the upload, relay resource may direct vehicle to delete the uploaded file from its onboard data storage. In certain embodiments, the AUV operations service may receive confirmation of the file upload from the destination which it then transmits to relay resource. In certain embodiments, the AUV operations service may also record in the transfer database the status of the data file such that if vehicle operations service receives a duplicate request to transfer the data file, the reply to relay resource will indicate that the data file does not need to be uploaded.

In certain embodiments, a vehicle operations service to manage data transfer for one or more AUVs may be implemented in program instructions in the context of any of the software applications, services, micro-services, modules, components, or other such elements of a suitable operations service. In certain embodiments, the AUV operations service may be implemented in the context of a data center or other such environment, and on one or more computing devices. In certain embodiments, the program instructions direct the one or more computing devices that provide a vehicle operations service to operate as follows.

In certain embodiments, the AUV operations service receives information which tasks AUV with transferring data collected by one or more elements, such as onboard sensors or receivers. In certain embodiments, the AUV operations service configures or receives transfer information, including file destinations, and stores the transfer information in a transfer log or database according to various parameters relating to the vehicle and/or the task. For example, a user, such as an AUV dispatcher, may configure a task or mission for a vehicle in a client application of the vehicle operations service which includes specifying a destination for the files of data collected by the vehicle while the vehicle performs the task. In certain embodiments, the destination may be a cloud data storage or other content handler, such as a video relay service. Alternatively, the AUV operations service may assign destinations for data files according to the type of data collected or an attribute of the task, such as the organization associated with the assigned vehicle or the purpose of the task. The vehicle operations service transmits task instructions to the vehicle selected to perform the task.

In certain embodiments, upon completing a task or mission and having collected data pertaining to the task or mission, the AUVs send to a relay resource or service the unique identifier of the data file of the collected data to be downloaded from the one or more AUVs. In certain embodiments, the relay service sends to the vehicle operations service a request for transfer instructions which includes the unique identifier of the to-be-transferred data file.

In certain embodiments, the AUV operations service determines the instructions for transferring the data file based on the file's unique identifier. To determine the instructions, the AUV operations service parses the unique identifier for various parameters according to a naming convention used to construct the identifier. In certain embodiments, the cloud service uses one or more of the parameters extracted from the unique identifier to determine instructions for transferring the file. In certain embodiments, the cloud service determines the instructions by consulting a transfer log or database which correlates destination information and/or instructions to one or more of the extracted parameters. In certain embodiments, the transfer instructions may include a web address (e.g., a URL) of the destination and API authentication key for communicating with the destination. In certain embodiments, the instructions may also include an encryption key for encrypting the data for transfer.

In certain embodiments, the vehicle operations service transmits to the relay service transfer instructions determined according to the unique identifier of the data file. In certain embodiments, the transfer instructions may include the information necessary for the relay service to communicate with the destination, such as a web address, authentication keys or credentials, encryption keys, and so on. In certain embodiments, the relay service, upon receiving the transfer instructions, implements the transfer by obtaining the data file from the vehicle and transmitting it to the destination. In certain embodiments, the vehicle encrypts the data file prior to transfer. In certain embodiments, the relay service may send the transfer instructions to the vehicle to transmit the data file to the destination directly (rather than through the relay resource) via the AUVs wireless network connectivity or Internet connection.

In certain embodiments, when the file transfer is complete, the destination sends confirmation of the upload to the relay resource, which in turn sends the confirmation to the vehicle. In other implementations, when file transfer to the destination is complete, the vehicle operations service queries and receives the confirmation of the file upload from the destination which it then communicates to the relay service. Upon receiving confirmation of the upload from the relay resource, the vehicle deletes the data file from onboard storage.

In certain embodiments, a relay resource for transferring data files from one or more AUVs to a destination in an implementation may be implemented in program instructions in the context of any of the software applications, services, micro-services, modules, components, or other such elements of a suitable operations service. In certain embodiments, the relay resource may be implemented in the context of a data center or other such environment, and on one or more computing devices. In certain embodiments, the program instructions direct the one or more computing devices that provide a data transfer service to operate.

In certain embodiments, a relay resource operating on computing device in wireless communication with a vehicle receives a request from the vehicle to transfer a data file to some destination. In certain embodiments, the request includes a unique identifier of the data file. In certain embodiments, the relay resource sends the unique identifier to a cloud service, such as a vehicle operations service, in a request for instructions for transferring the data file. In certain embodiments, the cloud service determines instructions for transferring the data file according to the unique identifier and transmits the instructions to the relay resource. In certain embodiments, the instructions include a destination for the data file and may also include other information for making the transfer, such as a web address, an authentication key, and an encryption key. In certain embodiments, the relay resource receives from the cloud service the instructions for transferring the data file to a specified destination. In certain embodiments, the relay resource receives the data file from the AUV and sends the data file to the specified destination according to the transfer instructions. In certain embodiments, the relay resource may receive and store the data file before uploading to the destination. For example, if the computing device executing the relay resource is in wireless communication with the destination, the relay resource may store the data file until the computing device detects sufficient signal strength to complete the transfer.

In certain embodiments, upon complete transfer of the data file, the relay resource may receive confirmation of the upload from the specified destination. In certain embodiments, the relay resource then sends confirmation of the transfer to the AUV which prompts the vehicle to delete the data file from its onboard data storage.

In certain embodiments, the one or more AUVs are tasked by a vehicle operations service with performing a task which includes transferring data produced by one or more elements onboard the vehicle. In certain embodiments, the vehicle stores a data file including data gathered in the process performing the task. In certain embodiments, the data file onboard the vehicle may include imaging data from onboard sensors such as cameras or other detectors, video data such as livestream or recorded video, and telemetry data which describes the position of the vehicle at various times during a task or mission. In certain embodiments, the data file can also include a custom or proprietary data format. In certain embodiments, the AUVs encrypt the data file according to an encryption key provided in the task assignment or that is native to the AUV.

In certain embodiments, the vehicle stores the collected data in a data file which has a unique identifier constructed by concatenating various parameters relating to the vehicle and/or to the task. For example, the unique identifier may include parameters such as a task or movement identifier, an AUV identifier, an organizational identifier for an organization associated with the vehicle or the data, an indication of the data type, an indication of the element sourcing or producing the data, and so on. In certain embodiments, the AUV, in wireless communication with a relay resource operating on a computing device such as a controller or ground station, sends a request to the relay resource to transfer the data file to some destination. In certain embodiments, the request includes the unique identifier of the data file. Communication and other data transfers between the AUVs and the relay resource may be facilitated by an API for requesting file transfer and/or for the file transfer. In certain embodiments, the relay resource then relays the transfer request to a cloud service which determines transfer instructions based on the file's unique identifier. In certain embodiments, the cloud service sends the transfer instructions to the relay resource. In certain embodiments, the vehicle then transmits the data file to the relay resource which executes the file transfer according to the transfer instructions.

In certain embodiments, the relay resource may operate onboard the vehicle, executed by the AUV's control system may communicate with the cloud service to request and receive transfer instructions via the AUVs network connectivity.

In certain embodiments, a tasking service of the AUVs operations service assigns a task to vehicle, which will entail the collection of task data by the equipment onboard the AUV. For example, the task data may be imaging data, such as photographs, video recordings, or livestream video, environmental data measured by any of various onboard sensors, telemetry data which can include location coordinates, vehicle performance data such as vehicle operating data, or other custom-configured or proprietary data or data formats. The task data may also indicate a destination for data files, such as a cloud-based data storage or other content handler such as a video relay service for livestream video, a content service operated by a vehicle operations service, or some other file repository.

In certain embodiments, the AUVs construct a unique identifier for each data file of data collected during the task. The unique identifier may be constructed according to a naming convention comprising various parameters relating to the task, the data, or the vehicle. Vehicle operations service may generate a unique identifier by concatenating one or more of various parameters of the task, such as a task identifier, a vehicle model designation, vehicle identifier, a pilot identifier, and/or a data type or kind. In certain embodiments, to ensure that the unique identifier is unique among the systems and services with which the AUV is in communication, the naming convention may also specify appending a randomized set of characters to the identifier. The AUV operations service stores transfer instructions including destination information in a transfer log or database according to one or more of the parameters used to create the unique identifier. The destination information stored in the data may include a web address for the destination, authentication keys or access tokens, file compression requirements, encryption keys, and so on.

In certain embodiments, the vehicle operations service may create a unique identifier which is provided to an AUV when the task is assigned and which vehicle operations service stores, along with the corresponding transfer instructions, in the transfer log or database.

In certain embodiments, when vehicle completes the assigned task, or as data files are created, the AUV will surface and send to relay resource a list of unique identifiers of data files available for transfer, such as for uploading to a cloud data storage. Alternatively, or additionally, vehicles may send the list when a mission is initiated, when a mission is terminated, or when the AUV is within range of a wireless access point with sufficient signal strength.

In certain embodiments, the relay resource receives a list of one or more unique identifiers from an AUV, which it transmits to vehicle operations service in a request for transfer instructions for the data files. In certain embodiments, the relay resource may be executed on a computing device in wireless communication with the vehicle, such as controller. In certain embodiments, the relay resource may be executed onboard vehicle. Upon receiving the list of unique identifiers from relay resource, vehicle operations service determines transfer instructions for the data files by accessing the transfer log or database of destinations and transfer instructions correlated to parameters extracted from the unique file identifiers.

In certain embodiments, the vehicle operations service transmits the transfer instructions to relay resource. When relay resource receives the transfer instructions from vehicle operations service, relay resource downloads the data files from vehicle. In certain embodiments, the relay resource then transfers or uploads the data files to the respective destinations of the data files according to the transfer instructions.

In certain embodiments, when transfer of a data file is complete, relay resource obtains confirmation of the successful file upload from destination. With upload confirmed, relay resource transmits an indication to the AUV to delete the data file from its onboard storage. In certain embodiments, the indication to delete may be transmitting a transfer confirmation to the AUV which prompts vehicle to perform the deletion, or the indication may be a command to delete the file. In certain embodiments, the vehicle operations service may receive confirmation of the successful upload from destination which may be further communicated to the client application where the task was created. In certain embodiments, the vehicle operations service may also communicate the confirmation to relay resource.

In certain embodiments, one or more AUVs collect data from instruments and sensors onboard vehicle and stores the collected data in a data file. In certain embodiments, the vehicle surfaces and then sends a request, which includes the file's unique identifier to relay resource to transfer the file. In this example, the file's unique identifier is constructed according to a naming convention which combines a vehicle identifier with an indication of the vehicle element sourcing the data.

In certain embodiments, upon receiving the transfer request from vehicle, relay resource, executing on a controller, ground station, docking station, base station, or mobile computing device in wireless communication with the AUV, relays the transfer request including the unique file identifier to cloud service. In certain embodiments, the cloud service is representative of a cloud-based vehicle operations or file transfer service which manages or orchestrates file transfers for UAVs such as vehicles. In certain embodiments, the cloud service maintains transfer database, which stores transfer instructions for data files to be downloaded from UAVs. In certain embodiments, the transfer database stores data records comprising various parameters relating to the vehicles, the task, or mission of the vehicle, the data collected, and/or other parameters, along with transfer instructions. In certain embodiments, the transfer instructions can include destination information comprising a web address or URL of the destination, an authentication for file transfers using an API of the destination, encryption information, and/or file format or compression information.

In certain embodiments, the cloud service receives the transfer request from relay resource. Cloud service determines transfer instructions for from database. In certain embodiments, the cloud service parses the file's unique identifier for parameters indicating an AUV identifier and an element of the vehicle producing the data. In certain embodiments, the cloud service determines the transfer instructions for the file, including destination information, based at least on the parameters extracted from the unique file identifier. From database, cloud service determines that the destination of the file is destination database. In certain embodiments, the loud service sends the transfer instructions including information for transferring the file to relay resource.

In certain embodiments, upon receiving the transfer instructions for file relay resource downloads the file from the AUV and transfers the file to destination according to the transfer instructions. In certain embodiments, the relay resource transfers the file using an API associated with destination and for which an access or authentication token may be provided in the transfer instructions. In certain embodiments, when file transfer is complete, destination may transmit via its API a confirmation of the upload to relay resource. In certain embodiments, the relay resource may send the confirmation to vehicle, prompting vehicle to delete the file from its onboard data storage. In certain embodiments, the relay resource may notify cloud service of the successful upload so that cloud service can update database with the information.

In certain embodiments, for managing file transfer from an AUV, an end-user at computing device, such as personnel affiliated with an organization operating vehicle, initiates a configuration change for vehicle via the user interface of a client application executing on computing device. In certain embodiments, the configuration change enables telemetry data collection. In certain embodiments, the client application sends an indication of the configuration change to application portal of cloud service. In certain embodiments, the application portal transmits the configuration change to cloud service. In certain embodiments, the cloud service updates transfer database for operator to indicate that data files for telemetry data. In certain embodiments, the cloud service also sends a configuration package to vehicle comprising one or more operational settings for vehicle which enable telemetry data collection. In certain embodiments, the telemetry data application may execute onboard vehicles to capture telemetry data from a vehicle element such as a GPS receiver.

In certain embodiments, when the file is ready for transfer, such as at the conclusion of the task or when the AUV surfaces, the AUV sends a request to relay resource to transfer the file. In certain embodiments, the cloud service parses the filename according to the naming convention to extract the vehicle identifier and the data type. Consulting the transfer database for the client associated with the AUV, cloud service determines the destination for file. Cloud service sends the transfer instructions including the destination information to relay resource. Relay resource downloads the data file from vehicle and sends it to destination via its API.

In certain embodiments, the AUV operator develops a new AUV capability or functionality and updates transfer database with respect to how data files associated with the new functionality are to be stored, including information such as filename parameter, a data type and destination of the files. In certain embodiments, the AUV operator deploys the new functionality to the AUV, which can include updating the operating system of vehicle and/or reallocating onboard data storage of vehicle.

In certain embodiments, after the deployment of the functionality, an operator tasks a vehicle with collecting and transferring data collected by the new functionality. Application portal transmits the operator's task directive to cloud service via an operations API for assignment to the AUV. In certain embodiments, the AUV collects data associated with the new functionality and stores the data in data file. When the task is complete or the data file is otherwise ready for transfer, the AUV sends a file transfer request to relay resource, wherein the request includes the unique file identifier. The relay resource transmits the request to cloud service via a relay API which is different from the operations API of cloud service. In certain embodiments, the cloud service parses the identifier to extract parameters for determining transfer instructions. With the updated information in database, cloud service determines the file destination of the file.

In certain embodiments, upon receiving the identifiers from relay resource, cloud service consults a transfer database for instructions for transferring data files from UAVs managed by vehicle operations service. Cloud service may execute one or more services relating to vehicle operations such as data file transfer management. Cloud service receives the unique file identifiers and determines the transfer instructions by consulting a transfer database maintained by cloud service. In certain embodiments, the database may comprise information which correlates transfer instructions for data files to various parameters relating to the vehicle which produced the data, the task during which the data was produced, the type of data collected, the user initiating the task involving the data production, and so on. In certain embodiments, the database may also store data file status information, such as an upload status for a file. In certain embodiments, the cloud service determines that data has already been uploaded and therefore does not require transfer.

In certain embodiments, when the AUV receives confirmation that the files have been uploaded to their respective destinations, it deletes the files from its onboard data storage. In implementation, cloud service may solicit and receive confirmation from destination of the upload to update the file status in the transfer database.

In certain embodiments, a user, such as an AUV operator, AUV dispatcher, or other personnel associated with AUV, enables a vehicle configuration for vehicle via the user interface of a application for managing vehicle operations executing on computing device. In certain embodiments, the vehicle configuration enabled by the user includes tasking vehicles with transferring data produced by elements operating onboard from vehicle, such as sensors (e.g., cameras) or receivers. For example, the operator may enable an operations upgrade, for example, which enables a premium functionality such as telemetry data collection, higher resolution photography, or Lidar. In certain embodiments, the user input comprising vehicle settings which enable the vehicle configuration are sent to cloud service via application portal.

In certain embodiments, the AUVs begins a mission, and at launch, the AUVs communicate with cloud service to synchronize configuration packages relating to AUV operations. Cloud service determines that the configuration package for the operations upgrade must be installed on the AUV and transfers the configuration package to the AUV via an API. In certain embodiments, once launched, one or more elements onboard the AUV produce data in accordance with the newly installed operations upgrade. In certain embodiments, the motion control system onboard the AUV stores the data produced in a data file with a unique filename. In certain embodiments, the unique filename is constructed by the motion control system or by an onboard data management system by concatenating parameters relating to the mission during which the data was produced, the AUV, the sensor or receiver producing the data, the mission purpose, or the data type. In certain embodiments, the AUV transmits the unique filename to relay resource in a request to transfer the file.

In certain embodiments, the relay resource sends the unique filename to cloud service to solicit transfer instructions for the data file. Cloud service parses the filename to determine the transfer instructions. Using parameters extracted from the unique filename, cloud service determines that the destination of the data file is destination. Cloud service sends instructions for transferring the data file including information for uploading the data file to destination, such as login credentials, encryption keys, etc. Upon receiving the transfer instructions from cloud service, relay resource downloads the data file from the AUV, then uploads it to destination according to the transfer instructions. In certain embodiments, the relay resource may send the transfer instructions to the AUV to affect the transfer. When the AUV receives confirmation of the file upload to destination, for example, from relay resource or from destination after a direct upload, the AUV deletes the file from its onboard file storage.

In certain embodiments, software systems architecture includes cloud service in communication with application portal, the AUV, and relay resource. In certain embodiments, the relay resource is in communication with destination. Application portal may also communicate with destinations. In certain embodiments, the cloud service communicates with the AUV via cloud API. In certain embodiments, using cloud API (i.e., application programming interface), cloud service may transmit task information or configuration packages to the AUV. Cloud service may also receive information relating to the AUV status or operations.

In certain embodiments, the cloud service also communicates with application portal via cloud API, which facilitates access by web applications hosted by application portal to various vehicle services supported by cloud service. For example, an end-user may schedule a mission which tasks the AUV with transferring data produced onboard the AUV. Cloud service then assigns the mission to vehicle via cloud API.

In certain embodiments, in configuring a task or mission for the AUV via application portal, an end-user may specify a location for receiving and storing the data collected by the AUV in performing a task. In certain embodiments, the cloud service may determine a destination for task data based on the type of data, the organization with which the vehicle or end-user is associated, or some other attribute of the task or mission. In certain embodiments, the end-user may be presented in the user interface with the ability to access, download, or view the data via cloud API, while backend data storage and transfer is managed by cloud service. Alternatively, the end-user may access task data stored at destination via destination API.

In certain embodiments, the relay resource communicates with a cloud service via relay API to transmit file transfer requests to and receive transfer instructions from cloud service. In various implementations, relay resources also receive file transfer requests and data files slated for transfer from vehicle via relay API. In certain embodiments, the relay API is different from cloud API.

In certain embodiments, when the relay resource receives transfer instructions from cloud service via relay API, the relay resource may upload the data file from vehicle to destination via destination API supported by or associated with destination. In certain embodiments, the end-user may also access, download, and/or view data, including on-demand or livestream data, via the user interface of the web application, wherein application portal communicates with destination to download and display the data.

In certain embodiments, the relay API facilitates file transfer from one or more AUVs by abstracting individual file transfer functions (performed, for example, by multiple APIs) away from the AUV, relay resource, and application portal so that data transfer is orchestrated by cloud service as a single point of contact for data transfer operations. The one or more AUVs are agnostic to file handling beyond each interaction with relay resource.

Similarly, the relay resource requests and receives transfer instructions on demand from cloud service at the time of transfer. In certain embodiments, where the relay resource executes on a mobile device, relay resource may store the data file received from vehicle until the wireless connection signal strength detected by the mobile device is of sufficient strength for the file to be transferred to destination.

In certain embodiments, the cloud service tracks file transfer information according to a data file's unique identifier in, for example, a transfer log or database. When a data file is to be downloaded from the AUVs, the AUVs transmit the unique identifier to relay resource via relay API. The relay resource then requests and receives transfer instructions for the unique identifier from cloud service via relay API. When relay resource receives the transfer instructions, it downloads the data file from the AUV via relay API, then transfers the data file to its destination, such as destination via destination API.

In certain embodiments, the destination may be a third-party cloud service provider which receives data from relay resource and other endpoints via destination API. In certain embodiments, the relay resource sends a data file including data produced onboard by the AUV to destination via destination API. In certain embodiments, the relay resource may use an API key or access token provided in the transfer instructions received from cloud service to enable the file transfer. In certain embodiments, the destination may send confirmation of a successful file upload to relay resource via and/or to cloud service 1110 via destination API. With the upload confirmed, in certain embodiments, the AUV may be notified by relay resource or cloud service that the data file stored onboard can now be safely deleted.

In certain embodiments, the AUV may upload the data file directly to destination via destination API, having received transfer instructions relayed by relay resource from cloud service. In certain embodiments, the AUV may receive confirmation of the file transfer directly from destination via destination API, upon receipt of which the AUV deletes the file from its onboard data storage.

In certain embodiments, the relay resource may comprise a service executing onboard an Internet-connected AUV, communicating with cloud-based services such as cloud service and destination for file transfer operations.

In certain embodiments, the one or more AUVs include systems architecture that includes navigation/motion control system, electromechanical system, and operational inputs. In certain embodiments, the navigation system comprises one or more receivers (RX) for receiving operational inputs, such as wireless network communication or navigation commands from a controller. In certain embodiments, the navigation control system further comprises a navigation controller, inertial measurement unit (IMU), camera, LiDAR, GPS sensor, transmitter (TX), and data storage. In certain embodiments, the data storage includes persistent or nonvolatile memory or a removable memory card (e.g., an SD card) for recording navigation and sensor data gathered from onboard devices, including photos or video captured by onboard cameras, or for storing programmed navigation programs for use by the AUV. In certain embodiments, the navigation control system may also comprise one or more other sensors such as barometers, depth sensors, additional cameras, heat-detecting sensors, electromagnetic sensors (e.g., infrared or ultraviolet), sonar sensors, magnetometers, and so on. In certain embodiments, the onboard camera\comprises a device for capturing imaging data, such as video or still photography, across visible and other wavelengths of the electromagnetic spectrum, such as ultraviolet or infrared wavelengths.

In certain embodiments, the electromechanical system provides the propulsion for the AUV, typically comprising an electronic speed controller which throttles one or more rotors according to navigation instructions received from navigation control system.

In certain embodiments, an AUV computing device may be implemented as a single apparatus, system, or device or may be implemented in a distributed manner as multiple apparatuses, systems, or devices. In certain embodiments, the computing device includes, but is not limited to, processing system, storage system, software, communication interface system, and user interface system (optional). In certain embodiments, the processing system is operatively coupled with storage system, communication interface system, and user interface system.

In certain embodiments, the processing system loads and executes software from storage system. Software includes and implements AUV data transfer process, which is representative of the AUV data transfer processes. When executed by the processing system, software directs the processing system to operate as described herein for at least the various processes, operational scenarios, and sequences discussed in the foregoing implementations. In certain embodiments, the computing device may optionally include additional devices, features, or functionality.

In certain embodiments, the processing system may comprise a micro-processor and other circuitry that retrieves and executes software from storage system. In certain embodiments, the processing system may be implemented within a single processing device but may also be distributed across multiple processing devices or sub-systems that cooperate in executing program instructions. In certain embodiments, examples of processing system include general purpose central processing units, graphical processing units, application specific processors, and logic devices, as well as any other type of processing device, combinations, or variations thereof.

In certain embodiments, the storage system may comprise any computer readable storage media readable by processing system and capable of storing software. In certain embodiments, the storage system may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage systems may also include computer readable communication media over which at least some of software may be communicated internally or externally. In certain embodiments, the storage system may be implemented as a single storage device but may also be implemented across multiple storage devices or sub-systems co-located or distributed relative to each other. In certain embodiments, the storage system may comprise additional elements, such as a controller, capable of communicating with processing systems or possibly other systems.

In certain embodiments, the software (including AUV data transfer process) may be implemented in program instructions and among other functions may, when executed by processing system, direct processing system to operate as described with respect to the various operational scenarios, sequences, and processes illustrated herein. For example, software may include program instructions for implementing the AUV data transfer processes.

In certain embodiments, the program instructions may include various components or modules that cooperate or otherwise interact to carry out the various processes and operational scenarios described herein. In certain embodiments, the various components or modules may be embodied in compiled or interpreted instructions, or in some other variation or combination of instructions. In certain embodiments, the various components or modules may be executed in a synchronous or asynchronous manner, serially or in parallel, in a single threaded environment or multi-threaded, or in accordance with any other suitable execution paradigm, variation, or combination thereof. In certain embodiments, the software may include additional processes, programs, or components, such as operating system software, virtualization software, or other application software. In certain embodiments, the software may also comprise firmware or some other form of machine-readable processing instructions executable by processing system.

In general, software may, when loaded into processing system and executed, transform a suitable apparatus, system, or device (of which computing device is representative) overall from a general-purpose computing system into a special-purpose computing system customized to support sensor device deployments and swaps. Indeed, encoding software on the storage system may transform the physical structure of the storage system. The specific transformation of the physical structure may depend on various factors in different implementations of this description. Examples of such factors may include, but are not limited to, the technology used to implement the storage media of the storage system and whether the computer-storage media are characterized as primary or secondary, etc.

For example, if the computer readable storage media are implemented as semiconductor-based memory, software may transform the physical state of the semiconductor memory when the program instructions are encoded therein, such as by transforming the state of transistors, capacitors, or other discrete circuit elements constituting the semiconductor memory. In certain embodiments, a similar transformation may occur with respect to magnetic or optical media. Other transformations of physical media are possible without departing from the scope of the present description, with the foregoing examples provided only to facilitate the present discussion.

In certain embodiments, the communication interface system may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

In certain embodiments, communication between computing device and other computing systems may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

### AUV Solar Rechargeable Battery

As used herein, “solar panels” refer to an array of one or more photovoltaic cells configured to collect solar energy. The solar panels may employ one or more of the following solar cell types: monocrystalline silicon solar cells, polycrystalline silicon solar cells, string ribbon solar cells, thin-film solar cells (TFSC), cadmium telluride (CdTe) solar cells, copper indium gallium selenide (CIS/CIGS) solar cells, and the like. To reduce overall weight and to improve reliability and durability, it is advantageous to employ light weight and/or flexible solar panels (e.g., thin-film solar panels).

In certain embodiments, the solar-powered AUV may further comprise one or more tail sections, each having a first tail panel and a second tail panel. The one or more tail section may be coupled to the fixed wing panel via a longitudinal boom. The longitudinal boom may define a longitudinal pivot axis perpendicular to the lateral axis of the fixed wing panel. The first tail panel (e.g., first tail airfoil) and the second tail panel (e.g., a second tail airfoil) may be traditional wings or canted wings, which may be canted upwardly or downwardly. As illustrated, the first tail panel may be positioned closer to the fixed wing panel than the second tail panel, wherein at least one of the first tail panels or the second tail panels comprises an array of solar panels located on a surface of the first tail panel or the second tail panel that allow the AUV battery or batteries to recharge while the AUV is on the surface of a body of water

In certain embodiments, the first tail panel and/or the second tail panel may be configured to rotate relative to the fixed wing panel about a central transverse portion of the first or second tail panel via a pivot assembly. In certain embodiments, the first tail panel and the second tail panel may be independently controlled or, in the alternative, the tail section may rotate as a single unit through a pivot assembly. The plurality of secondary wing panels, the first tail panel, and the second tail panel may rotate as a single unit.

In certain embodiments, the solar-powered AUVs may further comprise one or more energy storage devices operatively coupled to the solar panels. In certain embodiments, the one or more energy storage devices store collected solar energy for later use by the solar-powered AUV (e.g., when sunlight is unavailable, typically at nighttime). As used herein “energy storage device” refers to a battery or similar instrumentality known to those of skill in the art capable of storing and transmitting energy collected from the solar panels, including but not limited to, a rechargeable battery (e.g., one or more lithium ion batteries), a regenerative fuel cell, or combinations thereof. In certain embodiments, an energy storage system may employ a plurality of energy storage devices. In certain embodiments, the solar-powered AUV may be supplied with redundant components and/or conductors (power and data signals). In certain embodiments, the solar-powered AUV may further comprise embedded conductors, which may convey power and/or data signals throughout the solar-powered aircraft.

In certain embodiments, the solar-powered AUV may further comprise a control system operable to control the various functions of the solar-powered AUV. In certain embodiments, the control system, or subsystem, may be further configured to rotate, about a longitudinal pivot axis, the secondary wing panels, first tail panel, second tail panel, or combinations thereof. In certain embodiments, the control system operates to rotate solar panel comprising surfaces in a direction toward the sun (e.g., the planar surface of the solar panel is perpendicular to the sun's rays). In certain embodiments, the secondary wing panel can be rotated from 0 degrees to 180 degrees about a longitudinal pivot axis to ensure that the solar panels on a surface of the secondary wing panel or other component are oriented towards the sun to maximize power generation. For example, when the sun is near the horizon, the secondary wing panels would have their spanwise axis vertical (e.g., 90 degrees relative to the fixed wing panel) and the solar panels would be aimed approximately horizontal—oriented directly towards the sun—thereby collecting a maximum energy. In certain embodiments, when the sun is overhead (relative to the aircraft) the secondary wing panels would have their spanwise axis horizontal (e.g., parallel to the transverse axis of the fixed wing panel) such that the solar panels are be aimed upward and oriented towards the sun. In certain embodiments, when the sun is located at intermediate elevations, the secondary wing panels could either be oriented vertically or horizontally, or positioned at an intermediate angle that maximizes solar power generation. In certain embodiments, using the control system, the left wing tip panel may be oriented such that the solar panel is oriented towards the right and up (i.e., outboard wing tip up, inboard wing tip down), while the right wing tip panel is also aimed to the right and up (i.e., outboard wing tip down, inboard wing tip up). This “antisymmetric” arrangement, with a wide range of possible panel tilt angles, while more difficult to control in terms of aerodynamics, results in maximum possible collection effectiveness, and may be worth the cost and effort depending upon the need.

In certain embodiments, while the intermediate angle of the secondary wing panels is approximately 45 degrees relative to the fixed wing panel, other angles are contemplated. Indeed, an advantage of the secondary wing panels is their ability to rotate (pivot) at least 180 degrees, which allows the solar panels to be oriented to either side of the solar-powered aircraft. Thus, based on the heading of the solar-powered aircraft, the secondary wing panels can be rotated in a manner that maximizes the exposure of the solar panels to the sun. In certain embodiments, the secondary wing panels may be dynamically rotated between 0 and 180 degrees (including intermediate angles therebetween) based on the elevation of the sun, which may be tracked by a control system using one or more sensors (e.g., a solar position sensor). In certain embodiments, one or more sensors may be aboard the solar-powered AUV and integral with the payload, which will be discussed below. Additionally, the ability of the secondary wing panels to rotate 180 degrees allows solar panels to be present on a single surface of the panels, thereby saving cost and weight, while increasing efficiencies.

In certain aspects, the secondary wing panels rotate about a longitudinal pivot axis, wherein the secondary wing panels have substantially equal areas on each side of the axis. This balance significantly reduces the aerodynamic force moment about the pivot axis (e.g., at the pivot assembly), allowing for more efficient rotation of the secondary wing panels. Accordingly, either smaller motor assemblies can be used at the pivot assembly to rotate the secondary wing panels, or the secondary wing panels can be rotated faster using the same or larger motor assemblies.

In certain embodiments, the secondary wing panels, first tail panels, and second tail panels are configured to rotate independently to maximize the efficiency of each solar panel.

In certain embodiments, the secondary wing panels, first tail panels, and second tail panels may be configured to rotate together (e.g., in unison), wherein each component is substantially oriented in the same manner about a longitudinal pivot axis of fixed wing panel. For example, an embodiment of the present disclosure wherein the secondary wing panels, first tail panels, and second tail panels are configured to rotate together, wherein each component is substantially oriented in the same manner about a longitudinal pivot axis of fixed wing panel. In such a case, the components may share a pivot assembly. Alternatively, separate pivot assemblies may be used for each component but controlled in unison.

In certain embodiments, the secondary wing panels could have traditional aerodynamic trailing edge control surfaces, which would allow production of control moments about the pivot axes and allow the panels to be moved by aerodynamic forces. For example, when the secondary wing panels are locked in place, such control surfaces could function as traditional ailerons or camber changing flaps.

In certain embodiments, the solar-powered AUV comprises one or more propeller assemblies, each having a propeller, which is driven (i.e., rotated about an axis) by an electric motor. In certain embodiments, the propeller may be driven by the motor either directly or indirectly through a transmission and associated gearing. In certain embodiments, a single electric motor may be configured to drive plural propellers through a transmission or other gearing configuration; however, a dedicated electric motor may be provided for each propeller if desired. In certain embodiments, the propeller assemblies may be attached to the fixed wing panel (e.g., at a rib), a fuselage, or longitudinal boom. The electric motors are preferably direct current (“DC”) brushless motors, but other motor types may be used to meet a particular need.

In certain embodiments, the solar-powered AUV may comprise one or more fuselages and longitudinal boom. The secondary wing panel, first tail panels, second tail panels and/or auxiliary wing panel may be configured to rotate about the longitudinal pivot axis (Axis B) defined by the fuselage or longitudinal boom, wherein solar panels are positioned on one or more wing or tail panels.

In certain embodiments, the propeller assemblies may be pivoted upwardly, such that the thrust generated by the propeller assemblies is directed downwardly. To maintain balance of the solar-powered AUV, additional propeller assemblies may be positioned aft of the fixed wing panel. For example, additional propeller assemblies may be provided at the tail section or between the tail section and the fixed wing panel.

In certain embodiments, the solar-powered AUV may further employ a method of collecting solar energy while on a surface, the method comprising providing a solar-powered AUV having one or more propeller assemblies, a fixed wing panel, and a plurality of secondary wing panels configured to rotate about a longitudinal pivot axis extending from a distal end of the fixed wing panel through a central transverse portion of the secondary wing panel, wherein the secondary wing panels comprise an array of solar panels on a surface of the secondary wing panels, collecting solar energy with the array of solar panels by rotating the secondary wing panels in a direction to the sun.

In certain embodiments, the solar-powered AUV may further employ a method of continuously operating a solar-powered AUV comprising providing a solar-powered AUV comprising one or more propeller assemblies, a fixed wing panel, and a plurality of secondary wing panels configured to rotate about a longitudinal pivot axis extending from a distal end of the fixed wing panel through a central transverse portion of the secondary wing panel, wherein the secondary wing panels comprise an array of solar panels on a surface of the secondary wing panels, collecting, using and storing solar energy with the arrays of solar panels by rotating the secondary wing panels in a direction to the sun during the day while the AUV is on the surface of a body of water, rotating the secondary wing panels in a position that is substantially co-planar to the fixed wing panel during the night, and using the stored solar energy to operate the AUV during the night.

### AUV Payloads of the Invention

The AUV of the invention may further comprise one or more payloads. As used herein, “payload” refers to one or more sensors, communications packages, weapons systems, instruments, antennas, cameras, radars, navigation systems, control systems, or other cargo. For example, navigation control systems may be communicatively coupled with an inertial navigation system (“INS”) that is communicatively coupled with an inertial measurement unit and global positioning system (“GPS”) receiver, an onboard data storage device (e.g., hard drive, flash memory, or the like), a wireless communication device, or virtually any other desired services. In certain embodiments, the GPS gives an absolute position value that can be used to reset the INS solution or can be blended with it by use of a mathematical algorithm, such as a Kalman Filter.

In certain embodiments, the one or more payloads may also house an intelligence, surveillance, and reconnaissance (“ISR”) payload, which may be used to collect data and/or monitor an area. For example, the solar-powered AUV may be equipped with one or more cameras, audio devices, and other sensors including chemical sensors. Any video, or other data, collected by the solar-powered AUV may be communicated to a control station in real time wirelessly. In certain embodiments, the solar-powered AUV may be further equipped to store said video and data to the onboard data storage device. In certain embodiments, the one or more payloads may include hardware that operates as a communication relay or router. For example, the solar-powered AUV may receive signals from a remotely situated device (e.g., a satellite, communication tower, or even another solar-powered AUV) via an on board antenna. In certain embodiments, the solar-powered AUV may then relay the information from the remotely situated device to an end user at a location proximate to the solar-powered AUV. In certain embodiments, to facilitate two-way communication, the solar-powered AUV may receive information from the operator and relay it to the remotely situated device.

In certain embodiments, an auxiliary wing panel may be oriented in the vertical position (i.e., substantially perpendicular to the fixed wing panel) allows for a payload located on a lower end of the auxiliary wing panel to have a large field of view in azimuth without blockage by other parts of the AUV. Similarly, if the auxiliary wing panel has a greater height than the secondary wing panels when in the vertical (i.e., substantially perpendicular to the fixed wing panel) a payload located at the upper end of the auxiliary wing panel provides a horizontal looking payload having a large, unobstructed field of view.

### AUV Including Operational AI

In various embodiments, systems and methods are disclosed related to systems and methods for generating trajectories of the one or more AUVs in various aquatic environments. In certain embodiments, the navigation can be controllable to allow for criteria regarding the trajectories to be defined and implemented, such as for the AUV to avoid collisions or move in groups.

In certain embodiments, the AUVs include systems that can use analytical and/or rules-based approaches for simulating trajectories, such as to apply rules for criteria such as collision avoidance, group movement, and parameters such as velocity or acceleration bounds. In certain embodiments, the AUVs can include systems that can use neural network-based models that can be trained on data of actual movement, but these systems may lack the ability to be controlled, such as to react to newly introduced or unfamiliar obstacles, or to implement criteria for the trajectories at test time (e.g., runtime, inference time, during a simulation or as part of setup of the simulation).

In certain embodiments, the AUVs include systems and methods in accordance with the present disclosure that can use machine learning-based simulation models that can generate realistic navigational trajectories, and can incorporate guidance for controlling the movement. In certain embodiments, the trajectories can be for various agents that may move in relatively smooth manners which may be represented, for example, using two-dimensional bounding boxes.

In certain embodiments, the system can use generative models or other models that can sample from a distribution of potential navigational trajectories based at least on the guidance (e.g., diffusion models), and that are trained using training data movements and trajectories. The system can train and/or update training using (for example and without limitation) classifier-free approaches to enable the AUVs to be responsive to guidance. In certain embodiments, the classifier-free training can facilitate the use of various forms of datasets and/or annotations. In the example of a diffusion model-based approach, the system can use a function (e.g., objective function) representing the navigation as part of the denoising process by which the diffusion model determines trajectories, which can allow the guidance to perturb the trajectories towards satisfying the criteria.

In certain embodiments, the system can use a semantic map to facilitate determining the trajectory. For example, a spatial grid can have cells labeled with semantic information, such as classes, categories, and/or characteristics of objects (e.g., underwater mountain ranges) present in the cells, which the model can be trained to take into account as part of determining the trajectories. In certain embodiments, the system can determine the trajectories using information regarding positions and movement of other AUVs in the environment.

In certain embodiments, the systems and methods described herein may be used for a variety of purposes, by way of example and without limitation, for synthetic data generation, AUV control, AUV locomotion, AUV driving, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, generative AI with large language models, light transport simulation (e.g., ray-tracing, path tracing, etc.), collaborative content creation for 3D assets, cloud computing and/or any other suitable applications.

Disclosed embodiments may be comprised in a variety of different systems such as systems for performing synthetic data generation operations, navigation systems (e.g., a control system for an autonomous or semi-autonomous AUV, a perception system for an autonomous or semi-autonomous AUV), systems implemented using a robot, aerial systems, systems for performing deep learning operations, systems for performing simulation operations, systems for performing digital twin operations, systems implemented using an edge device, systems incorporating one or more virtual machines (VMs), systems implemented at least partially in a data center, systems for performing conversational AI operations, systems implemented with one or more LLMs, systems for performing light transport simulation, systems for performing collaborative content creation for 3D assets, systems implemented at least partially using cloud computing resources, and/or other types of systems.

In certain embodiments, the AUV system can train, update, or configure one or more navigational models. In certain embodiments, the models can include machine learning models or other models that can generate target outputs based on various types of inputs. In certain embodiments, the models may include one or more neural networks. In certain embodiments, the neural network can include an input layer, an output layer, and/or one or more intermediate layers, such as hidden layers, which can each have respective nodes. In certain embodiments, the AUV system can train/update the neural network by modifying or updating one or more parameters, such as weights and/or biases, of various nodes of the neural network responsive to evaluating estimated outputs of the neural network.

In certain embodiments, the AI models used in the AUVs can be or include various neural network models, including models that are effective for operating on or generating data including but not limited to image data, video data, text data, speech data, audio data, sensor data, or various combinations thereof. In certain embodiments, the models can include one or more transformers, recurrent neural networks (RNNs), long short-term memory (LSTM) models, other network types, or various combinations thereof. In certain embodiments, the models can include generative models, such as generative adversarial networks (GANs), Markov decision processes, variational autoencoders (VAEs), Bayesian networks, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof.

In certain embodiments, the models can include at least one navigation or trajectory model. In certain embodiments, the navigation or trajectory model can include any function, model (e.g., neural network or other machine learning model), operation, routine, logic, or instructions to perform functions such as determining trajectories of one or more AUVs according to various parameters. For example, the navigation or trajectory model can determine a trajectory of a AUV in an underwater environment according to one or more of a past trajectory of the AUV, a past trajectory of one or more remote AUVs, or context information regarding the underwater environment. In certain embodiments, the context information can include or be determined according to various rules, policies, or heuristics with respect to realistic movement, navigation, and trajectories, and may be processed by the trajectory model in a manner that allows for controllability of the determination of the trajectory of the AUV.

In certain embodiments, the trajectory model includes at least one generative model or neural network, such as at least one diffusion model. The diffusion model can be a continuous time diffusion model. The diffusion model can include a neural network, such as a denoising network. For example, in brief overview, the diffusion model can include a network that is trained, updated, and/or configured using training data that includes data elements to which noise is applied, and configuring the network to modify the noisy data elements to recover the (un-noisy) data elements.

In certain embodiments, an AUV system can configure the trajectory model to determine, for one or more AUVs, at a given time, a state trajectory indicating at least one future state of the AUV. In certain embodiments, the future state of the AUV can be a state of the AUV at a time step subsequent to t. In certain embodiments, the trajectory model can determine a plurality of future states of the AUV τAUV=[AUVₜ+1, AUVₜ+2, . . . AUVₜ+T_{f}], where T_{f} represents a number of time steps, and the states can be defined as a vector or matrix of position and/or motion data of the AUV, such as [x, y, θ, v]^{T}, where x and y represent position of the AUV in two dimensions (e.g., horizontal/vertical directions in a 2D plan view of the environment), θ represents a heading angle (e.g., angle of direction) of the AUV, and v represents a speed of the AUV. In certain embodiments, the states s can include, among various parameters, the heading as a two-dimensional heading vector (e.g., in the dimensions of x and y), a bounding box of the AUV (e.g., length and width dimensions of the bounding box), an indication of whether the AUV is visible or occluded, or various combinations thereof.

In certain embodiments, the system determines the state Ts according to at least one action τAUVa=[aAUVt+1, aAUVt+2, . . . aAUVt+Tf]. Each action at can be defined as a vector or matrix representative of motion data, such as aAUVt=[\dot{v}, \dot{θ}]^{T}, where \dot{v} represents acceleration and \dot{θ} represents rate of change of heading (e.g., yaw rate). For example, the state τAUVS can be determined according to a function f(AUVt, τAUVa), such as a dynamics model to allow the system to determine the state trajectory τAUV based at least on an initial (or current) state AUVt and the plurality of actions τAUVa. For example, the dynamics model can be a model or function that can determine movement or other state information from action information. As such, the system can define a full state-action trajectory as [τAUV, τAUVa].

In certain embodiments, the system can configure the trajectory model to determine the future trajectory of the AUV (e.g., determine at least one of τAUV and τAUVa) based at least on (i) one or more past states (e.g., a past state trajectory of the AUV): x^{·ego}=[AUVt−Tp, St−Tp+1 . . . AUVt], (ii) one or more past states (e.g., past state trajectories) of one or more remote AUVs: X^{Rem}={xⁱ} i=1^{N}; or (iii) a map context in a frame

In certain embodiments, the map context includes a plurality of pixels arranged around the subject, such as by being cropped from a full context to a plurality of pixels extending outward in one or more directions from where the subject is located. In certain embodiments, the map context (e.g., one or more pixels of the map context) can include one or more binary channels indicating the presence or absence of a type of feature, such as a semantic property. In certain embodiments, the channels can include, for example and without limitation, channels such as whether a pixel is a movable area, an obstacle, an underwater terrain or various combinations thereof.

In certain embodiments, the remote AUVs can be at least a subset of all remote AUVs maintained by the system; for example, the remote AUVs can be any remote AUV within a threshold distance from a channel, or within a same grid portion of the environment as the channel.

In certain embodiments, the AUV system can operate on training data elements (e.g., training data instances), which may be retrieved from one or more databases. The one or more databases can be maintained by one or more operators or entities, which may be entities that maintain the system or may be separate from entities that maintain the system. In certain embodiments, the system uses training data from different data sets, such as by using training data elements from a first database to perform at least a first configuration of the models, and uses training data elements from a second database to perform at least a second configuration of the models. For example, the first database can include publicly available data, while the second database can include domain-specific data (which may be limited in access as compared with the data of the first database).

In certain embodiments, the training data elements can include AUV data and remote data. In certain embodiments, the AUV data and remote data can respectively include data such as AUV state, action, and/or trajectory data (e.g., τ_{AUV}, τₐ, x^{ego}) and remote subject data (e.g., X^{Rem} and/or state or action data thereof). For example, the AUV data (and remote data) can include trajectory data including at least positions and/or motion data (e.g., velocity and/or acceleration) of one or more AUVs at points in time. In certain embodiments, the AUV data (and remote data) can be determined or generated, for example and without limitation, from text, image, or video data of AUVs; from synthetic trajectory determination by various simulations or models; from outputs of prior implementations of the machine learning models; or various combinations thereof. In certain embodiments, a plurality of remote trajectories of remote data may be associated with each respective AUV trajectory of AUV data. In certain embodiments, the AUV data includes remote data, such that the system can receive, for a given AUV data, AUV data of other AUVs to use as remote data. For example, for a given training data element, the remote data may include identifiers of one or more remote AUVs relative to the AUV data of the training data element. In certain embodiments, the AUV data and remote data can include various identifiers or class information regarding the subjects (and remote subjects), such as identifiers of each subject, classes (of entities or objects that the subjects represent), or groups that the subjects may be assigned to.

In certain embodiments, the system can perform diffusion on one or more AUV trajectories τ⁰, which the system can retrieve from respective AUV data. In certain embodiments, the trajectories τ⁰ can be clean (e.g., as opposed to trajectories determined using noise) future trajectories of AUV. In certain embodiments, the AUV system can perform diffusion by applying noise to (e.g., diffusing; augmenting with noise; adding noise) the trajectories τ⁰, to determine noisy training data points (e.g., diffused or noisy data, such as noisy trajectories).

For example, the system can add the noise to the trajectories τ⁰ (e.g., add a numerical value representing the noise in a same data format as the trajectories τ⁰, to the trajectories τ⁰) to determine the noisy training data points. In certain embodiments, the system can determine the noise to add to the trajectories τ⁰ using one or more noise distributions, which may indicate a noise level according to a step, x (e.g., diffusion step of a sequence or plurality of diffusion steps), where 0<x<X, such that applying noise corresponding to the amount of steps X may result in the training data point τ^{x} representing Gaussian noise. For example, the noise can be a sample of a distribution, such as a Gaussian distribution. The noise associated with a step x can correspond with a duration of time t (e.g., of an interval 0<t<T). In certain embodiments, the system can apply the noise according to or with respect to the step x and/or a number of steps x (e.g., where 0<x<X as noted above). The value of step x may be a multiple of a number of discrete steps between zero and X. The maximum X may correspond to number of diffusion steps such that the result of applying noise for a duration of time X may be indistinguishable or almost indistinguishable from Gaussian noise.

For example, the system can perform a forward noising process to determine at least one noisy training data point from the clean trajectory τ⁰ such as to determine a plurality of progressively noisier trajectories (τ¹, τ², . . . τ^{x}, . . . τ^{X}).

In certain embodiments, the system can apply noise (e.g., a first amount of noise according to the predetermined variance schedule) to the subject trajectory τ⁰ to determine a first noisy trajectory τ¹; apply noise (e.g., a second amount of noise according to the predetermined variance schedule) to the noisy trajectory τ¹ to determine a second noisy trajectory τ², and so forth up to a Xth noisy trajectory τ^{X}.

In certain embodiments, the machine learning models can include at least one denoising network (e.g., neural network) to perform denoising of the noisy training data point τ^{K} to determine an estimated output (e.g., {circumflex over (τ)⁰). In certain embodiments, the denoising network can be implemented using a U-Net, such as a convolutional neural network that includes downsampling and upsampling paths.

In certain embodiments, the estimated output can have a same format as the AUV trajectories of the AUV data and/or of the noisy trajectories τ¹ . . . τ^{K}. For example, the estimated output can include at least motion data (e.g., velocity and/or acceleration, such as \dot{v}, \dot{θ}) for each of plurality of points of time.

For example, the denoising network can have parameters φ, and the system can configure the denoising network by performing a denoising process defined as:

p_{φ}(τ^{k-1}|τ^{k}, C)=(τ^{k-1}; μ_{φ}(τ^{·k}, k, C), Σₖ)
where the system retrieves Σₖ from a predetermined schedule for denoising, and μ_{φ}can represent a mean of a distribution (e.g., Gaussian distribution) of one or more AUV trajectories for a respective denoising step k. For example, at various steps k that reflect the fact that τ^{k} is a noisy representation of the AUV trajectory of the subject, this noisy representation can correspond to a mean value μ_{φ} and a standard deviation (which may correspond to the schedule Σₖ). In various implementations, the system can perform various parameterizations to relate variables of the denoising network, such as to cause (1) the denoising process to output the clean final trajectory τ⁰, such that μ_{φ} can be determined from τ⁰ and τ^{k}; (2) the denoising process to directly output μ_{φ}; or (3) the denoising process to output noise ϵ that results in τ.sup.k from τ⁰.

In certain embodiments, the denoising network performs denoising of the training data point τ^{K} according to at least one of (i) one or more remote trajectories of remote data corresponding to the AUV data having the AUV trajectory τ⁰ or (ii) one or more context data C of context data. For example, the system can provide, as input to the denoising network, the remote trajectories (e.g., X^{REM} corresponding to τ⁰). In certain embodiments, the system can provide, as input to the denoising network, the map context vr corresponding to τ⁰.

In certain embodiments, the system can configure (e.g., train, modify, update, etc.) the denoising network based at least on the subject trajectories τ⁰ of the subject data and the estimated outputs (e.g., \hat{τ}⁰) determined from respective subject trajectories τ⁰. For example, the system can use various objective functions, such as cost functions or scoring functions, to evaluate the estimated (e.g., candidate) outputs according to a comparison of the estimated outputs with the subject trajectories τ⁰ of the subject data. In certain embodiments, the system can update the denoising network responsive to output of the objective function, such as to modify the denoising network responsive to whether the comparison between the estimated outputs and the corresponding AUV trajectories τ⁰ of the AUV data satisfies various convergence criteria (e.g., an output of the objective function is less than a threshold output or does not change more than a predetermined value over a number of iterations; a threshold number of iterations of training is completed). In certain embodiments, the objective function can include, for example and without limitation, a least squares function, an L1 norm, or an L2 norm. In certain embodiments, the objective function can receive, as input, at least (1) the estimated output (2) the ground truth data (e.g., subject trajectory τ⁰ of the AUV data from which the denoising network determined the estimated output), and can determine an objective value as output responsive to the input.

In certain embodiments, the system configures the machine learning models, including the denoising network, to allow for classifier-free operation of the machine learning models at test time. For example, the system can train, update, or otherwise configure a first denoising network using conditioning (e.g., by using remote AUV data and/or context data) and configure a second denoising network without conditioning (e.g., by not using at least one of remote AUV data or context data) . In certain embodiments, the system can determine the first denoising network as a conditional model μ_{φ}(τ^{k}, k, C) and can determine the second denoising network as an unconditional model μ_{φ}(τ^{k}, k). In certain embodiments, the outputs of the condition and unconditional models can be weighted in various manners, providing a user greater controllability while enabling the networks to be trained using datasets with varying annotations (e.g., since the models are trained with conditioning being randomly dropped out, mixed data with subsets of the full conditioning can be used; since datasets may include additional datasets with diverse motions but no semantic maps, and may include datasets with limited motions and detailed maps, mixed training can facilitate trajectory diversity and controllability under various such input conditions).

In certain embodiments, the system can apply various machine learning model optimization or modification operations to modify the machine learning model responsive to the outputs of the objective function. In certain embodiments, the system can use a gradient descent operation, such as stochastic gradient descent.

In certain embodiments, the system uses at least some different subsets of the data to configure the machine learning models. In certain embodiments, the system can use a first subset, such as a first batch of the training data elements to perform a first configuration of the denoising network, and a second subset, such as a second batch of the training data elements to perform a second configuration of the denoising network. In certain embodiments, the first subset and second subset may be from the same or different databases, such as different databases having different levels of public accessibility. In certain embodiments, the first subset may be a training dataset, and the second subset may be a test or validation subset. The databases can include data of different types of annotations, such as annotations indicating different classes or categories of objects or features.

In certain embodiments, other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In certain embodiments, the system can include any function, model (e.g., machine learning model), operation, routine, logic, or instructions to perform functions such as configuring, deploying, updating, and/or generating outputs from machine learning models, as described herein. In certain embodiments, the system can incorporate features of the system, including to perform training operations for configuring and updating machine learning models. For example, the machine learning models can include and be trained or otherwise configured with a model architecture that includes the pre-processing components such as featurizer, as well as fully-connected layer; the machine learning models can be configured by concatenating noisy trajectories τ^{k} with featurized context data determined from context data C and/or map context.

In certain embodiments, the system can include at least one machine learning model. In certain embodiments, the machine learning models or portions thereof can be received from the system as a data structure that includes the machine learning model or a representation or variation thereof, such as a data structure representing the structure of the machine learning model (e.g., layers or arrangements of layers) or the parameters of the machine learning model. In certain embodiments, the system can operate machine learning models to control determination of trajectories of pedestrians or other subjects or agents according to one or more guidance criteria, which can facilitate determination of realistic trajectory determination.

In certain embodiments, the system can receive at least one input, which can represent one or more states or scenarios of an environment. In certain embodiments, the input can include at least one past trajectory of an AUV. In certain embodiments, the past trajectory can include at least one of state data (e.g., position and/or motion data) or action data (e.g., motion data, such as velocity and/or acceleration data) regarding one or more past states of the AUV, such as states through which the AUV has moved up to a current time point. In certain embodiments, the input can include at least one remote past trajectory of one or more remote AUVs, such as other AUVs or other remote entities in the environment. In certain embodiments, the neighbor past trajectories can include at least one of state data (e.g., position and/or motion data) or action data (e.g., motion data, such as velocity and/or acceleration data) regarding one or more past states of the remote AUVs, such as states through which the remote AUVs have moved up to a current time point.

In certain embodiments, the context data can include 3D information representative of objects or other features in the AUV environment. In certain embodiments, the context data can indicate semantic classes or categories of the features in the environment. In certain embodiments, the system represents the context data in a map data structure, depicted as rasterized map. For example, the map data structure can be a top down or bird's eye view data structure, in which two dimensions (H, W) represent lateral directions (e.g., front/back and left/right), and a third dimension represents features at corresponding coordinates (e.g., pixels) of the map data structure. In certain embodiments, the map data structure can include additional dimensions to encode information such as height, class, etc. of features.

In certain embodiments, the machine learning models can include one or more pre-processing components to modify the inputs or portions thereof for further processing. For example, the pre-processing components can perform various filtering, featurizing, compression, or other operations to prepare or modify the inputs for downstream processing. In certain embodiments, the featurizer can include a neural network, such as a convolutional neural network (CNN), such as a 2D convolutional neural network, configured to determine a feature grid Ψ from the map data structure. The feature grid Ψ can include a plurality of pixels, in which one or more pixels indicates a high-dimensional feature, such as a single feature representative of features of the map data structure at each pixel.

In certain embodiments, the pre-processing components can include at least one of a position encoder, one or more multi-layer perceptrons (MLPs), or a fully-connected (FC) layer. In certain embodiments, the position encoder can apply sin/cosine position encoding to the denoising step k, and the MLPs can process the respective past subject trajectory (x^{ego}) and remote AUV trajectories (X^{REM}) to provide these features to the FC layer to determine a conditioning feature (e.g., single conditioning feature). As such, the pre-processing components can determine the conditioning feature from at least one of the diffusion step k, the state of the one or more AUVs, the past trajectory of the AUV, or the past trajector(ies) of remote AUVs, and apply the conditioning feature to one or more layers of denoising network. Various such pre-processing components can operate with respect to various iterations of processing the noisy trajectories τ^{k} (which can represent estimated or candidate trajectories for the subject) for example, pre-processing may be performed once, and data determined from pre-processing can subsequently be retrieved for any denoising step k as needed.

In certain embodiments, the system can combine information from the feature grid Ψ with the noisy subject trajectory τ^{k} (e.g., where the denoising schedule Σₖ can be used to denoise a (fully) noisy trajectory sample τ^{K} through steps K−1, K−2, . . . k+1, k, k−1, etc.). In certain embodiments, the system can identify each of a plurality of positions represented by τ^{k} (e.g., the positions of the states of the AUV that make up the trajectory τ^{k} for each respective time step of the trajectory τ^{k}), and for each position of the plurality of positions, retrieve a feature from a corresponding position of the feature grid Ψ to determine a feature trajectory Ψₖ. In certain embodiments, the system can retrieve the feature from the corresponding feature of the feature grid Ψ by interpolating between the positions of the noisy trajectories and the positions of the pixels of the feature grid Ψ. In certain embodiments, the system can combine the noisy AUV trajectory τ^{k} and the feature trajectory Ψₖ by concatenating the noisy AUV trajectory τ^{k} with the feature trajectory Ψₖ. In certain embodiments, the system can combine the noisy AUV trajectory τ^{k} and the feature trajectory Ψₖ to determine an input, which can allow the system to determine a localized representation of the environment around the AUV, which can facilitate map interactions such as obstacle avoidance.

In certain embodiments, the denoising network can receive, as input, the input (e.g., receive data representative of at least one of the noisy trajectory τ^{k} or the feature trajectory Ψₖ and can determine a trajectory responsive to the input. In certain embodiments, the trajectory can be a future trajectory, such as a trajectory indicating states of the AUV subsequent to the states of the past trajectory x^{ego}. In certain embodiments, the trajectory can include a plurality of future states of the AUV, such as states continuing from x^{ego}. In certain embodiments, the trajectory can include a prediction of a clean (e.g., not noisy) final trajectory \hat{τ}⁰ of the AUV. In certain embodiments, the trajectory can include a state of the AUV at a second time point that may be subsequent to a first time point of ego (e.g., subsequent to a latest time point of x^{ego}).

In certain embodiments, the denoising network can receive, as input, the conditioning feature. In certain embodiments, the conditioning feature can be combined with (e.g., added to) the intermediate trajectory received by and/or determined by any one or more of the layers of the denoising network, such as to add the conditioning feature to the inputs to each of the layers of the denoising network. In certain embodiments, this can enable the denoising network to account for the AUV's prior states, as well as states of neighboring AUVs, along with the overall process of denoising, to inform how to determine the future trajectory.

In certain embodiments, the system can determine the trajectory according to guidance, which can indicate criteria for determination of the trajectory, such as to allow for controllability of the trajectory. In certain embodiments, the guidance can represent a loss according to an amount by which the trajectory violates or deviates from a guidance objective, such as a user-defined or user-inputted objective. In certain embodiments, the guidance can include one or more instructions, rules, heuristics, models, policies, functions, algorithms, etc., which the system can use to control, modify, update, or perturb how the denoising network determines the trajectory. In certain embodiments, the system can select or determine the guidance according to user input, such as quantitative, qualitative, and/or semantic input indicating the objective(s) that an operator is directing the system to follow for determining the trajectories. In certain embodiments, the system can apply the guidance to various portions of the processing pipeline for determining the trajectory, including but not limited to the trajectory (e.g., the clean final trajectory \hat{τ}⁰), such as to back-propagate a result (of applying the guidance to the trajectory) to the denoising network. In certain embodiments, the guidance can indicate penalties and/or rewards associated with distances of the AUV with respect to other AUVs or objects or features in the environment meeting criteria such as minimum or maximum thresholds.

In certain embodiments, the guidance can be defined as a function, which can be a learned function or a differentiable analytical function. For example, the function can be learned including guidance information in context data as part of training the denoising network, or using one or more separate neural networks that are trained or configured using training data that includes examples of trajectories and guidance information, such as to learn reward and/or loss values associated with how trajectories are arranged relative to target states corresponding with guidance information.

In certain embodiments, the guidance can indicate at least one of a waypoint, obstacle avoidance, collision avoidance, or AUV group movement. For example, the guidance can indicate at least one of AUV's avoidance (e.g., avoiding collisions or distances between AUVs being less than a threshold) or social distance criteria, such as to indicate a penalty value for distances between AUVs being less than a threshold (e.g., a nonzero threshold or a threshold of zero to indicate collision). In certain embodiments, the guidance can indicate obstacle avoidance, such as by indicating a penalty value for the AUV (or a point of a bounding box of the AUV) entering a threshold distance of the obstacle. In certain embodiments, the guidance can indicate waypoints for the trajectory to pass through at specific time steps or any time step, such as by assigning rewards for the trajectory passing through the way point and/or penalties for not passing through the waypoint. In certain embodiments, the guidance can indicate rewards for the AUV remaining within a distance of one or more other AUVs of a group or swarm (or penalty values for not remaining within the distance).

In certain embodiments, the system can determine the trajectory based at least on (i) a conditional network and (ii) an unconditional network. For example, the denoising networks can be determined as conditional model μ_{φ}(τ^{k}, k, C) and unconditional model μ_{φ}(τ^{k}, k); the machine learning models can include one or more networks, which can include a conditional network corresponding to the conditional model μ_{φ}(τ^{k}, k, C) and an unconditional network corresponding to the unconditional model μ_{φ}(τ^{k}, k).

In certain embodiments, the AUV system includes a computing process that may be performed using any combination of hardware, firmware, and/or software. For instance, various functions may be carried out by a processor executing instructions stored in memory.

In certain embodiments, the method may also be embodied as computer-usable instructions stored on computer storage media. In certain embodiments, the method may be provided by a standalone application, a service or hosted service (standalone or in combination with another hosted service), or a plug-in to another product, to name a few.

In certain embodiments, the system monitors AUVs moving in an environment, such as to determine trajectories of AUVs using neural networks. Various operations of the method can be implemented by the same or different devices or entities at various points in time. For example, one or more first devices may implement operations relating to configuring (e.g., updating or training) diffusion models, and one or more second devices may implement operations relating to determining trajectories using diffusion models. The one or more second devices may maintain the neural network models, or may access the neural network models using, for example and without limitation, APIs provided by the one or more first devices.

In certain embodiments, the systems and methods include identifying one or more criteria for movement of an AUV in an environment. In certain embodiments, the environment can include at least one of a simulated environment (e.g., virtual environment) or a simulated representation of a real world environment. In certain embodiments, the environment can by a physical or real world environment. In certain embodiments, the AUV can include various entities that may be present or moving in the environment, including but not limited to obstacles or other AUVs. In certain embodiments, the criteria can include criteria for AUVs, objects, or features of the environment for the AUV to maintain distances relative to, such as according to minimum and/or maximum thresholds. For example, the criteria can include, without limitation, criteria associated with guidance criteria such as waypoints, collision avoidance, obstacle avoidance, distance, and movement in the AUV groups. For example, the criteria can indicate a distance to maintain with respect to one or more remote AUVs.

In certain embodiments, the criteria can be received as operator input, such as by presenting a prompt via an operator interface to request the operator input. The criteria can be retrieved from at least one of a learned function or an analytical function.

In certain embodiments, the methods includes determining, using a neural network, a trajectory of the one or more AUVs according to the one or more criteria. For example, the neural network can include a denoising network configured to determine, from a noisy representation of a candidate trajectory, the trajectory of the subject. In certain embodiments, the denoising network can determine the trajectory using information such as state data of the subject (e.g., past trajectory of the subject), state data of remote subjects (e.g., trajectory data of other subjects in the environment), and context data of the environment, such as locations of road, obstacles, or other areas to move through or avoid. For example, a path of the trajectory can be used to query a map representation of the environment to identify locations of features of the environment that coincide with the path, to determine the trajectory according to the identified features neural network can be configured (e.g., trained) using

In certain embodiments, the examples of AUV trajectories, trajectories of remote subjects, and context information regarding the environment, such as information indicating obstacles, environment, or other features that AUVs may account for while moving in the environment.

In certain embodiments, the method includes at least one of (i) updating a representation of the trajectory of the AUV in the environment or (ii) present, using a display, the trajectory of the AUV in the environment. For example, a simulation or other computer representation of the environment can be updated in time, during which the AUV can be moved through the trajectory. In certain embodiments, the simulation or other representation can be displayed using a display device. In some implementations, the trajectory is used for AUV control, such as for testing operation of an autonomous AUV controller.

In certain embodiments, the system, server, computer device, etc., and one or more procedures and/or processes for identifying, navigating, communication, operating, and managing one or more AUVs (e.g., a swarm of AUVs including 100 s or even 1.000 s of AUVs). In general, an AUV fleet may include two or more AUVs preferably 10, preferably 100, preferably 1000, preferably 10,000, preferably 100,000 AUVs; however, in certain embodiments, one AUV may be active at a particular time. In certain embodiments, the AUV swarm may include a mobile device that is capable of operating in or below a body of water and which has various hardware components used to control the AUV swarm operation. In general, an AUV optionally has one or more propellers which are controlled by a motor that causes the AUV to maneuver below the water surface. Other examples may include AUVs which operate without propellers by using other propulsion techniques. Also, multiple AUVs may be underwater at any given team operating in an autonomous swarm or fleet.

In certain embodiments, the AUVs may have any number of cameras which are capable of capturing images and/or video content of an area above, even with or below the AUV. In certain embodiments, the AUVs may also have sensors to detect sound, water disturbances, chemical presence, light, etc. In certain embodiments, the AUVs may also have the capability to collect a sample of material by a mechanical capture and/or to drop or deliver an object (e.g., a payload) it is or was previously carrying.

In certain embodiments, the internal components of the AUVs may include a computer or portions thereof, such as a memory, processor, storage, battery, software used to control the AUV operation, a radio transceiver for transmitting/receiving a radio communication signal, etc. In certain embodiments, the AUVs may have a structure that protects its components and provides an aerodynamic body to provide a stable maneuvering during a operation. Any number of motors on the AUV can be used to control the propeller(s), moving parts, etc.

In certain embodiments, the AUV swarm may transmit data to an operating station, such as a computer server that is accessible by a radio access point. In certain embodiments, the AUV swarm can capture content and send it wirelessly to the server continuously or in certain intervals depending on the information sharing procedure employed by the AUV swarm.

In certain embodiments, the AUV swarm initially powers-up, turns-on and/or attempts to communicate with a primary communication station (e.g., AUV authentication server), the AUV swarm may use its transmitter/receiver components to wirelessly communicate and share its identity with the management entity. In certain embodiments, the process may include an identifier being forwarded as a beacon signal by the AUV to an access point, such as a field router, a base station, a wireless hub, etc. The access point may use satellite, cellular, and/or other wireless communication systems, mediums and protocols, such as Wi-Fi protocols, including 802.11xx or comparable protocols and/or frequencies. The access point may be in communication with one or more servers and/or databases configured to store secure data related to the AUV.

In certain embodiments, a beacon signal may include a name, identifier code, protocol information, secure token data, smart contract information assuming a blockchain configuration is being used and/or other profile information (e.g., hardware address, etc.). In certain embodiments, the blockchain may assert authority to operate and act as an orchestrator to control all actions of the AUV swarm. As a distributed entity, the blockchain permits secure coordination of AUV operations by permissioned entities. Due to the inherent consensus algorithm, no one can unilaterally alter data, unlike traditional authentication and storage systems. In certain embodiments, the access point can facilitate information exchange between one or more AUVs and an AUV management server by sending and receiving information to the AUV as it is operating. In certain embodiments, the AUV identifier information received may be stored in the authentication server which is responsible for storing AUV profile information and forwarding tokens and credential information to the blockchain, which verifies the credentials prior to the AUV being assigned a mission or task related instructions. In certain embodiments, the server may commit transactions for records of tokens, encryption key data, blockchain transactions in a blockchain structure.

In certain embodiments, when identifying and confirming authentication with the one or more AUVs, secure communication and identity management is performed to avoid any unauthorized entities from interfering with the efforts of the AUV management system. One approach to authentication is to use a public-key cryptography to authenticate each of the AUVs. In certain embodiments, this may include requiring a public key to encrypt data sent to and from the AUVs. In certain embodiments, the Public/Private key Pair assigned to a specific AUV may ensure encrypted communications. Each time an AUV is accessed, a unique key may be assigned to the AUV to ensure an encrypted communication session between the AUV and the server.

In certain embodiments, other access control mechanisms may be used to authorize AUvs based on their roles and permissions. When an AUV establishes its operation, the AUV may be assigned a particular status such as ‘active’ or ‘inactive’ to indicate it is ready or not ready to perform a particular task, the AUV may be assigned a role, such as ‘leader’ or ‘follower’ to indicate whether it will be sending commands to other AUVs in the body of water or whether it will be receiving the commands and following the command orders. If a leader AUV is experiencing a degradation in its activities during a mission or other coordinated task with other AUVs, logic and information stored in a smart contract may be invoked to redefine a role and a mission to redistribute tasks so new AUVs can be established as leaders and mission tasks may be conducted. In one example, if a fleet of AUVs are needed to take images and video of a particular geographical area, in order to ensure the AUVs perform unique reconnaissance efforts and do not overlap and interfere with one another, one lead AUV may be needed to assign a first area to a first follower AUV and a second area to a second follower AUV while the leader performs other tasks. In certain embodiments, the lead AUV may communicate with a plurality of other AUVs directly, for example, via radio communication. Each transaction or AUV event may be logged in a blockchain to maintain a ledger of all events performed by the AUV(s).

In certain embodiments, a private (e.g., permissioned) blockchain may be used to record AUV presence and to manage the AUV identities, roles and permissions during a registration and authorization procedure. In certain embodiments, a fungible token, such as an Ethereum request for comment (e.g., ERC20) token may be used as a mechanism to identify trusted AUVs. In certain embodiments, the token may be assigned previously and may be required to be received and verified prior to permitting an AUV to be listed as accessible and authorized for use.

In certain embodiments, during the initial authorization and registration phase of an AUV's operation, the event may be logged in a blockchain transaction to include various parameters, such as a current time (T1), an AUV identifier ((IAUV1)—name, model, etc.), an initial role ((R1)—leader, follower, etc.), and one or more permissions ((P1)—read, write, assign missions, perform actions, etc.). In certain embodiments, the registration and authorization transaction may be a first transaction that is stored in the blockchain. A smart contract may be used to assign rules and other criteria to the AUVs which can be applied in the field during a mission, such as capturing images and content over a specific geographical area and for a period of time.

In certain embodiments, a monitoring configuration can assign tokens for newly identified AUVs and revoke tokens for offline AUVs, which have not maintained a signal communication at expected intervals for a Period of time. For example, an AUV that is actively communicating with the server may send a communication signal every 30 seconds. When the server does not receive a signal for 60 seconds, the AUV may be considered inactive and may have its token revoked for inactivity.

In certain embodiments, each of the AUVs may be assigned a unique private key that is generated using a cryptographically secure random number generator and is used to identity verification credentials, token storage and transfer, and secure communication. In certain embodiments, to implement secure communications and identity management for the AUVs, hardware-based security features may be used with a blockchain to form a comprehensive security measure for AUV-based applications.

In certain embodiments, the AUV is forwarding periodic communications to the access point. When the communication is received, the authentication server may create a transaction to log the updated status of the AUVs. For example, between every signal a new set of content (images, video, etc.) may be identified by a communication sent by the AUV. In certain embodiments, the storage server may update the ledger to include a new transaction to identify the current time (T2), the AUV identifier (IAUV1), role (R1), permission (P1) and an updated mission status MS1, which in this example may indicate new content to store on the blockchain, such as media, images, video which need to be stored and catalogued for subsequent review. In certain embodiments, the next transaction creation operation is performed to include in the ledger with the updated information received. When an AUV is reporting an update, the mission assignment may be changed and/or maintained and an updated mission message may be sent including objectives, locations and other information necessary for the AUV to perform the operations corresponding to the instructions received. In certain embodiments, information which may be included in the mission assignment instructions may include global positioning satellite (GPS) coordinates used to provide locations to capture content, battery life requirements, permissions needed to perform the AUV actions, etc. In certain embodiments, the communication may modify a current AUV status and mission and overwrite the previous instructions in light of the new mission data received at the AUV.

In certain embodiments, an AUV may be initialized during a power-up operation and may attempt to communicate with a device to register and receive credentialing. One example process may include receiving, at a server, one or more communications from one or more AUVs, the process may also include identifying, via the server, the one or more AUVs are active in a predefined geographical area, authorizing, via the server, the one or more AUVs to receive one or more assignments and performing, via the server, the one or more assignments to the one or more AUVs to Perform one or more operations, and the operations assigned to the one or more AUVs are based on one or more roles and permissions assigned to the one or more AUVs. In certain embodiments, the AUVs with management or leader roles will receive leader oriented operations, such as to instruct other AUVs on how to complete a mission, what parts of a mission the leader AUV will perform and what parts the other AUVs should perform. Examples may include shift work, such as monitoring an area for a period of time by one AUV and then having another AUV monitor the area for a second period of time while the first AUV is charging or performing another operation.

In certain embodiments, additional operations may include assigning a leader role and a leader permission to a first AUV of the one or more AUVs, and the leader role permits the first AUV to provide assignments to follower AUVs. Once the leader is established, the other AUVs may be identified as follower AUVs which are assigned tasks directly from the leader AUV or via with the permission of a ground station device. The leader AUV may ask the ground station permission to perform the assignment of a mission or tasks which make up a mission. All transactions may require token authorization and may be solidified by creating and storing a transaction in a blockchain. The process may also include assigning a follower role and a follower permission to a second AUV of the one or more AUVs, and the follower role permits the second AUV to receive an assignment from the first AUV, and the follower permission requires the second AUV to transmit one or more updates to the first AUV to report updates on the assignment and a current status of the second AUV. All AUVs must have a unique key registered in the blockchain and must have received a unique token. The specific role should be assigned as a leader or a follower. Each follower should know which leader could assign it tasks. Each assignment should be verified via a smart contract and each transaction should be posted in the blockchain by leader AUVs and follower AUVs. In certain embodiments, the roles and permissions and rules for accepting and denying assignments may be overridden by an authorized entity, such as an operator or entity that is controlling the one or more AUVs. The owner roles may be defined in the blockchain transactions and/or the smart contracts.

In certain embodiments, the one or more communications include signals periodically sent from each active AUV, and the signals include one or more of a AUV identifier, a AUV status, an assigned role and an assigned permission. In certain embodiments, the signals may include a unique key assigned to each AUV being sent to other AUVs and/or to ground station devices, such as a management server.

In certain embodiments, the process may also include creating a data entry in memory based on the unique key, storing the data entry in a blockchain transaction, and updating a smart contract to identify the leader role assignment and the follower role assignment, assigning a token to each of the one or more AUVs, and storing the one or more assigned tokens in the blockchain transaction. In one example, each of the communications is signed by the unique key associated with the AUV that sent each of the communications, and the unique key may include a public key and private key pair.

In certain embodiments, the anatomy of the AUVs may include a system of components which are needed to control and execute instructions associated with the AUV's operation. Each AUV may have a set of mechanical components such as an aerodynamic body, propeller(s), and a set of internal components, such as one or more sensors (e.g., GPS, gyrometers, accelerometers, light, sound, infrared, chemical, movement, temperature, pressure sensors), a memory to store digital information for AUV operation, a permanent storage for storing content that is captured, a battery for powering the digital components as well as the mechanical components, a transmitter/receiver pair which may include one or more antennas and receivers for receiving and broadcasting wireless communication signals, one or more motors and a processor for computer based operations.

In certain embodiments, the AUVs may be different from one another, some may have additional memory, batteries, motors, reconnaissance features, tactical payload, etc., that others do not have as part of their composition. In certain embodiments, the AUVs may communicate via their transmitter/receiver communication resources to exchange roles, permissions, mission data, etc. A role may be a leader or follower and a leader may command a follower to perform tasks such as part of a mission the AUV leader is attempting to have the follower AUVs perform. In certain embodiments, the permissions are the guiding factors which indicate what actions a AUV can and cannot perform. For example, a leader AUV can command a follower AUV but not vice versa. In certain embodiments, the leader AUV may request a status of another AUV which provides a status update. The AUVs can then share information once the AUVs have knowledge of one another and are authorized to communicate with one another.

In certain embodiments, the AUVs may be used to monitor areas of interest by capturing motion, noise, light detection via the one or more sensors included on the AUV. In certain embodiments, the AUVs may also capture content and send the data received to another entity for recordation and/or action. In a military environment, an AUV may be equipped with an ordnance or related weapon that can dispel a torpedo, mine, chemical, or explosive. In certain embodiments, certain actions detected by the AUV may trigger actions, such as dispatch, messaging and other communication signals which enact a follow-up event to notify third parties and/or to enable the AUV mission to be modified for additional screening operations. Additionally, AUVs may have robotized arms, legs and other mechanical components which can pick up and later drop objects at certain locations.

In certain embodiments, military AUVs play a vital role in modern warfare, providing situational awareness and intelligence to ground/sea command. However, ensuring secure communication and managing AUV identities becomes increasingly important as the AUVs become more autonomous and interconnected with the certain control systems.

In certain embodiments, a compromised (e.g., broken, inoperable, lost, etc.) AUV can pose a significant risk to mission success and to the safety of personnel on the ground or at sea. Ideally, an authorized AUV would share captured content, communications and other data with control systems or other AUVs on an ongoing basis to avoid information theft in the event that the AUV was captured by an adverse party. Secure communication and AUV identity management may be provided by using an immutable ledger, such as a blockchain. In certain embodiments, the blockchain is an immutable ledger that commits transactions which may include various information in a manner that ensures outside parties cannot access and/or destroy the information without the proper credentials.

In certain embodiments, a combination of secure communication protocols, authentication and authorization mechanisms may enable secure AUV management operation. In one example, blockchain-based identity management, and using ‘ERC20’ tokens for trust verification may provide a secure way to authenticate and monitor AUVs. Also, using AUV specific private keys for enhanced security and privacy may enable additional security measures.

In certain embodiments, an AUV may use a secure communication protocol to communicate with a ground control station and/or other AUVs. In certain embodiments, the communication between AUVs can be secure by enabling transport layer security (TLS) or secure socket layer (SSL) protection to encrypt a particular communication channel. Additionally, authentication and authorization mechanisms can be used to ensure that only authorized AUVs can communicate with each other. Public-key cryptography may be used to authenticate AUVs. Each AUV may have a unique private key that is used to sign messages, and a corresponding public key that is used to verify the signature. Other access control mechanisms may be used to authorize AUVs based on their roles and permissions.

In certain embodiments, in order to manage identities of AUVs, a blockchain-based approach may be used by creating a private (i.e., permissioned based) blockchain network that is accessible only to the assigned AUVs and which may be used to record and manage the AUV identities. Each AUV can have a unique identity that is recorded on the blockchain, along with its public key and other metadata. This process may ensure that each AUV is identified and trusted within the network.

In certain embodiments, in order to ensure one AUV can trust another AUV, the ‘ERC20’ tokens can be used to establish a trust mechanism. For example, a token on the Ethereum blockchain can represent trust in a specific AUV and can be assigned to other AUVs that have been verified and deemed trustworthy by an authorization procedure. In certain embodiments, each AUV can have a digital wallet as part of an AUV profile store any respective tokens. When one AUV needs to communicate with another AUV, it can verify the trustworthiness of the other AUV by checking its token balance to ensure it still has valid tokens. Token balance checking and other procedural operations may be used to track ERC20 token balances along with other token tracking operations.

In certain embodiments, to implement secure storage and retrieval of tokens, a decentralized storage solution, such as an interplanetary file system (IPFS) can be implemented. The IPFS can be used to store the token balances of each AUV and ensure that they are securely retrieved when needed. To accommodate limited storage capacity and to avoid data tampering, a sub-block concept can be implemented where only the latest few sub-blocks are stored on the AUV. The sub-block approach increases a speed of verification before blockchain transactions are posted by making it difficult to decipher information on captured AUVs. The full list of block IDs and link IDs would be missing from the captured AUVs even if the capturer successfully deciphers the information stored on a captured AUV. The entirety of the data across all blocks would only be accessible on a controlled blockchain via ground station connectivity.

In certain embodiments, AUV private keys can be used for enhanced security and privacy by utilizing the AUV private keys to authenticate AUVs, store and transfer tokens, and encrypt and decrypt messages transferred to and from the AUVs. Each AUV's private key is generated using a cryptographically secure random number generator and stored securely within its hardware, such as a trusted platform module (TPM). This approach ensures that only authorized AUVs can participate in a common network and communication and transactions are authentic and confidential.

In certain embodiments, the AUVs may implement a procedure that includes sending, receiving and/or monitoring for style periodic communication sent and received by the AUVs and/or one or more ground systems that are in communication with the AUVs. In one example, the mechanism includes AUVs periodically sending messages to indicate that they are online and operational to ground or sea stations and/or other AUVs. In certain embodiments, the monitoring system tracks the heartbeat messages and maintains a record of which AUVs are online and which ones are offline and whether tokens are confirmed for those communications. If an AUV is not identified by a signal after a period of time (e.g., x minutes) and is deemed to have gone offline, its tokens can be revoked and re-allocated to other trusted AUVs, especially when the system is attempting to maintain a specific number of AUVs operating at all times.

In certain embodiments, to ensure secure communication with AUV-to-AUV or AUV-to-ground or sea control stations (e.g., computing devices), a unique serialized key can be added to each communication along with communication protocols. In certain embodiments, the approach uses a unique key that needs to be verified within a blockchain before transaction blocks can be added or accessed. For example, a genesis transaction or block and/or smart contract stored in the blockchain may store details of the unique key, a number of communications required, time intervals for when communications must be received, etc. In certain embodiments, the verification process can then reference the requirements when communications are received. This approach limits the ways that communication tampering can occur and reduces potential takeovers of AUVs by third parties.

In certain embodiments, multiple AUVs can communicate with one another and registering with a AUV management entity according to example embodiments. In certain embodiments, a plurality of AUVs may be included as well. In certain embodiments, the AUV 1 may initiate an information request message to AUV 2 to identify a current status, determine an identifier associated with AUV 2 and/or to determine whether AUV 2 is authorized to participate in a current mission. In certain embodiments, the AUV 2 may confirm its status (i.e., active, inactive, authorized, etc.) in a response communication. In certain embodiments, the response may be sent directly to the first AUV 1 or to the server. In this example, the first AUV 1 may report the status of itself and AUV 2 since it is the leader AUV. In certain embodiments, the access point may forward the status information to the server. The server may authenticate AUVs 1 and 2, and create a new blockchain transaction in the ledger indicating the registration transaction for AUV 2 to include a time, identifier for 2, a role (R2) for 2 and a Permission(s) (P2) for 2. The result may include sending an authorization message to 2 directly including a newly assigned token and the other information pertaining to AUV 2. The authorization may instead be sent to AUV 1 which will store the information and notify AUV 2 of the newly added transaction information.

In certain embodiments, multiple AUVs communicating to one another and exchanging mission objective information and according to example embodiments. In certain embodiments, the AUV D1 attempting to assign a role to AUV 2, such as a follower role and information pertaining to a current mission, which may include areas to fly over and capture content. In certain embodiments, the mission status may be updated by a communication sent from AUV 1 to an access point. In certain embodiments, the communication is forwarded to the authentication server so another transaction may be committed to the ledger. In certain embodiments, the transaction may include updated mission information such as, both AUVs are active and are assigned a current mission. Similar communications may be sent periodically confirming a heartbeat signal communication shared between the AUVs 1 and 2. In certain embodiments, the communications may also be sent to the server to confirm the AUVs are still active during a current mission or while awaiting a new mission. In certain embodiments, the communications may include current status (e.g., mission status, battery level, locations traveled, content captured, etc.). Each communication may also be committed to the ledger.

In certain embodiments, multiple AUVs communicate to one another and perform mission tasks assigned to each specific AUV. In certain embodiments, the configuration includes an example of two AUVs 1 and 2 sharing a current mission to perform data capturing of a particular area. In certain embodiments, AUV 1 may assign itself to capture images/video of area and assign AUV 2 to capture images/video of area as part of a general area that needs to be studied by the AUVs as part of a current mission.

In certain embodiments, the AUVs may search in a particular pattern identified by the mission data to ensure the entire area is studied. In certain embodiments, the mission may be assigned by a first AUV 1 as a leader to a second AUV 2 as a follower. In certain embodiments, the second AUV 2 may confirm the mission assignment and then the AUVs may begin actively performing the study of the area in a manner where they do not interfere with one another and share the responsibility of studying the entire area.

In certain embodiments, once the area study is completed, the second AUV 2 may submit its captured content to AUV 1 and/or to the ground or sea station server. If the first AUV 1 receives the confirmation and/or the content of AUV 2 completing its study, then AUV 1 can forward the mission data as an update to the access point which forwards the data to the server, which updates the records of the mission by sending the mission data to the ledger for storage.

In certain embodiments, the process may also include transmitting, via the first AUV, a response communication to the second AUV indicating a role assigned to the first AUV and the current mission assigned to the first AUV, and receiving, via the first AUV, a confirmation from the second AUV that the second AUV is participating in the current mission with a different role than the role assigned to the first AUV. The role may be a leader role and the response communication further a request to assign the second AUV a follower role as the different role on the current mission. The process may also include transmitting an assignment communication, via the first AUV to the second AUV, comprising assignment instructions for the second AUV to perform over a period of time as part of the current mission, and receiving a confirmation, via the first AUV, that the second AUV has accepted the assignment instructions. In certain embodiments, the process may also include receiving, via the first AUV, one or more heartbeat communications from the second AUV at predefined time intervals, and transmitting a confirmation, via the first AUV, to one or more of the second AUV and the server confirming the heartbeat communications were received. In certain embodiments, the process may further include receiving, via the first AUV, one or more content communications from the second AUV comprising content captured by the second AUV as instructed by the current mission, and forwarding, via the first AUV, a content removal communication instructing the second AUV to remove the content captured. In certain embodiments, the process may also include moving the first AUV over an area defined by the current mission and capturing content associated with the area, and receiving, via the first AUV, a content confirmation communication by the second AUV indicating the second AUV has moved over a different area and captured content associated with the different area defined by the current mission.

In certain embodiments, to prevent data loss in case an AUV is lost or stolen, the AUV private keys can be backed-up and stored in a secure location. The backup and recovery process is designed to ensure that the private keys cannot be easily compromised by attackers. A secure communication protocol is used to encrypt the communications between the AUVs, while authentication and authorization mechanisms are applied to ensure that only authorized AUVs can communicate with each other. Blockchain-based identity management is used to manage the identities of the AUVs by committing and referencing blockchain transactions every time a AUV registers with the system, and the ERC20 tokens are issued to the AUVs and used for trust verification during communication sessions.

In certain embodiments, a decentralized storage solution is used to securely store token balances and other data associated with the AUVs while they are being verified and are operational. In certain embodiments, the AUVs may be assigned private keys which are applied to enhance the security and privacy of the network, and the heartbeat mechanism and monitoring system ensures that the AUVs are operational and trusted within the network. Also, backup and recovery of private keys prevents data loss in case the AUVs are lost or stolen. AUVs may forward information stored in their respective memories periodically so the information can be erased each time a communication is sent to other AUVs or a control station device. In a multi-domain environment, AUVs may need to communicate with each other across different networks, such as air, ground, or maritime networks.

In certain embodiments, the modifications to the architecture for a multi-domain operational environment would depend on the specific requirements and challenges of the environment. However, the basic components of the architecture, such as secure communication, authentication and authorization, identity management, and trust verification, would still be applicable in a multi-domain environment.

In the event that a AUV is compromised (e.g., lost, stolen, captured, etc.), and its machine learning models, artificial intelligence models and other data stored on the AUV are at risk of access by adversaries, several approaches can be taken to secure the models using blockchain technology. One approach involves using a secure trusted execution environment to host the machine learning models. This would include isolating the models from the AUV's main operating system and operating them in a secure environment that is protected by hardware-based security features. The secure enclave would be accessible only by authorized entities, and access to the enclave would be managed using blockchain-based authentication and authorization mechanisms.

Another option is to use a federated learning approach by which machine learning models are trained on multiple AUVs and updates are aggregated in a decentralized manner. This approach includes distributing the machine learning models across multiple AUVs and using a consensus mechanism, such as a blockchain consensus group of peers, to coordinate the updates. The models would be encrypted using a secure communication protocol and access is managed using blockchain-based authentication and authorization mechanisms.

In certain embodiments, homomorphic encryption can be used to encrypt machine learning models and respective data inputs so they can be processed securely by a remote server without revealing the underlying data. This approach would include using a blockchain-based approach to manage the encryption keys and ensure that processing is done securely and reliably. The use of a blockchain can provide a secure and decentralized approach to managing machine learning models on AUVs. The specific approach taken would depend on the specific requirements and constraints of the AUV network and would need to be carefully designed and implemented to ensure the security and privacy of the machine learning models and respective data.

In certain embodiments, the operations may involve multiple AUVs and ground or sea entities (e.g., stationary devices, moving entities, vehicles, ships, submarines etc.) that are operating in different domains, such as air, ground, and/or sea. The AUVs and vehicles may be collecting data and information that needs to be shared with other AUVs and vehicles in real-time, while also ensuring that only authorized entities can access the data.

Each AUV and ground or sea vehicle can have a unique identity that is recorded on the blockchain along with respective access control permissions. The data and information collected by each AUV and vehicle can be stored on a decentralized storage solution, such as an interplanetary file system (IPPS), which is accessible only by the authorized entities. The access control permissions can be managed using a consensus mechanism, such as a blockchain, to ensure that only authorized entities can access the data.

In certain embodiments, a trusted platform module (TPM) is utilized to isolate certain processing environments from a AUV's main operating system and operate them in a secure environment. Another approach is to use secure enclaves or trusted execution environments, which can be hosted on hardware devices such as specialized chips or dedicated servers. For example, secure enclaves or trusted execution environments can be used to ensure that machine learning models are stored and processed in a secure environment, even if the AUV is compromised. The environments are tamper-proof and can provide a secure location for storing encryption keys and other sensitive information, and can also limit unauthorized access to models by isolating them from the AUV's main operating system and other applications.

In certain embodiments, using homomorphic encryption to encrypt machine learning models and their inputs, specialized hardware devices such as application-specific integrated circuits (ASICs) can be used to accelerate the encryption and decryption processes. In certain embodiments, the devices are optimized for specific computations and can provide improved performance and efficiency over general-purpose computing hardware.

Another example embodiment may include using multi-domain machine learning, such as in a command, control, communication, computers, cyber, intelligence and surveillance (C5ISR) environment and in a multi-domain operational environment, machine learning algorithms can be used to process and analyze large amounts of data in real-time to provide insights and intelligence for decision-making. However, machine learning models may be at risk of being compromised or stolen by adversaries, especially in dynamic and adversarial environments. Using blockchain technology to store data and recall operatives and mission data, the machine learning models can be distributed across multiple AUVs and other field entities, such as ground vehicles in a decentralized manner, and the updates can be aggregated using a consensus mechanism, such as a blockchain. Data models can be encrypted using a secure communication protocol, and access to the data models can be managed using blockchain-based authentication and authorization mechanisms.

In certain embodiments, the, multiple AUVs and ground vehicles may be collecting data and sending the data to a machine learning algorithm that is processing the data in real-time. The machine learning algorithm may be analyzing data to provide intelligence on enemy movements, weather patterns, and other factors that may impact the mission. The learning algorithms may offer insight on how to conduct the mission more efficiently and to ensure additional measures are taken based on previously performed measures and recent discoveries. In certain embodiments, the updates to the machine learning model can be sent securely to a blockchain, where they are verified and recorded, and the updated models can be distributed to the AUVs and ground vehicles in a decentralized manner. For example, a smart contract may be updated to include additional mission information based on a comparison and threshold based decision procedure.

In certain embodiments, an AUV may discover two sea vehicles which appear to be military types of vehicles. This may cause an association by the machine learning algorithm to determine that a radio communications control center or sea control has been setup nearby since most vehicles communicate to a radio base communication entity to update mission data and to receive and forward tactical operatives. In certain embodiments, the artificial intelligence may then determine an estimated location of the radio station based on the movement and/or positions of the sea vehicles, which, in turn, causes an update to the smart contract to include a new location and new object identification procedure which was not previously part of the mission data. The examples demonstrate how blockchain technology can be used to provide secure and decentralized approaches to managing data sharing, access control, and machine learning in a C5ISR and multi-domain operational environment. By leveraging the security and reliability of blockchain technology, military operations can improve their situational awareness and decision-making capabilities, while also ensuring the privacy and security of their data and machine learning models.

In another example, a mission may dictate that a group of AUVs be deployed to conduct image and/or reconnaissance and gather intelligence on identified object movements. In certain embodiments, the AUVs may be equipped with high-resolution cameras and sensors to detect activity, and may communicate with each other to share information and coordinate movements. As the AUVs travel over a certain area, they may encounter various obstacles, such as electronic jamming signals being present and even hostile firepower. However, the AUVs are able to use their communication and identity management architecture to navigate through these obstacles and continue the mission. If the obstacle or distress event is detected prior to the AUV losing control, the information stored on the AUV may be sent to another AUV and/or to a sea or ground station for secure storage. Also, the AUV may enter a distress operative where it attempts to purge its stored data.

In another example, after a successful reconnaissance mission, one of the AUVs may be captured, and the adversaries may attempts to access the AUV's data and communication channels; however, the architecture's use of secure communication protocols and private keys prevents access by opposing parties. In certain embodiments, the captured AUV's private key may be stored securely within the AUV's hardware and may not be accessible to anyone except the AUV itself, or the private key may already be transmitted and stored in the blockchain. This prevents a captured AUV from providing access to the rest of the network by an opposing party.

In certain embodiments, the opposing parties may attempt to use the captured AUV by creating a fake identity, however the use of blockchain-based identity management, secured by a smart contract, prevents access attempts by third parties. Each AUV's unique identity is recorded on the blockchain, along with its public key and other metadata, making it impossible to create a fake identity without being detected by the control center. Additionally, the use of ERC20 tokens as a trust mechanism ensures that only trusted AUVs are given access to the network. Also, the online and offline status of AUVs can be detected by heartbeat signals. If an AUV goes offline or is captured, the monitoring system can revoke its tokens and re-allocate them to other trusted AUVs, ensuring that the captured AUV's tokens will not be used to gain access to the network.

In certain embodiments, the AUVs may encounter increasingly sophisticated electronic jamming and signal interference from third parties. A machine learning algorithm can be used to adapt to changing signal environments and dynamically adjust communication parameters such as frequency and power to maintain secure communication. In certain embodiments, the AUVs may modify their paths to avoid likely areas of signal jamming, change an operating frequency used by the AUV and seek additional modifications to a recurring mission to ensure the threats are reduced. In certain embodiments, the AUV may also attempt to assign another AUV as a decoy such that one AUV is providing information capturing and the other AUV is assigned to travel around an area and do nothing and collect no data so that AUV will not pose a threat if captured since it has no data sharing or storing capabilities. Another example may include a multi-domain operational environment in which the AUVs need to communicate and share information with other entities and assets, such as ground personnel communication devices, naval vessels, other aircraft, etc. The security architecture can be extended to include secure communication and identity management across multiple domains, using common standards and protocols to ensure interoperability.

In certain embodiments, the multiple (e.g., greater than 10 or even 100) AUVs perform mission task(s) of traveling over a particular area assigned to each AUV respectively. The AUVs may have experienced a distress event by a sensor condition, such as a temperature sensor, a vibration sensor, accelerometer, gyroscope, radio signal interference, etc. An adversary may have fired a torpedo at the AUV, transmitted a jamming signal, etc., and the AUV may determine that it may not be able to continue traveling and may have sunken to the sea floor. In certain embodiments, the AUV may decide to escape the area by rapidly moving away and abandoning its current mission if it is still operable. Such a distress event may invoke distress event instructions which may cause the ERC tokens to be invalidated and an event update may be sent to another AUV. In certain embodiments, the AUV 1 may still be conducting its mission and transmitting updates to the access point which forwards the data for any AUVs which are reporting information to the authentication server or any other device responsible for logging information in the blockchain or another data storage entity.

In certain embodiments, the AUV may also attempt to transmit a distress signal, and/or a time-based liveness/heartbeat signal, directly to the ground or sea station (e.g., access point, authentication server or any Particular computing device in communication with the AUVs). In certain embodiments, the AUV may be preparing for a data purge in which all data stored on the AUV is erased or re-encrypted to ensure security measures are in place prior to being captured by an adversary.

In certain embodiments, one or more indicators may include a change in battery status, a loss of power, an unauthorized access attempt, a change in depth, a change in location, a vibration sensor indication, a temperature sensor indication, an accelerometer indication and a gyroscope indication. The mitigation operation includes one or more of changing a communication frequency of the AUV, temporarily ceasing communications, purging data stored in memory on the AUV, transmitting data to a ground station or another AUV, releasing a current mission, and assigning the current mission to another AUV. In certain embodiments, the process may also include releasing a token assigned to the AUV, transmitting a distress alert to another AUV, receiving a confirmation response from the another AUV, and transmitting the content stored on the AUV to the another AUV and receiving a distress alert at the ground or sea station, transmitting a confirmation response from the ground or sea station, and receiving the content stored on the AUV at the ground or sea station.

In certain embodiments, the one or more AUVs may perform their own distress mitigation operations without ground or sea control operation and/or other AUVs being used to initiate the operations. In certain embodiments, the process may include detecting, via an AUV, a distress event based on one or more indicators, initiating, via the AUV, a mitigation operation, attempting to transmit, via the AUV, one or more communications comprising a distress alert and content stored on the AUV to another device, and performing a data purge, via the AUV, of data stored on the AUV to satisfy the mitigation operation.

In certain embodiments, the AUV may include sensors or an array of sensors, such as temperature, noise, light, vibration, etc., which are placed in strategic locations to track activity remotely by cellular, radio and/or other types of communications linked to the sensors which are battery operated and which may use solar or other ways to generate energy to maintain an active status. In certain embodiments, the sensor data may be periodically sent from any of the sensors to a control station, such as authentication server, an emergency service station, etc. In certain embodiments, the sensor data in one example may indicate a particular vehicle is present at a location detected by sensor where vehicles are not regularly present, such as a national park after hours or private property, etc. In certain embodiments, the authentication server may notify an emergency service center to dispatch one or more AUVs to the areas of interest identified. This approach Permits the AUVs to be dispatched on an as-needed basis without requiring continuous missions being conducted to monitor remote locations,

In an exemplary embodiment, a swarm or group of AUVs (e.g., 10, 100, or 100 AUVs) is assigned a mission to travel in a particular pattern of a body of water over a designated area to identify certain objects of interest (e.g., mines, adversary assets). The result of the mission may include identifying one or more sea objects. The locations of the objects may be identified as well as types of objects and other information. In this example, the objects may be identified from image data and paired with known military grade objects to achieve a particular result, such as a threat level or threshold which may invoke further action.

In certain embodiments, the swarm of AUVs may report the identified objects to a ground or sea station which may perform an artificial intelligence procedure to further investigate the data provided and whether mission updates are necessary to further the original mission objectives. In certain embodiments, a knowledge-base may be stored on the AUVs but preferably may be stored in a remote server or even on the blockchain. In certain embodiments, the data captured can be analyzed based on or more intelligence algorithms which attempt to perform a comparative analysis of the inputted data. Any conclusions can be committed to the blockchain, such as additional objects which are likely to be present within a predefined area of the original objects. This will invoke an additional mission measure to perform additional monitoring for a specific area between the objects as dictated by the intelligence algorithm based on known information. The updated mission data is then sent to the AUVs.

In certain embodiments, the AUVs can perform a modified mission based on the predictions and applied artificial intelligence according to example embodiments. In certain embodiments, the AUVs are dispatched to new mission area defined by the intelligence analysis to locate a likely candidate object. In this example, a number of identified military objects (i.e., adversary assets) would invoke a likely presence of a communication somewhere between the objects in a predefined area. In certain embodiments, the intelligence algorithm could predict any type of candidate object associated with the identified objects and instruct the AUVs to seek additional data content in a predefined area also likely to be the location of such objects as predicted by the intelligence algorithm. In certain embodiments, the new updates may be sent from the AUV to ground station to be further analyzed in a subsequent intelligence analysis procedure, which could yield additional mission updates and further modifications to existing mission objectives. In certain embodiments, the updates can be maintained in the blockchain and may be used with the smart contract data to define a next mission.

In certain embodiments, the AUVs may be monitor an area and perform an intelligence operation to determine another object is likely present and then decide to do additional monitoring or modified monitoring. The known information is used to predict certain results and the smart contract may be updated for a new mission objective once a decision is made regarding the validity of the intelligence analysis.

In an exemplary embodiment, a process may include identifying a likelihood of an object presence at one or more locations within a predefined distance of locations explored by the AUVs during one or more monitoring actions performed by the AUVs during a mission comprising a plurality of mission requirements, selecting one or more new monitoring actions to perform by the AUVs based on the likelihood of the object presence to satisfy the mission requirements, and performing the one or more new monitoring actions by the AUV. In certain embodiments, the one or more monitoring actions may include one or more of communication signal detection and an image capture being performed at the locations explored by the AUVs, or at new locations determined to be relevant to the previous locations of the identified objects, such as within a predefined radius between the objects or adjacent to the one or more objects. The mission requirements include one or more of identifying objects at the locations explored by the AUVs and monitoring communication signals at the locations explored by the AUVs. In certain embodiments, the process may also include identifying the likelihood of an object presence at one or more locations within the predefined distance of the locations explored by the AUVs by performing a comparative analysis of the objects previously identified at the one or more locations with candidate objects which are known to be associated with the objects previously identified, and determining the likelihood of the candidate objects also being present exceeds a threshold based on the comparative analysis. The analysis may yield a percentage of likelihood, such as 85 percent and the threshold for action may be 80 percent indicating the action should be performed based on the likelihood score. In certain embodiments, the process may also include creating an instruction to perform one or more of additional image captures and communication signal monitoring at the locations within a predefined distance of the locations explored by the AUV when the threshold is exceeded. In certain embodiments, the process may also include determining a range of the locations within the predefined distance of the locations explored by the AUVs based on a distance between two or more objects detected during the monitoring of the locations explored by the AUVs, monitoring the locations within the predefined distance of the locations explored by the AUVs for a predefined period of time and performing the additional image captures to identify the candidate objects, and performing an image analysis of the additional image captures to identify the one or more candidate objects. The process may also include updating the mission requirements to include additional monitoring actions including the identified known objects when the candidate objects are identified.

In general, AUVs could only be registered (authorized) for operation by an designated operator. In certain embodiments, the authorized AUVs could only be tasked by an designated operator. Every authorized AUVs should send a live signal (announcing current location and state) at a specified frequency while the AUVs is tasked or operating on a mission. In certain embodiments, the AUV data could be remotely wiped when the AUV is experiencing a distress event (e.g., captured by an unauthorized entity), when a distress signal is sent, when the AUV is unable to send a live signal at a specified frequency, or when the AUV veers out of an authorized geo-location.

In certain embodiments, each AUV may have a unique serial number, an encrypted hardware key, and an encrypted memory store. Each AUV's unique identifier is a software key, which is a combination of a serial number and the encrypted hardware key, each AUV's memory will be programmed to be erased after a set time in case of any distress events encountered. Each AUV may be programmed to send location, status, and any authorized data at set intervals when operating on a task/mission. In certain embodiments, the tasked AUV's memory may be erased within a pre-programmed time following identified distress events.

In certain embodiments, the blockchain (public or private or combination thereof) platform provides an immutable ledger with events that abide by set smart contracts that detail AUV operational rules to ensure secure operation. For example, all serial numbers and encrypted hardware keys may be registered in the blockchain by a designated operator. In certain embodiments, each AUV will be registered by the owner/designee to generate its unique identifier, and only a designated operator could change combinations of serial number and encrypted hardware key to generate a new unique identifier. AUVs can be retired at an end-of-life cycle by the designated operator. In certain embodiments, only a designated operator can task a registered AUV by posting an event linked to the unique identifier in the blockchain. An authorized AUV will acknowledge a task assigned by the designated operator before starting the task. Live signal information (e.g., status, location, and any other authorized data) sent by a tasked AUV may be accompanied by its unique identifier.

In certain embodiments, the blockchain may execute certain operations before posting the live signal and end of task events, verify and validate authenticity of the unique identifier of the AUVs and its task instructions, execute a programmed consensus algorithm to validate and commit the live signal and end of task events information, only the designated operator will be able to alter tasks during middle of task.

In certain embodiments, exemplary AUV attributes may include a AUV serial number, an encrypted hardware key, an encrypted memory. Other network elements of the AUV configuration may include a blockchain with an immutable ledger to post events, smart contracts with AUV operational rules, identity and task validator components, a signal repeater (hub) to facilitate sharing of AUV-hyperledger communications, and an owner/designee that is an authorized user or a system that is allowed to register and task AUVs.

In certain embodiments, the the AUVs may be equipped with advanced sensors and artificial intelligence (AI) capabilities that enables them to autonomously detect and track certain targets that they did not have knowledge of and which are not present in their usual navigation patterns. In certain embodiments, the architecture can be further enhanced to incorporate secure AI model training and deployment by using techniques such as homomorphic encryption to ensure that the AI models and their data remain secure and private even if the AUVs are compromised. One example of this may include creating a new navigation pattern to identify an object which is not previously identified based on the presence of other objects which were identified. For example, a certain type of vehicle may create an artificial intelligence measure that determines there are likely other vehicles of the same type, or a communication station within a predefined distance of the identified vehicle location based on a prior knowledge base.

In certain embodiments, if the AUV is lost or destroyed, the architecture can include mechanisms for remote data purge instructions or destruction of sensitive data and AI models stored on the AUV's hardware. The AUV may enact such measures on its own or by instruction from a ground station or other AUV that is aware of the AUV's current distress.

In certain embodiments, the AI measures used by the AUVs may include convolutional neural networks (CNNs), which are a type of deep learning algorithm commonly used for image and video analysis. In certain embodiments, the AUVs equipped with high-resolution cameras and sensors can use CNNs to identify and classify objects in their environment, such as third party vehicles or even personnel. In certain embodiments, this can help the AUVs to detect and track potential threats, and provide valuable intelligence to alliance entities nearby. In the context of countering cyber or Offensive AUV attacks, CNNs can be used to identify and track incoming adversary assets in real-time. In certain embodiments, this can help personnel to quickly respond to potential threats and deploy defensive measures to neutralize the attack.

In certain embodiments, the AUVs of the invention include recurrent neural networks (RNNs), which are a type of deep learning algorithm that is commonly used for natural language processing and sequential data analysis. In the context of military AUVs of the invention, RNNs can be used for tasks such as speech recognition and language translation. For example, an AUV equipped with an RNN could be used to intercept and analyze enemy communications and provide real-time translations. RNNs can also be used to detect and classify patterns in data, such as the movement patterns of third party assets or the behavior of cyber attackers.

In certain embodiments, generative adversarial networks (GANs) are a type of deep learning algorithm that can also be used for generating synthetic data. In the context of military AUVs of the invention, GANs can be used to generate synthetic images and videos of potential targets, such as third party underwater assets, mines, ships and/or sea vehicles. This can help personnel develop and test strategies for neutralizing these targets without harming allied AUVs or personnel. In certain embodiments, the GANs can also be used for training other AI models, such as CNNs or RNNs. By generating synthetic data that mimics real-world scenarios, GANs can help to improve the accuracy and robustness of these models and ensure that they are able to perform effectively in a variety of different environments and situations, By enabling AUVs to detect and classify potential threats, intercept and analyze third party communications, and generate synthetic data for testing and training, these models can help optimize the effectiveness and safety of sea operations in a variety of different contexts.

In certain embodiments, an intrusion detection system (IDS) may use CNNs to detect cyberattacks on the AUV network, and the output can be used to trigger the revocation and re-allocation of ERC20 tokens. When an intrusion is detected, the monitoring system can trigger the token revocation process that revokes the ERC20 tokens associated with the compromised AUV's wallet or data entries. This ensures that the compromised AUV cannot participate in any communication or transactions in the network, and that the trust level of the network remains high.

In certain embodiments, image recognition may use a neural network, such as ‘ResNet50’ to detect and classify potential threats to the AUV network or allied assets, such as third party AUVs or other hostile activities. The output of the model can be used to trigger the transfer of ERC20 tokens to other trusted AUVs, ensuring that the network is able to respond to threats in a timely and effective manner. In certain embodiments, when an AUV is under distress, the mission will benefit from another AUV taking the distressed AUV's activities. Assignment and reassignment may be dynamic and automated by actions stored in a AUV and/or in a smart contract that defines the actions to take under distress scenarios.

In certain embodiments, during a mission, a path planning algorithm, such as ‘A*’ can be used to plan the optimal sea path for the AUV, considering locations of potential threats and the need to avoid detection. In certain embodiments, the output of the algorithm can be used to trigger the transfer of ERC20 tokens to other trusted AUVs that can assist in the mission, ensuring that the network is able to respond to changing mission requirements. As threats are identified, the AUV's mission operative may be assigned, reassigned, cancelled, postponed, etc. Overall, the use of ERC20 tokens in conjunction with AI models can enhance the security of AUVs by ensuring compromised AUVs are not able to participate in the network, and that the network can respond to threats and changing mission requirements in a timely and effective manner.

In certain embodiments, the types of blockchains may include public, private (permissioned), etc. Also, layer 2 ‘rollups’ may be used to maintain performance requirements when deciding which blockchain technology to use. While public blockchains may be suitable in some cases, layer 2 ‘rollups’ can offer better performance and lower costs and provide a smart contract approach to managing the blockchain transactions and objectives. An abstraction layer may be used for AUV management by creating an abstraction layer that handles all interactions between the AUVs and the blockchain. This layer should manage AUV identity, configuration, and supply chain information, and will permit for secure communication between the AUVs and the blockchain. Standardized APIs may be used for AUV management by interacting with the abstraction layer. These APIs should include functions for registering new AUVs, updating AUV configurations, tracking supply chain information, and verifying AUV identity. Client libraries may implement the standardized APIs for different programming languages and platforms. In certain embodiments, the libraries can be used by AUV manufacturers, operators, and other stakeholders to manage AUVs in a secure and decentralized manner. The abstraction layer may be used for AUV data storage to create another abstraction layer that handles the storage of AUV data on the blockchain. This layer should be responsible for managing the storage and retrieval of AUV data, including telemetry data, logs, and maintenance records.

In certain embodiments, the standardized APIs define standardized APIs for AUV data storage that can be used to interact with the abstraction layer. These APIs may permit for the secure storage and retrieval of AUV data, and should include functions for querying data, adding new data, and verifying the authenticity of stored data. Client libraries may be used to implement the standardized APIs for different programming languages and platforms. These libraries can be used by AUV operators to securely store and retrieve AUV data on the blockchain. In certain embodiments, the operator or an autonomous entity may need to verify one or more identities before accessing any weapon systems on the AUV. A standardized API can be used to activate or deactivate various AUV features such as a camera, a radio transceiver, a microphone, sensors, one or more weapon systems (torpedo/tactical launching, etc.) as well as view logs of previous weapon system activities. In certain embodiments, if the AUVs are communicating over a low earth orbit (LEO) network, such as ‘Starlink’, additional security measures may be necessary to protect the weapon system data as information is propagated through the private network. For example, a security layer for weapon systems should include access controls to ensure that only authorized operators can access the weapon systems. If the AUV is communicating over a LEO network, the security layer should include encryption and data validation to ensure that any weapon systems data is protected. The security layer for weapon systems should include access controls to ensure that only authorized operators can access the weapon systems. If ERC20 is used to authenticate the operator's identity, the security layer may include a mechanism for validating the operator's ERC20 token and verifying that it is associated with their respective public key.

In the case of a particular user operator, the user may need to verify their identity before accessing any navigation data on the AUV. They can then use the standardized API to view the AUV's current location, navigation plan, mission data, and telemetry data. If the AUV is communicating over a LEO network, the operator may need to use additional security measures to protect its navigation data as it transmits through the network. The security layer for navigation may include access controls to ensure that only authorized operators can access the navigation data. If the AUV is communicating over a LEO network, the security layer may include encryption and data validation to ensure that the navigation data is protected.

In certain embodiments, AUV-to-AUV (D2D) communications communication may be used where certain strategic AUVs could be equipped with onboard devices that permit for direct communication to and from other AUVs in a certain proximity. In certain embodiments, the communications could be used to share information, environmental conditions, and/or to coordinate actions, such as platooning where a group of AUVs follows closely behind a lead vehicle. Another approach may be AUV-to-infrastructure (A2I) communication, where AUVs may also communicate with local infrastructure such as ships or submarines. This could permit for a higher level of interaction with the local environment and provide additional data to support autonomous operation. In both those AUV examples, the interactions could be recorded as transactions on a blockchain. This could provide an immutable record of the vehicle's actions and observations, which could be useful for dispute resolution in the event of an accident, verifying the authenticity of sensor data, or tracking the use of shared infrastructure. In certain embodiments, sea vehicles may also communicate to AUVs to provide a dynamic option to a variety of different field devices which are working together to accomplish a common goal(s). The roles, leaders, permissions and mission operatives may be shared from AUV to sea vehicle and all such devices may communicate. In certain embodiments, the sea vehicles may be preferred in certain areas where ground activity is necessary and when travel becomes burdensome, the AUVs may exit the sea vehicles and navigate away to continue the journey and mission operatives. In certain embodiments, the AUVs may be extensions of the sea vehicles and may share a common role or position where one is active and the other is inactive depending on the current situation.

In certain embodiments, the a team of AUVs, for example, may be operating on a mission reconnaissance of an area of sea. In certain embodiments, the system of AUVs may employ an ERC20-based blockchain system to ensure their safety and seamless operation. In certain embodiments, the AUVs may continuously share their location, status, and the environmental conditions with each other. In certain embodiments, if one AUV reports dangerous conditions or an equipment failure, smart contracts can be triggered to adjust the mission plan, potentially assigning tasks previously assigned to one AUV to a second AUV or group of AUVs. In certain embodiments, if an AUV loses communication with one or more of the other AUVs, a blockchain transaction could be automatically generated to trigger a search and rescue operation. In certain embodiments, the other AUVs could be redirected to the last known location, and additional AUV could be deployed from a surface support vessel to assist underwater. In certain embodiments, the AUVs may communicate with one central submarine or sea vessel a device above or below water that is provided the communication point to and from the ledger.

In certain embodiments, the data collected by the AUVs may be timestamped and stored on the blockchain, ensuring the accuracy and integrity of the data. This can be critical for post-mission analysis, especially if an accident or equipment failure occurs.

In certain embodiments, adaptive learning using data models with the AUVs may require a standardized approach to have a full AUV swarm management and signal integration for formation algorithms, dynamic task assignment mechanisms, real-time coordination protocols, and appropriate response strategies for heartbeat anomalies.

In certain embodiments, the configuration may include certain blockchain elements, for example, a group of blockchain member nodes as part of a permissioned blockchain group. In certain embodiments, the permissioned blockchain is not accessible to all parties but only to those members with permissioned access to the blockchain data. In certain embodiments, the blockchain nodes may include one or more nodes. The nodes may participate in a number of activities, such as blockchain entry additions and/or a validation process (consensus). One or more of the blockchain nodes may endorse entries based on an endorsement policy and may provide an ordering service for all blockchain nodes. A blockchain node may initiate a blockchain authentication and attempt to write to a blockchain immutable ledger stored in the blockchain.

In certain embodiments, each time an AUV event occurs, such as registration, status changes, authorization, mission assignment, updated content captures, discoveries, sensor readings by the AUVs or stationary sensor elements, etc., the blockchain transactions are stored in memory of computers associated with the blockchain as the transactions are received and approved by the consensus model dictated by the members nodes. Approved transactions are stored in current blocks of the blockchain and committed to the blockchain via a committal procedure which includes performing a hash of the data contents of the transactions in a current block and referencing a previous hash of a previous block. Within the blockchain may be smart contracts which are configured to define the terms of transaction agreements and actions included in the smart contract executable application code.

In certain embodiments, the information used to create and establish AUV assignments and events may be based on information sharing agreements to include permissions granted to share mission data and other AUV related information with the authorized AUVs and any secure computing devices operating as part of the AUV management system. In certain embodiments, the smart contract information may include the AUV serial number(s), encrypted hardware keys and other information stored in memory, and other information, such as mission data, objectives and other information necessary to command the AUVs including starting and stopping their operation, controlling AUV positions, etc.

In certain embodiments, the blockchain configuration may include one or more applications which are linked to application programming interfaces (APIs) to access and execute stored program/application code (e.g., smart contract executable code, smart contracts, etc.) which can be created according to a customized configuration sought by blockchain participants to maintain status, control assets, and receive external information. This can be deployed as an entry and installed, via appending to the distributed ledger, on all blockchain nodes.

In certain embodiments, the smart contract application code provides a basis for the blockchain transactions by establishing application code which when executed causes the transaction terms and conditions to become active. In certain embodiments, the smart contract, when executed, causes certain approved transactions to be generated, which are then forwarded to the blockchain platform. In certain embodiments, the platform includes a security/authorization, computing devices which execute the transaction management and a storage portion as a memory that stores transactions and smart contracts in the blockchain.

In certain embodiments, the blockchain platform may include various layers of blockchain data, services (e.g., cryptographic trust services, virtual execution environment, etc.), and a physical computer infrastructure that may be used to receive and store new entries and provide access to auditors which are seeking to access data entries. In certain embodiments, the blockchain may provide an interface that provides access to the virtual execution environment necessary to process the program code and engage the physical infrastructure. Cryptographic trust services may be used to verify entries such as asset exchange entries and to keep information private.

In certain embodiments, the blockchain architecture configuration may process and execute program/application code via one or more interfaces exposed, and services provided, by the blockchain platform. As a non-limiting example, smart contracts may be created to execute reminders, updates, and/or other notifications subject to the changes, updates, etc. The smart contracts can themselves be used to identify rules associated with authorization and access requirements and usage of the ledger. For example, the information may include a new entry, which may be processed by one or more processing entities (e.g., virtual machines) included in the blockchain layer. The result may include a decision to reject or approve the transaction based on the criteria defined in the smart contract and/or a consensus of the peers. The physical infrastructure may be utilized to retrieve any of the data or information described herein.

In certain embodiments, the smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. In certain embodiments, the temporary data that is used/generated by the smart contract is held in memory by the supplied execution environment, then deleted once the data needed for the blockchain is identified.

In certain embodiments, the smart contract executable code may include the code interpretation of a smart contract, with additional features. In certain embodiments, the smart contract executable code may be program code deployed on a computing network, where it is executed and validated by chain validators together during a consensus process. The smart contract executable code receives a hash and retrieves from the blockchain a hash associated with the data template created by use of a previously stored feature extractor. If the hashes of the hash identifier and the hash created from the stored identifier template data match, then the smart contract executable code sends an authorization key to the requested service. The smart contract executable code may write to the blockchain data associated with the cryptographic details.

In certain embodiments, the operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

In certain embodiments, the AUV swarms of the invention can perform various functions including, but not limited to, maritime platforms, tactical platforms enabled to exercise various mission sets such as sea denial, escort, survey, logistics, targeted counter abilities, etc.

In certain embodiments, the AUVs will include a tactical platform starts by defining the mission objectives based on the requirements or tasks to be accomplished. These objectives can include, for example, patrolling a specific area, conducting search and rescue operations, monitoring maritime traffic, or any other mission-specific goals.

In certain embodiments, the AUVs collects relevant data from various sources to gain situational awareness. This data can include real-time information on weather conditions, vessel traffic, sensor readings, geographical features, and mission constraints. In certain embodiments, the AUVs analyze this data to understand the current operational environment and identify potential risks or opportunities.

In certain embodiments, the AUVs assesses the availability and capabilities of the assets at its disposal. This includes considering other AUVs in the area, their sensor suites, communication systems, endurance, speed, and any other relevant characteristics. In certain embodiments, the AUVs also takes into account the operational constraints and limitations of each asset.

In certain embodiments, the AUVs include a tactical platform that utilizes optimization algorithms to determine the most effective deployment and utilization of assets. These algorithms consider factors such as asset capabilities, mission objectives, constraints, and operational parameters to generate optimized plans. The plans may include routes, schedules, task assignments, and coordination strategies.

Based on the optimized plans, the tactical platform assigns tasks and allocates resources to the AUVs. It ensures that the assets are efficiently distributed to maximize coverage, minimize response times, and optimize the overall mission performance. This may involve considering factors such as asset proximity to target areas, their current status, and their suitability for specific tasks. In certain embodiments, the tactical platform continuously monitors the operational environment and adapts the assets planning as needed. It can dynamically adjust plans in response to changing conditions, emerging threats, or new mission requirements. This adaptability allows the platform to optimize the allocation of assets in real-time and make informed decisions based on the latest information. In certain embodiments, the tactical platform facilitates communication and coordination among the AUVs and other entities involved in the mission. It establishes communication links, provides real-time updates, and enables collaboration between the assets. This ensures that the assets are synchronized, share relevant information, and work together to achieve the mission objectives effectively.

In certain embodiments, the by combining data analysis, optimization algorithms, and adaptive planning strategies, an autonomous maritime tactical platform can efficiently conduct assets planning for autonomous sea-going vessels. It optimizes the utilization of assets, enhances mission performance, and enables effective decision-making in dynamic maritime environments.

In certain embodiments, based on the AUV's perception and awareness of the environment, the given tasks/objectives, the onboard payloads, the platform continuously assesses the objectives, the effects achieved, and whether or not corrections are needed in its execution. Thereafter corrective measures are implemented and action taken to ensure that the tactical platform fulfills its objectives. For example, the AUVs include a plurality of perception sensors connected to the reactive guidance system including, for example, one or more accelerometers; one or more gyroscopes; one or more compasses; one or more magnetic heading sensors; one or more barometric sensors; one or more multiple one or more GNSs sensors; one or more vision sensors including camera, stereo camera, omni camera, IR cameras; one or more ultra-sonic sensors; one or more laser range finders; one or more Li-DARs; one or more sonars; one or more radars; one or more optical sensors; one or more chemical sensors; and one or more depth sensors. Such type of sensor data using sensor fusion algorithms gives appropriate data. It is referred to as a computational methodology that aims at combining measurement from multiple sensors such that they jointly give more precise information on the measured system than any of the sensors alone.

In certain embodiments, data from such sensor and data from human operator to perform the critical tasks at Remote Control Workstation (RCW) with a human operator. This data can be used for course controlling of the AUVs. Course control includes multiple movements of the AUVs including, but not limited to, roll, pitch, yaw, right, left, port, starboard, altitude gain, altitude decrease, thrust, throttle, gear shift, etc.

With that those data from sensors are used to get feedback from the system in close control loop instead of open loop to monitor control and accept the data from system. As well as current system is platform agnostic which makes it able to work with closed loop as well as open loop system. In open loop system, the data is managed by perception/fusion sensor data management and the decision/control/monitoring/management is completed at Remote Control Workstation (RCW).

In certain embodiments, the AUVs include a self-learning command control unit comprising multiple FRAM and NVRAM memory storage which store the main control code which resides in the directory of the boot controller.

In certain embodiments, the AUV guidance module generates a path for the vehicle towards completing an assigned task to reach the prescribed destination with respect to a home position, by taking feedback from navigational payloads and perception sensors. In certain embodiments, course control module generates commands for AUVs actuators for the assigned task. In certain embodiments, the navigation system deploys deliberative payloads like aeronautical information services (AIS), the environmental scenario/constraints and assessment and correction module for a precision navigation. In certain embodiments, the navigation system uses data from cameras, LIDAR, SONAR, ADSB, besides AIS that provide real time data on which the reactive guidance makes course control (through assessment and correction module for collision avoidance. The perception sensors continue to generate dataset for self-learning in real time with respect to the assigned task, while vehicle guidance model updates dataset in real time.

In certain embodiments, the invention encompasses a system for configuring data for one or more AUVs comprising a server computing devices of a central command system: a mission plan for resilient execution by a swarm of AUVs, wherein one or more of the AUVs in the swarm comprises one or more sensors to capture data in accordance with the mission plan, and wherein the mission plan specifies (1) requirements for fault tolerance or parallelism and (2) a redundancy structure for the swarm corresponding to the requirements; transmitting instructions representing the mission plan to a remote swarm controller device; receiving mission-related data captured by the swarm; and displaying results of the mission plan. In certain embodiments, the central command method may further comprise determining a swarm configuration that specifies a number of AUVs in the swarm, specific types of AUVs to include in the swarm, or specific roles for AUVs in the swarm. In certain embodiments, the central command method may further comprise receiving a request from the remote swarm controller device for replacement of AUVs or an updated mission plan; generating, based on the completion status and the redundancy structure, a determination whether to dispatch one or more replacement AUVs, generate an updated mission plan, or both; and transmitting, based on the determination, a response to the request from the remote swarm controller device. In certain embodiments, the central command method may further comprise assessing completion status of the mission plan based on the received mission-related data, wherein the generating the determination is further based on the completion status. In certain embodiments, the central command method may further comprise detecting a position of each of one or more AUVs in the swarm; calculating a correction for one or more of the AUVs in the swarm; and transmitting, to the remote swarm controller device, information based on the calculated correction to adjust a timing or position of one or more of the AUVs in the swarm. Particular embodiments may provide one or more computer-readable non-transitory storage media embodying software comprising instructions operable when executed by one or more server computing devices to perform the steps of the central command method. In certain embodiments, a system comprising one or more server computing devices, each of the server computing devices comprising one or more processors and a memory coupled to the processors comprising instructions executable by the processors, the processors being operable when executing the instructions to perform the steps of the central command method.

In certain embodiments, an AUV swarm controller device comprises receiving, from a central command system, a mission plan for resilient execution by a swarm of AUVs, wherein one or more of the AUVs in the swarm comprises one or more sensors to capture data in accordance with the mission plan, and wherein the mission plan specifies (1) requirements for fault tolerance or parallelism and (2) a redundancy structure for the swarm corresponding to the requirements; determining a swarm configuration based on the mission plan and a set of available AUVs and capabilities of the available AUVs, wherein the swarm configuration includes a number of the available AUVs in accordance with the specified redundancy structure; transmitting instructions corresponding to the swarm configuration and information related to the mission plan to dispatch a plurality of the available AUVs as a resilient swarm; after dispatch, receiving status information from the AUVs in the resilient swarm during execution of the mission plan; receiving sensor data captured by one or more sensors of the resilient swarm; and transmitting, to the central command system, mission-related data generated based on the sensor data or the status information. In certain embodiments, the swarm system may further comprise transmitting information to synchronize the AUVs in the resilient swarm. In certain embodiments, the swarm method may further comprise merging the mission-related data captured by each of the AUVs in the resilient swarm into a single dataset. In certain embodiments, the swarm method may further comprise detecting a fault involving one or more of the AUVs in the resilient swarm; and either: transmitting reconfiguration instructions to the AUVs in the resilient swarm; transmitting instructions to one or more of the available AUVs not included in the resilient swarm to join the resilient swarm; or transmitting a request to a central command system for replacement AUVs or an updated mission plan. In certain embodiments, one or more computer-readable non-transitory storage media embodying software comprising instructions operable when executed by a AUV swarm to perform the steps of the method. Particular embodiments may provide a AUV swarm comprising one or more processors and a memory coupled to the processors comprising instructions executable by the processors, the processors being operable when executing the instructions to perform the steps of the swarm controller method.

In certain embodiments, a plurality of AUVs in a resilient swarm receive from a AUV swarm controller device, dispatch instructions corresponding to a swarm configuration and information related to a mission plan for resilient execution by the AUVs, wherein one or more of the AUVs comprises one or more sensors to capture data in accordance with the mission plan, and wherein the mission plan specifies (1) requirements for fault tolerance or parallelism and (2) a redundancy structure for the resilient swarm corresponding to the requirements; determining, by each of the AUVs and based on the dispatch instructions, a role of the AUV in the resilient swarm based on the swarm configuration and the specified redundancy structure; commencing, by the resilient swarm, execution of the mission plan; and during execution of the mission plan: sensing, by each of the AUVs, a relative position of the AUV with respect to other AUVs in the resilient swarm; transmitting, by each of the AUVs in the resilient swarm and to the AUV swarm controller device, status information regarding the AUV; capturing, by one or more sensors of one or more of the AUVs in the resilient swarm, sensor data; and transmitting, by the resilient swarm, mission-related data generated based on the sensor data or the status information. In certain embodiments, the mission execution method may further comprise exchanging, with the other AUVs in the resilient swarm, information to calibrate the AUVs in the resilient swarm. In certain embodiments, the mission execution method may further comprise detecting that another AUV in the resilient swarm is absent or out of position; and in response to detecting, transmitting a notification to the AUV swarm controller device identifying the other AUV. In certain embodiments, the mission execution method may further comprise receiving, by the resilient swarm and from the AUV swarm controller device, correction information of one or more of the AUVs in the resilient swarm; and spatiotemporally adjusting one or more of the AUVs in the resilient swarm. The mission-related data may be transmitted from the resilient swarm directly to the central command system or to the AUV swarm controller device. In certain embodiments, one or more computer-readable non-transitory storage media embodying software comprising instructions operable when executed by a AUV swarm controller device to perform the steps of the mission execution method. Particular embodiments may provide a AUV swarm controller device comprising one or more processors and a memory coupled to the processors comprising instructions executable by the processors, the processors being operable when executing the instructions to perform the steps of the mission execution method.

In certain embodiments, the invention encompasses a fleet of AUVs incorporating a laser-based communications system, the system comprising: an acquisition module configured to acquire and characterize a plurality of laser beams; a tracking module configured to track the acquired laser beam, the tracking module comprising: a beacon feedback and beam divergence mechanism configured to control the beam and detect the beam; an adaptive learning unit configured to implement an adaptive learning detection algorithm to identify and track a unique optical signature from at least one of the acquired laser beams; and an aiming module configured to aim at least one laser beam at a target based on the acquired laser beam.

In certain embodiments, the acquisition module may include: an optical fiber coupling mechanism for coupling the acquired laser beam to an optical fiber system; and a laser beam characterization unit configured to extract specific information from at least one of the acquired laser beams.

In certain embodiments, the tracking module comprises a position diversity unit configured to select at least one of the acquired laser beams based on at least one of: reliability of the beam, capacity of the beam, spatial characteristics of the beam and/or temporal characteristics of the beam.

In certain embodiments, the laser beam characterization unit includes an interferometry and calculation system configured to extract specific information.

In certain embodiments, the specific information includes at least one of a temporal identifier, a spatial identifier, and/or a spectral identifier.

In certain embodiments, the fiber coupling mechanism includes a tapered fiber coupler configured to increase the surface size of the core.

In certain embodiments, the targeting module includes a multi-stage beam steering unit configured to steer at least one laser beam to a target based on the acquired laser beam.

In certain embodiments, the multi-stage beam steering unit is configured to change one or more optical characteristics thereof so as to steer at least one laser beam to a target based on the acquired laser beam.

In certain embodiments, the changing the optical characteristics of the multi-stage beam steering unit includes one or more of the following steps: inducing a Pockels effect on the light beam by applying an electric field; tuning the spatial light modulator; tuning the metamaterial structure; inducing a diffraction grating; and correcting the output angle of the light beam.

In certain embodiments, the beacon feedback and beam divergence mechanism is configured to detect the beam of light without performing the following steps in a particular order: receiving a command to connect to a node; checking whether the transmit power is above a threshold; calculating a position vector relative to the node; calculating a spatial uncertainty function based on the position vector; and adjusting the beam divergence with respect to the spatial uncertainty.

In certain embodiments, adjusting the beam divergence includes covering the uncertainty region such that θ>α×σ max Where θ includes the applied beam divergence, α includes the diffraction-limited beam divergence, and σ max Including uncertainty factors.

In certain embodiments, selecting at least one of the acquired laser beams includes the following steps, not in a particular order: identifying a plurality of beacon signals; comparing information received from the beacon signal to an array of information profiles; removing decoys from the plurality of beacon signals; determining and selecting an optimal beacon signal from a plurality of beacon signals; and after the false target is removed, the processed data array is sent to the self-adaptive learning detection algorithm.

In certain embodiments, the adaptive learning detection algorithm is further configured to remove decoys.

In certain embodiments, the adaptive learning unit comprises an adaptive neural network configured to extract the relative position of the beacons at the sub-pixel resolution.

In certain embodiments, the step of inducing a diffraction grating is caused by at least one of acoustic waves and/or holographic material.

In another embodiment, AUV swarm includes a laser system based communication method, the method comprising: acquiring and characterizing a plurality of laser beams by an acquisition module; tracking the acquired laser beam by a tracking module; controlling the light beam and detecting the light beam by a beacon feedback and beam dispersion mechanism; implementing an adaptive learning detection algorithm by an adaptive learning unit to identify and track unique optical signatures from at least one of the acquired laser beams; and aiming, by an aiming module, at least one laser beam at a target based on the acquired laser beam.

In certain embodiments, the method may further comprise: coupling the acquired laser beam to an optical fiber system through an optical fiber coupling mechanism; and extracting, by the laser beam characterization unit, the specific information from at least one of the acquired laser beams.

In certain embodiments, the method may further comprise selecting, by the position diversity unit, at least one of the acquired laser beams based on at least one of: reliability of the beam, capacity of the beam, spatial characteristics of the beam and/or temporal characteristics of the beam.

In certain embodiments, the method may further include extracting the specific information by an interferometry and computing system.

In certain embodiments, the method may further comprise increasing the surface size of the core by a tapered fiber coupler.

In certain embodiments, the method may further comprise steering, by a multi-stage beam steering unit, at least one laser beam to the target based on the acquired laser beam.

In certain embodiments, the method further comprises changing one or more optical characteristics of the multi-stage beam steering unit to steer at least one laser beam to the target based on the acquired laser beam.

In certain embodiments, the step of changing the optical characteristics of the multi-stage beam steering unit comprises: inducing a Pockels effect on the light beam by applying an electric field; tuning the spatial light modulator; tuning the metamaterial structure; inducing a diffraction grating; and correcting the output angle of the light beam.

In certain embodiments, the step of detecting the light beam comprises: receiving a command to connect to a node; checking whether the transmit power is above a threshold; calculating a position vector relative to the node; calculating a spatial uncertainty function based on the position vector; and adjusting the beam divergence with respect to the spatial uncertainty.

In certain embodiments, the step of adjusting the beam divergence includes covering the uncertainty region such that θ>α×σ max Wherein θ includes the applied light beamDispersion, alpha comprises diffraction limited beam divergence, and sigma max Including uncertainty factors.

In certain embodiments, the of selecting at least one of the acquired laser beams comprises: identifying a plurality of beacon signals; comparing information received from the beacon signal to an array of information profiles; removing decoys from the plurality of beacon signals; determining and selecting an optimal beacon signal from a plurality of beacon signals; and after the false target is removed, the processed data array is sent to the self-adaptive learning detection algorithm.

In certain embodiments, the method further comprises removing decoys by an adaptive learning detection algorithm.

In certain embodiments, the method further comprises extracting the relative position of the beacons at sub-pixel resolution through an adaptive neural network.

In certain embodiments, the AUVs of the invention incorporate an optical-based device that may allow a static or dynamic system of nodes to accurately find, aim, and align with each other while actively tracking and maintaining alignment. Embodiments of the present application may provide an optimized, efficient method that may allow maximum energy and data transfer between multiple nodes in as little time as possible, while taking into account random fluctuations or disturbances that may occur in or between the multiple nodes themselves, such as atmospheric effects or jitter of the multiple nodes themselves.

Embodiments of the application may also be disclosed as follows: an aiming and beam steering system comprised of a multi-stage beam steering mechanism with a non-mechanical fine tuning system; free space to fiber photon coupling waveguide; a reconfigurable closed-loop beacon feedback system based on bidirectional laser, which consists of a) a self-adaptive beacon beam divergence adjusting mechanism and b) a method for detecting a beacon by utilizing beam space, time and spectrum data; dynamic site diversity using real-time multiple-Input multiple-Output (MIMO) beam detection and channel quality sensing; an acquisition method based on deep learning; tracking and sub-pixel resolution detection algorithms; a method for interferometry analysis of extracting beam features from a beacon signal; and an integrated space and atmosphere photon simulation test bed.

Embodiments of the application may be applied to several industries, such as aerospace and the national defense industry.

In certain embodiments, the invention incorporates high-speed communications. In certain embodiments, the system includes a signal conditioning module, an attitude detection and control module (attitude detection and control module, ADCS), and a free space optics (free space optics, FSO) module. In certain embodiments, the signal conditioning module may include a laser light source (or data) coupled to an active temperature control unit configured to provide thermal stability of the output laser signal. In certain embodiments, the output laser beam may be modulated by an Electro-optical (EO) modulation scheme, and the EO modulation scheme may be connected to a plurality of data interface units (not shown in the drawing) via built-in microwave circuits. EO modulation scheme may be configured to optimize power efficiency while the output signal (or output laser beam) may be transmitted to Free Space Optical (FSO) module via filtering unit and final amplifying unit to achieve the desired output power.

Current satellites typically have their own ADCS module, but most current systems are not capable of meeting the stringent requirements required for high throughput and low SWAP (Size Weight and Power consumption) laser communication systems. The AUVs of the invention include an ADCS module that includes specially developed algorithms capable of achieving this capacity, i.e., a high throughput and low SWAP laser communication system, as described below.

In certain embodiments, the ADCS module may first detect the precise pose and position of the satellite via at least four detection signals. In certain embodiments, the ADCS module may include a built-in advanced inertial measurement chip (Inertial Measurement Chip, IMU). The ADCS module may be configured to provide initial data to the heading tracking unit to aim the satellite at the target ground station. Subsequently, the on-board orthogonal photodiode and focal plane array in the ADCS module may be configured to receive laser steering signals from a ground station. In another embodiment, an optical signal detector (e.g., a camera chip) in the ADCS module may also be configured to receive the laser guidance signal from the ground station. The fine correction vector of the ADCS module may be configured to use this data to calculate a final signal and feed it to the fine beam steering unit. In certain embodiments, the ADCS module may also include a backup low-speed Radio Frequency (RF) signal configured for emergency command and control operations. Alternatively, a complementary mixed signal solution with a maximum power ratio combination or other form of mixed solution may also be configured for emergency command and control operations.

In certain embodiments, the AUVs include a plurality of algorithms in a system, which may include, but are not limited to: 1) A plurality of custom heuristic center-coding algorithms coupled with the adaptive learning neural network may be configured to achieve sub-pixel resolution. The plurality of custom algorithms may be configured to provide feedback in a closed loop laser adaptive beacon control system; 2) A method of beam correction using a plurality of software and hardware adaptive optics algorithms; and 3) a variety of adaptive positioning and predictive heading tracking algorithms.

In certain embodiments, the free-space optical module may be configured to receive the output signal (or output laser beam) from the signal conditioning module and may be configured to transmit the output signal into the diffraction-limited, precisely aligned collimation unit. In certain embodiments, the collimated light beam may be sent to a beam compensation unit and ultimately to a fine beam steering unit, the beam compensation unit may be configured to correct for atmospheric effects using information collected by the ADCS module, and the fine beam steering unit may be configured to receive a plurality of data correction vectors from the ADCS module. In certain embodiments, the resulting beam corrected laser communication link will be transmitted from the fine beam steering unit to a plurality of ground stations. The free-space optical module may also be configured to receive a plurality of incident light beams and transmit them to a communication acquisition unit via an adaptive optics unit.

In certain embodiments, the system may also include a field-programmable gate array (FPGA) and a plurality of existing astronomical station networks such that the base station apparatus as described above may be used to improve the light output from the telescope of the existing astronomical station networks. This may be beneficial because (a) there are approximately fifteen instant ground station networks worldwide that can provide full coverage; and (b) wastes little time, money and effort in selecting the appropriate location, renting the land and building a new telescope.

In certain embodiments, the invention includes an AUV for receiving a command to initiate data or power transfer. In certain embodiments, the method includes determining satellite positions using inertial measurement units, global positioning systems (global positioning system, GPS), and other sensors. In certain embodiments, the method includes receiving updated partner system beacon centroid offset data from the focal plane array system. In certain embodiments, the method includes initiating a first acquisition of a partner system laser beacon using a plurality of wide-of-view (FOV) sensors. In certain embodiments, the method includes directing a coarse correction cradle head system to aim within a first field of view (FOV) accuracy of a partner beacon. In certain embodiments, the method includes reading updated partner system center centroid set data from the focal plane array system. In certain embodiments, the method includes determining whether a fine control increment is required to accurately aim the data beam. In certain embodiments, the method includes performing fine angle adjustment using a mechanical or non-mechanical beam steering method that corrects for one tenth of a beam width or step size less or greater. In certain embodiments, the method includes repeating the above steps until the focal plane array system determines that there is zero deviation from the center of the data beam. In certain embodiments, the focal plane array system determines that there is a non-zero deviation from center. In certain embodiments, the method includes activating the data or power transfer beam to carry the encoded data to the partner node. In certain embodiments, the method includes determining that all data or power has been transmitted.

In certain embodiments, the AUV swarm laser targeting, acquisition and tracking system may be configured to derive the precise location of sister nodes within very stringent requirements for their size, weight and power parameters so that specific targeting and pose detection accuracy may be achieved within highly dynamic thermal, vibration and radiation environments. In certain embodiments, the targeting, acquisition, and tracking system may include a feedback sensor, a fine steering and lead targeting module (or tracking module), an optoelectronic module, a coarse targeting and gesture detection module (or targeting module), an acquisition module, and a communication module. In certain embodiments, the fine steering and look-ahead targeting module (or tracking module) may include correction vectors with micro-arc accuracy, while the acquisition module may include a focal plane array, orthogonal avalanche photodiodes, or other forms of photosensor array. In certain embodiments, the acquisition module may also be configured to acquire and characterize a plurality of laser beams, while the fine steering and look-ahead module (or tracking module) may be configured to track the plurality of laser beams. In certain embodiments, the focal plane array, along with the orthogonal avalanche photodiodes, may be configured to assist the targeting, acquisition and tracking system in fine tuning during pose detection.

In certain embodiments, the AUV communication module may also include avalanche photodiodes (avalanche photodiode, APD), balanced APD, or APD arrays, which are high sensitivity photodiodes that operate at high speed and high gain by applying a reverse bias voltage. Such APDs are widely used in optical rangefinders, spatial light transmission and scintillation detectors. In certain embodiments, the coarse targeting and pose detection module (or targeting module) may include an Inertial Measurement Unit (IMU), an earth/sun tracker, and rf/mm wave signals to supplement data transmission.

In certain embodiments, the targeting module may be part of the tracking module may be configured to target at least one laser beam based on the acquired laser beam. Alternatively, the targeting module may be a stand-alone module. In certain embodiments, the targeting module may also include multiple stages of beam steering units, where each stage of the system provides a specific range and resolution for the beam steering mechanism. In certain embodiments, the multi-stage beam steering unit may be further configured to steer at least one laser beam to the target based on the acquired laser beam. In certain embodiments, the targeting module includes three tuning stages. Depending on the application, more or fewer tuning stage stages may be applied. In certain embodiments, a stage 1 driver is used to make coarse adjustments to the beam in order to align the beam position over a wide range. In certain embodiments, in stage 2, the beam is trimmed with a stage 2 driver by a piezoelectric microelectromechanical system (Micro-Electro-Mechanical systems, MEMS) or other mechanical/non-mechanical beam steering technique (e.g., spatial light modulator or Electro-optic element). In certain embodiments, in stage 3, ultra fine tuning is applied. An example application of phase 3 would be to extract additional information about the beam for tracking purposes. For example, a temporal/spatial modifier (temporal/spatial modifier) may be used that uses a fast fine targeting mechanism (mechanical or non-mechanical) to generate a fast scanning beam of a very fast “rotating” beam, allowing the system to extract additional space time data from the system and use it as a laser beam tracking mechanism. In certain embodiments, the component may also apply an angle of advance aiming if desired. This can also be achieved using the techniques mentioned for stage 2. This additional data may be used in the interferometric computing unit for further intelligent and adaptive decisions on the system.

In certain embodiments, the beam undergoes non-mechanical fine tuning at stage 3. In certain embodiments, a non-mechanical trimming method may include changing one or more optical characteristics (e.g., refractive index/dielectric constant) of the multi-stage beam steering unit to steer at least one laser beam to the target based on the acquired laser beam. Changing one or more optical characteristics of the multi-stage beam steering unit may include the steps of: a) A birefringent crystal material by applying an electric field and inducing a Pockels effect (Pockels effect); b) Tuning the spatial light modulator; c) A periodic metamaterial structure is adopted, and tuning is carried out through shielding voltage; d) Inducing a diffraction grating on the crystal structure using sound waves and/or holographic material, and e) correcting the output angle by correcting the frequency of the acoustic actuator. The non-mechanical trimming method may include a collimated beam that may be focused onto the integrated light panel, which may reduce the overall physical interaction size required. This may advantageously allow for a smaller amount of voltage and energy to be required in the design of the targeting module, resulting in a low power trimming mechanism. The different mechanisms disclosed may be integrated and may produce high speed micro-radians or nanoradians of deviation in the beam. The fine tuning mechanism may be coupled to an internal feedback system. The output power may be used as a feedback signal that may be communicated to the trim controller by moving the input beacon along the optical path. The trim controller may be configured to operate the trim system to achieve maximum input power using a plurality of signals generated by a focal plane array of acquisition modules or Complementary Metal Oxide Semiconductor (CMOS). The input power may be used as a feedback signal in a neural network algorithm.

In certain embodiments, to create an all-silicon integrated solution and reduce the overall SWAP (Size Weight and Power consumption, size, weight, and power consumption) parameters, the input beam in a typical system can be connected to a fiber-based unit. This requires precise focusing of the input signal onto the core of the fiber optic waveguide. For single or even multimode waveguides, the core of the fiber waveguide is typically an order of magnitude smaller than the surface of the photodetector, imposing unnecessary stringent alignment requirements on the system. Even very slight misalignments can result in most of the focused energy being misaligned with the fiber core and lost to the surrounding environment. As a result, most current systems avoid this problem by focusing the light directly onto the surface of the light detector. Such designs limit the system for high speed communications in geometry, design, and result in bulky components.

In certain embodiments, a fiber photon-coupled waveguide (or mechanism) may include a unique tapered fiber coupler that acts as a photonic taper and may effectively increase the effective surface size of the input fiber core by orders of magnitude. Such a design may allow for efficient coupling of light into the optical fiber and may enhance the robustness of the coupling mechanism. In certain embodiments, the unique tapered fiber coupler may also be less sensitive to beam deviation and may be configured to utilize integrated silicon photonics solutions. In certain embodiments, the structure of the claimed tapered fiber coupler can be created by using tapered graded index input covers with multilayer dielectric/metal/graphene coatings that optimize reflection and diffraction characteristics.

In certain embodiments, a bi-directional laser beacon system may be configured to receive fine tuning attitude information. In certain embodiments, the laser beacon system may include a beacon feedback and beam divergence mechanism that may be configured to control and detect the beam, allowing each node to acquire their relative pose with respect to each other with a slight arc accuracy. Each communication node in the system will transmit a beacon signal that may enable it to broadcast its unique identifier and location to other nodes in the system. In certain embodiments, the physical wavelength selection of the beacon is 800-850 nm. In certain embodiments, to optimize between meters and may provide advantages with maximum CMOS sensitivity, minimum background radiation, minimum atmospheric loss, and availability of high power sources. In certain embodiments, the beacon may have adjustable beam divergence allowing it to adjust the overall illumination size of the receiving node. In certain embodiments, the AUV includes an adaptive beacon beam divergence for a laser beacon system for high speed communications. In certain embodiments, the system receives a command to connect to a node (e.g., node X). In certain embodiments, the system determines whether the transmit power meets a threshold. If it is determined that the threshold is met, the system initiates a data transfer. If it is determined that the transmit power does not meet the threshold, the system calculates a position vector relative to the node. In certain embodiments, the system calculates a spatial uncertainty function. In certain embodiments, the system adjusts the beam divergence to cover the uncertainty region such that θ>α×σ max Where θ represents the applied beam divergence, α represents the diffraction-limited beam divergence, and σ max Representing the uncertainty factor. In certain embodiments, the system receives a feedback beacon signal from another node.

In certain embodiments, the beacon signal may be modulated with a unique identifier, allowing the acquisition system to identify it in various noise, turbulence, and fast and slow moving background information. More specifically, at least one of the acquired laser beams may be selected by extracting specific information from the acquired laser beams. This can be achieved by beam detection using specific information of the beam, such as beam space, time and spectral data. In certain embodiments, the method includes receiving information from a focal plane array/complementary metal oxide semiconductor/charge coupled device/beacon sensor. In certain embodiments, the method includes identifying all potential beacon signals. In certain embodiments, the method includes extracting temporal, spatial, and spectral identifiers. In an alternative embodiment, the method may include extracting at least one of a temporal identifier, a spatial identifier, and/or a spectral identifier. In certain embodiments, the method includes comparing the information to a beacon information profile array from the profile of the previous number. In certain embodiments, the method includes identifying and removing a plurality of explicit decoys. In certain embodiments, the method includes calculating an adaptive background temporal/spatial noise function. In certain embodiments, the method includes preprocessing the data array. In certain embodiments, the method includes transferring the processed data array to a neural network or adaptive learning detection algorithm after removing the plurality of distinct decoys. In one embodiment, the adaptive learning detection algorithm may be configured to remove a plurality of explicit decoys. In certain embodiments, the method may further comprise determining and selecting an optimal beacon signal (not shown) from a plurality of beacon signals.

In certain embodiments, the acquisition module may be configured to continuously receive a plurality of beacon signals from its surrounding nodes. In certain embodiments, the acquisition module may consider the total channel quality for communications and optical power transmissions between each of these nodes and prioritize and rank them based on highest reliability and capacity and direct the controller to use that particular node. In certain embodiments, the acquisition module may also prioritize based on spatial and/or temporal characteristics of the acquired laser beams (or beacon signals). If the quality of the channel is deteriorating, the acquisition module may automatically re-prioritize the rating system, allowing the controller to switch the link to the new highest ranked channel. In addition, the ordering information is used to estimate the information/power capacity of the channel. In certain embodiments, the optoelectronic module uses adaptive coding and Modulation (MODCOD) to modify its transmission rate based on this estimate, allowing the transceiver to be configured to maximize channel capacity. This mechanism may also enable predictive feedback link acquisition in milliseconds to allow automatic switching and handover between multiple nodes in the same window with minimal possible downtime. In certain embodiments, the tracking module (or fine steering and look-ahead module) may include a position diversity unit configured to select the acquired laser beam based on at least one of: reliability of the light beam; capacity of the beam; spatial characteristics of the light beam and/or temporal characteristics of the light beam.

In certain embodiments, the the technique may include multiple acquisition units (or modules) in multiple nodes that acquire the beam. Laser guided star and luck algorithms or other adaptive optics methods may be combined with spatial diversity techniques to enhance signal reception and transmission. This may include optimizing the spatio-temporal profile before the beam phase to ensure the beam. Advantageously, this may ensure that the beam is not destructively disturbed when focused. In addition, a bandpass filter may be included to filter out background noise. Furthermore, ultrasensitive photon counting methods using balanced or unbalanced avalanche photon detectors can be used to detect data on a beam. The above technique can optimize specialized diversity such that the beam acquisition availability is greater than 99%. Other maximum ratio combining and techniques may also be included to maximize the final output by sensing the signal-to-noise ratio of each collected signal and combining them at a ratio and further maximizing the power diversity effect. The final received power may be combined in a coherent or incoherent manner. These techniques may advantageously combine and multiple beam paths and may allow for smaller and more robust ground stations.

In certain embodiments, the method includes receiving information from at least one of a focal plane array, a complementary metal oxide semiconductor sensor, a charge coupled device, and a beacon sensor. In certain embodiments, the method includes extracting beacon locations, link distances, power loss, turbulence, and/or data priority. In certain embodiments, the method includes calculating a communication channel capacity. In certain embodiments, the method includes calculating a realignment cost function. In certain embodiments, the method includes calculating a turbulence risk factor. In certain embodiments, the method includes calculating a beacon priority function. In certain embodiments, the method includes reassigning priorities to the plurality of communication channels. In certain embodiments, the method includes communicating the plurality of beacon priority and location data to the controller.

In certain embodiments, the acquisition, tracking and sub-pixel resolution detection algorithms based on adaptive learning are included. A number of computer vision algorithms may perform HSV extraction, filtering, blob detection, and subsequent Hough transform and object detection using heuristic driving methods. In certain embodiments, the method can realize statistical accuracy, and the statistical accuracy can be improved by orders of magnitude by using a self-adaptive learning driving method. Fast recursive adaptive neural networks such as regional convolutional neural networks (Regional Convolutional Neural Network, R-CNN) or long-short term storage networks (Long Short Term Memory network, LSTM) may include adaptive learning detection algorithms that have been trained to extract, identify and track unique optical signatures in background images, which may lead to high levels of accuracy, reliability, repeatability, and execution speed. The adaptive neural network may be part of an adaptive learning unit and when fully trained using enhanced learning, may understand the intensity distribution of beacon spots over a set of adjacent pixels within a frame image obtained from a focal plane array or similar imaging sensor array. Any offset in intensity allows the adaptive learning detection algorithm to track the movement (or position) of the node relative to the beacon at the sub-pixel level resolution. The above information provided to the controller system by the adaptive learning system (or adaptive learning unit) allows the controller system of the node to calculate the correction vector and provide control signals to realign the parent system with the incoming beacon.

In certain embodiments, the AUVs of the invention includes a system and method for adaptive learning based acquisition, tracking and sub-pixel resolution detection algorithms for high speed communications, according to an example embodiment. In certain embodiments, the method includes receiving a command to intelligently acquire a beacon, track its provenance, and its relative movement. In certain embodiments, the method includes receiving a latest snapshot image frame from a focal plane array containing focused beacon light. In certain embodiments, the method includes running a fast homing neural network (e.g., R-CNN or LTSM) to extract the relative position of the beacons at sub-pixel resolution. In certain embodiments, the method includes obtaining a relative position of the beacon with respect to surrounding objects in the frame. In certain embodiments, the method includes storing beacon location data in a beacon information array. In certain embodiments, the method includes communicating the beacon information array to an aiming and realignment controller. In certain embodiments, the method includes calculating, by the controller, a heading correction vector for the control system. In certain embodiments, the method includes realigning the free-space optical system by the controller.

In certain embodiments, the AUVs of the invention include a system for high-speed communications that may include interferometric analysis for extracting beam features from a beacon signal. In certain embodiments, when an incoming beacon signal is aimed directly onto a focal plane array (focal plane array, FPA) or Complementary Metal Oxide Semiconductor (CMOS) sensing array, it only reveals information about the amplitude distribution before the phase of the beacon signal. To extract more accurate information (or specific information) on the beacon beam, such as phase distribution on the front of the beam, beam divergence angle, polarization, relative input angle, spectral shift, and doppler information, interferometry and computing systems are placed in the beam path that systematically interfere the beacon and its reflection together onto the FPA/CMOS beacon sensor. In certain embodiments, the interferometry and calculation system may be part of the laser beam characterization unit of the acquisition module and may extract specific information from the beacon, such as information related to amplitude and phase. This information is fed into an image processing algorithm that extracts the spot size, interference area, fringe angle, and distance between fringe depth and minimum, and uses them to calculate the relevant characteristics of the beam. This interferometry method can be applied using various forms of optical components to produce a particular phase interference pattern, for example, mixing light having different focal lengths, focusing the light into multiple foci (similar to a microlens array) or more custom optical modifiers. In certain embodiments, the optical elements implementing these patterns may be liquid crystal arrays or spatial light modulators capable of changing the patterns in real time.

In certain embodiments, the interferometric acquisition/transmission system may include a feedback sensor, a fine steering and look-ahead module, an optoelectronic module, an interferometry module, a beacon detector, and a communication module. In certain embodiments, the fine steering and look-ahead module may include a correction vector with micro-arc accuracy, while the communication module may also include Avalanche Photodiodes (APDs) that are high sensitivity photodiodes operating at high speed and high gain by applying a reverse bias. Such APDs are widely used in optical rangefinders, spatial light transmission and scintillation detectors. In certain embodiments, the beacon detector may include an imaging array such as a FPA/CMOS sensor so that beam characteristics may be acquired as in an image/video. An example of such an image of the beam characteristics is shown as a grid in the figure. In the grid, “a” represents the beam size, “b” represents the beam overlap, “c” represents the fringe peak distance, “d” represents the fringe minimum distance, and “e” represents the fringe angle. In certain embodiments, the above description illustrates example components that may be extracted from a captured image/video. In certain embodiments, the interferometry unit may be applied to both the incoming and outgoing beams with similar functionality as an adaptive optics unit, ensuring that both transmit and receive power are optimized for transmission through the atmosphere. In certain embodiments, the interferometry unit may be implemented using a spatial light modulator or a liquid crystal array or other form of active or passive optical element that can modify the beam profile.

In certain embodiments, the AUVs of the invention include a system for high-speed communications that may include an integrated space and atmospheric photon simulation test stand that may fully simulate influences from ground stations, atmosphere, and space environments in a single test unit. In certain embodiments, a photonic spatial simulation system for high-speed communications may include a ground station, an atmospheric effect unit, a spatial effect unit, an optical bench, and a bus. In certain embodiments, the bus may be connected to a thermal control unit, a pressure control unit, and a calculation and display unit (such as a PC as shown in the figure). In certain embodiments, the spatial effect unit may include a laser communication module and a vibration server unit connected to the bus. In certain embodiments, the atmospheric effect unit may include a rotating lens group, variable attenuator and/or rain/fog/snow simulator with various phase profiles, while the ground station may include a laser transceiver and nano-actuator to simulate the ground station unit.

In certain embodiments, the AUVs include a single-base laser communication module that may be used in the photon space simulation system or in any other laser communication device. In certain embodiments, the module may include a transmitter and receiver, a beacon detector, a laser unit, and/or a laser diode. In certain embodiments, the module may also include an optical train of various lenses, mirrors and dichroic mirrors, allowing biaxial (θ x And theta y) . At least one adjustable optical element that controls the beam and other higher order fluctuations in the beam profile, at least one long-pass dichroic mirror having a wavelength a, at least one long-pass dichroic mirror having a predetermined wavelength (e.g., 650-800 nanometers), at least one optical splitter having a predetermined wavelength (e.g., 650 nanometers) and a coating (e.g., 850 nanometers), and at least one bandpass filter coupled to the beacon detector. In certain embodiments, the emitter or receiver end may be connected to a fixed plano-convex lens having a predetermined focal length (e.g., 50 mm) and having a coating (e.g., 1310 nm to 1550 nm). In certain embodiments, the other end of the fixed plano-convex lens may be connected to at least one long-pass dichroic mirror having a wavelength of λ1. In certain embodiments, the laser diode may be connected to a standard or planar lens system and the other end to at least one long-pass dichroic mirror having a wavelength of 2 to 3. The bandpass filter is in the optical path with the beacon detector at one end and the optical splitter at the other end.

In certain embodiments, the operation of the laser communication module includes generating a light beam by a laser source passed through a tunable lens system. It then passes through the optical train and is combined and aligned with all other beams, and there is a final input/output aperture. Meanwhile, the system may include a visible laser unit that generates a visible laser beam that also passes through the optical train and is integrated with the beams. This beam, which is combined with the transmission (Tx) beam and the beacon beam, all passes through the same optical path, although it leaves the device as a single aperture. The same aperture is used to input multiple beams within a cell. Once received, it may be split into two or more beams by a beam splitter and/or dichroic mirror, and according to its wavelength, angle of arrival or power parameters. A portion of the split beam may be received by the beacon detector via a bandpass filter. Another portion of the split beam is received by a long-pass dichroic mirror of wavelength λ1 and reaches a receiver (Rx). All input and output beams are integrated and aligned within the optical path and pass through a single aperture. The tunable mirror and optical system can uniformly condition all incident and outgoing beams.

In certain embodiments, a laser data or power delivery network layout using a single-base laser communication module. In certain embodiments, the laser data or power transmission network diagram shows a laser-based system in a ground-air-sea-space data network. In certain embodiments, the laser data or power transmission network may include a satellite constellation network that may create a satellite constellation that uses very accurate lasers to transmit bi-directional data between satellites in various orbits to ground stations, aircraft, watercraft, moving vehicles, or external spaces. Satellite constellation networks may also provide internet access to remote areas using networks of mobile balloons or drones that are connected to each other to exchange information or transfer data between them and to the ground. In certain embodiments, the satellite constellation network may also provide a network of ground communication nodes that work in concert with the drone to provide a mesh network for point-to-point communication for data centers, financial institutions, islands, offshore platforms, cargo vessels, and cruise vessels. A potential application of such a network may be to implement a near earth orbit nanosatellite based spatial data network. These satellites will communicate with each other and with the AUV through ground stations as well using laser communication links.

In certain embodiments, multiple terrestrial links may provide for the development of terrestrial-level laser communication links ranging from 1 to over 1000 gigabits per second (Gbps) and may be designed and optimized to operate within the atmospheric weather conditions of a region (e.g., the Arctic). This may result in having the necessary knowledge to implement a base transceiver unit capable of encoding 1000 Gbps of digital data onto a laser carrier. It may also provide specific technical knowledge about: a microwave circuit design optimized for stably and efficiently switching the distributed feedback laser; an effective free-space optical alignment technique near the diffraction limit for coupling the laser out into the atmosphere and into the low noise avalanche photodiode, and a low noise amplifier system at the receiving end for amplifying the detected signal by at least 20 dB. In addition, the basic angle of arrival detection algorithm may result in an accuracy of the laser beam angle of arrival approaching 0.001 degrees (0.001-deviee), and a high precision and repeatable tracking algorithm that may detect minute vibrations within this range and realign the system to achieve maximum stability.

In certain embodiments, the laser communication system 100 may provide the following example parameters during use: data transmission rates up to 1 or more Tbps (terabits per second); gesture detection precision and accuracy less than 1 micro radian; laser beam steering aiming capability precision and accuracy of less than 1 micro radian; active beam steering jitter correction capable of correcting random fluctuations in the range of 2 kilohertz (kHz) or higher; thermally stable operation at- 40 degrees Celsius to 80 degrees Celsius or higher; link connectivity and a margin of 3 dB or more are maintained under the following weather conditions: the humidity is up to 100%; a haze with a visibility of less than 1 km; sunlight directly entering the aperture; rainfall of 250 millimeters per hour or more; and a temperature oscillating between −40 degrees Celsius to 80 degrees Celsius or higher.

In certain embodiments, the extreme SWaP (size, weight, power) limitations at the external space may force the laser communication system to operate ideally under a diffraction-limited beam. This may require that the satellite system be able to accurately detect its attitude relative to the associated ground station within a precision and accuracy of about 1 micro radian or better. As a result, the satellite system may be required to accurately aim and actively steer the beam within micro-arc accuracy. Furthermore, considering the fact that satellites in Low Earth Orbit (LEO satellites) constantly Orbit the Earth at extremely high speeds, accurately aiming and steering the beam can be more challenging. This results in a specific vibration profile on the satellite that depends on its structural characteristics and can have a frequency spectrum that is high in the range of 1-2 kHz. Furthermore, LEO satellites may experience extreme thermal and radiation changes in each orbit. The laser communication system disclosed in the present application is capable of actively steering the laser communication link at relevant precise locations within very stringent requirements for its SWaP parameters, and achieving specific aiming and attitude detection (Pointing and Attitude Detection, PAT) accuracy within highly dynamic thermal, vibration and radiation environments. The disclosed system may meet the above-described basic requirements for an indoor environment on a simulated floor within the parameters described above.

In certain embodiments, the system for high speed communications may take into account atmospheric effects in satellite-ground links. Clouds, rainfall, temperature gradients (atmospheric flicker), humidity, haze, etc. all cause random turbulence and fluctuations in the propagation of the laser beam in the atmosphere. This may lead to major variations in link budget estimates in the communication link and requires careful consideration in designing the communication system. The disclosed system may quantify these varying parameters in a controlled indoor environment and may provide the link space required to be able to compensate for these effects to maintain its operation.

Furthermore, the disclosed system for high speed communications is designed with regulations in various jurisdictions in mind. This is because the operation of high power laser beams in free space and their technology is governed by various laws and regulations in different jurisdictions. The following regulations have been considered in the design of the present application: the first regulations considered are laser safety regulations (Laser Safety regulation). This regulation relates to eye safety requirements. A general criterion for maximum eye power emission is less than 0.1 watts/cm 2. The second rule considered is the component selection constraint. Techniques related to space and satellite communication links fall within the scope of international weapon transport regulations. The system may be based on a purely non-ITAR (International Traffic in Arms Regulations, international weapon transport regulations) component to avoid such limitations. The second regulations considered are aviation regulations. For air transportation safety and to avoid the possible impact of high power lasers on aircraft and pilot navigation, certain jurisdictions have specified restrictions on laser propagation in free space or in specific air transportation routes for air safety purposes, these restrictions being desired. The claimed application is contemplated. Spectral permissions may also be required for spectral permissions and airline eye safety, for example with trial permissions to operate within the radiation characteristics required by the system.

In certain embodiments, the disclosed laser communication system for high speed communications is also designed with radiation link budget calculations. For any communication link, the overall achievable efficiency can be estimated by taking into account the various forms of communication channels to be used. For example, under clear and highly atomized conditions, basic link budget calculations may be provided for an envisioned communication system. Based on the estimated calculations, the free-space optical channel disclosed in the embodiments of the present application can relay data exceeding 10 Gbps even in the worst case. These values can be greatly increased by using a more sensitive light counting sensor, a larger receiver aperture or pushing optics towards diffraction limited performance.

In certain embodiments, the system of the present application can provide a method of aiming accuracy and beam forming. This can be achieved by using a unique 3-step closed loop feedback system to achieve the single digit micro-arc targeting accuracy and beam formation required to pass through and accurately transmit data between the LEO satellite and the ground. In alternative embodiments, the system may have more or less than 3 steps depending on the type of application. The system can provide the advantage of having a lower price point and can also be kept leading the curve at all times. In addition, the system of the present application may provide an observatory network for Ground-Station-as-a-Service. This can be achieved by utilizing the existing astronomical station network around the world by modifying the base station apparatus of the present application to the optical output of the telescope of the existing astronomical station. This may allow for a quick introduction of new ground stations in a short time and also reduce the time, money and effort spent, thereby significantly improving defenses in long-term operation.

In certain embodiments, the system of the present application may provide the following advantages: having more bandwidth, high bandwidth for mobile and remote platforms, capitalizing on the fiber market with the maturity and cost reduction of the silicon photonics industry, facilitating the growth of nano-satellite technology and with lower nano-satellite emission costs and frequencies.

In certain embodiments, the system of the present application may also provide for low cost manufacturing using manufacturing extensibility that covers the following subsystems with different levels of extensibility: the optoelectronic system of the present application will be based on silicon photonics, integrated lasers and optics, and high speed electronics. All of these components can have a highly mature and scaled manufacturing process; the free-space optical component of the present application requires precise mechanical design and alignment. The fabrication process of diffraction limited optics is commercially available from many companies. However, the alignment process needs to be completed in a semi-automatic test equipment. The targeting, acquisition and tracking system of the present application can take advantage of advances in microelectromechanical systems (MEMS) and nanoelectromechanical systems (NEMS) technology integrated into CMOS processes, which have allowed for very accurate high performance sensors enabling very accurate measurement of various parameters in inertial measurement units. The particular set of core components may be customized using the same scalable process accepted in the industry.

In certain embodiments, the advantages of the present application may include higher efficiency, new novel methods, less delay, lower latency, more data, less energy requirements, smaller devices, higher bandwidth, fewer mechanical components, and faster connectivity. The application may be used in any situation where gaze tracking and alignment is required within two or more nodes. This can be used in a variety of commercial industries including aerospace, telecommunications, satellite services, military and defense, low latency financial services, and the like.

Further advantages may include: fewer machines; small size, weight, and power consumption (SWAP); micro-arc accuracy; due to closure with a back-off mechanism

In certain embodiments, the bidirectional feedback search has high reliability; intelligent algorithms that rely on learning rather than completely on heuristics; space diversity.

Some portions of the description which follows present, explicitly or implicitly, algorithms and functional or symbolic representations of operations on data within a computer memory. These algorithmic descriptions and functional or symbolic representations are the system used by those skilled in the data processing arts to most effectively convey the substance of their work to others skilled in the art. An algorithm is here, and generally, considered to be a self-consistent sequence of steps leading to a desired result. These steps are those requiring physical manipulations of physical quantities, such as electrical, magnetic, or optical signals capable of being stored, transferred, combined, compared, and otherwise manipulated.

Unless specifically stated otherwise, and as apparent from the following, it is appreciated that throughout the present specification discussions utilizing terms such as “scanning,” “computing,” “determining,” “replacing,” “generating,” “initializing,” “outputting,” or the like, refer to the action and processes of a computer system, or similar electronic device, that manipulates and transforms data represented as physical quantities within the computer system into other data similarly represented as physical quantities within the computer system or other information storage, transmission or display devices.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof system any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

What is claimed is:

1. A group (or swarm) of two or more autonomous underwater vehicles (AUVs), each AUV comprising:
a. a plurality of sensors enclosed within a housing of the AUV; and
b. a generative learning system comprising at least one processor and at least one memory configured to implement a deployed learning network model, the deployed learning network model generated from a training network, wherein the training network is tuned using features extracted from a set of data received from the one or more sensors in the group of submersible underwater vehicles, and wherein data associated with each of the one or more sensors indicates a navigation model, the at least one processor configured to at least:
i. automatically process a first set of data using the deployed learning network model to generate a navigation trajectory;
ii. compute the navigation trajectory metric associated with the set of data using the deployed learning network model by leveraging the features and associated target value for the navigation trajectory network to determine the associated navigation trajectory for the group of submersible underwater vehicles; and wherein the AUVs further comprise a linked communication system wherein depending on maritime conditions the swarm of AUVs communicates with one another and with a command-and-control system (C2) using a combination of acoustic, RF, and optical communication systems,
c. wherein the optical communication system comprises: one or more of a photon-counting detector, a boundary detector operably coupled to the photon-counting detector, at least one alignment block operably coupled to the boundary detector, and a rate decision block operably coupled to the alignment blocks, wherein the photon-counting detector transduces an optical signal with a variable data rate into a digital signal including a symbol having a data period and a guard period, wherein he boundary detector senses a boundary (e.g., a rising or falling edge) of the digital signal and indicates a photon arrival at the photon-counting detector, wherein the alignment block estimates a number of photons detected by the photon-counting detector during the guard period at each of a plurality of predetermined data rates based on the boundary of the digital symbol, and the rate decision block estimates the variable data rate of the optical signal based on the number of photons detected by the photon-counting detector during the guard period at each of the plurality of predetermined data rates.

2. The autonomous underwater vehicles of claim 1, wherein the optical communication system includes a plurality of lasers acquired and characterized by an acquisition module; a laser tracking module; a beacon feedback and beam dispersion mechanism; an adaptive learning detection algorithm implemented using an adaptive learning unit to identify and track unique optical signatures from at least one of the acquired lasers; and an aiming module aimed by at least one laser at a target based on the acquired laser.

3. The autonomous underwater vehicles of claim 1, wherein the AUV further comprises a processor that controls the GPS, a DVL (Doppler Velocity Log), the depth sensor, and an inertial navigation system to calculate the posture and the position of the AUV.

4. The autonomous underwater vehicles of claim 1, wherein the one or more communication systems include acoustic and RF communications.

5. The autonomous underwater vehicles of claim 1, further comprising a low-power laser-based LiDAR (Light Distancing and Ranging) system, a video camera, a GPU (Graphic Processing Unit), side-scan-sonar, a magnetometer, and multibeam echo sounder.

6. The autonomous underwater vehicles of claim 1, further comprising a fluorometer, a magnetometer, a thermometer, and pH meter.

7. The autonomous underwater vehicles of claim 1, wherein the AUVs may be powered by one or more lithium-ion batteries.

8. The autonomous underwater vehicles of claim 1, wherein the AUVs incorporate an internal counterweight system and dive plane mechanism for operating autonomously underwater.

9. The autonomous underwater vehicles of claim 1, wherein the AUVs incorporate a unique pitch and yaw control.

10. The autonomous underwater vehicles of claim 1, wherein the AUVs comprise a conventional torpedo shaped designs having a single aft-located motor.

11. The autonomous underwater vehicles of claim 1, wherein the AUVs comprise an internal counterweight system to turn and drive the AUV.

12. The autonomous underwater vehicles of claim 1, wherein the AUVs work in swarms of about 10 or more AUVs.

13. The autonomous underwater vehicles of claim 1, wherein the AUVs work in swarms of about 100 or more AUVs.

14. The autonomous underwater vehicles of claim 1, wherein the AUVs work in swarms of about 1000 or more AUVs.

15. The autonomous underwater vehicles of claim 1, wherein each of the AUVs comprises one or more systems selected from the group consisting of a cruising system, exploration condition setting systems, exploration mission executing systems, recording systems, cruising speed setting section, cruising-control section, imaging systems, and geological layer researching systems.

16. The autonomous underwater vehicles of claim 1, wherein the AUVs are configured for autonomous exploration, reconnaissance, or military/tactical conditions by remotely inputting, to the one or more AUVs, information which is necessary for the mission, comprising an exploration region and a cruising path of the underwater vehicle using the exploration condition setting system before the underwater vehicle is introduced into the exploration water area.

17. The autonomous underwater vehicles of claim 16, wherein the exploration missions, the exploration regions, and the cruising paths are optionally differently set for the respective underwater vehicles to explore the exploration regions more efficiently.

18. The autonomous underwater vehicles of claim 1, wherein the AUVs each have an endurance of 24 hours or more.

19. The autonomous underwater vehicles of claim 1, wherein the AUVs each have a weight of 50 pounds or less.

20. The autonomous underwater vehicles of claim 1, wherein the AUVs can provide real-time data to a command and control center using an interface.
